(19) United States
(12) Patent Application Publication
(10) Pub. No.: US 2004/0236659 A1
(43) Pub. Date: Nov. 25, 2004

(54) Method and apparatus for an engine system supporting transactions, schedules and settlements involving fungible, ephemeral commodities including electrical power

(76) Inventors: Edward G. Cazalet, Los Altos Hills, CA (US); Ralph Samuelson, Mountain View, CA (US); John Stremel, Santa Clara, CA (US); Tichomir Tenev, Stanford, CA (US)

Correspondence Address: Glenn Patent Group, Suite L, 23475 Edison Way, Menlo Park, CA, 94025, US

(21) Appl. No.: 10/296,482

(22) PCT Filed: May 16, 2001
(86) PCT No.: PCT/US01/15858

Related U.S. Application Data
(63) Continuation-in-part of application No. 09/613,685, filed on Jul. 11, 2000.
(60) Provisional application No. 60/168,478, filed on Dec. 1, 1999.
(60) Provisional application No. 60/206,852, filed on May 23, 2000.

(51) Int. Cl. G06F 17/60

(52) U.S. Cl. 705/37

(57) ABSTRACT

Certain embodiments include a method and apparatus for a computing system supporting transactions involving fungible, ephemeral commodities including electrical power, the transmission of electrical power, trading such commodities to create commitments, scheduling and settling those commitments. Certain embodiments include a market engine supporting not only a virtual trading floor, but also biloteral trading and external market trading by certified clients of the system. Certain embodiments include databases and database engines coupling at least some of the market engine, scheduling engine and settlement engine. Certain embodiments support Web site support.

### TECHNICAL FIELD

This invention relates to engine systems for trading, operational scheduling, and settling transactions involving ephemeral, fungible commodities with regards to trading electrical power as applied to grids of one or more AC power networks.

### BACKGROUND ART

As used herein, a fungible commodity will refer to a commodity traded strictly in terms of the quantity of that commodity. No single unit of a fungible commodity is distinguishable from another unit of that commodity. A kilowatt-hour of 60 Hz AC power delivered on a power line is not distinguishable from another kilowatt-hour delivered at the same time to the same place on the same line. An ephemeral, fungible commodity is a fungible commodity whose existence is extremely short-lived. Electrical power generation, network bandwidth, seats on an airplane and entry slots onto a freeway during rush hour are all examples of fungible commodities which exist but for a short duration of time. In contradistinction, starting lots in an assembly line produce tangible results, which may differ widely in content, thus showing an example of an ephemeral, non-fungible commodity. Ever since the invention of AC power technology, this and many other countries have benefited from the ability to share the use of AC electrical power across great distances. However, the management and control of AC power networks have shown themselves to have fundamental problems. Before discussing these management and control problems, it is important to consider some of the basic physical properties of electrical power distribution.

An AC power network is an electrical network connecting AC power generators to AC power loads on power lines controlled so that the network functions at an essentially constant frequency and uniform phase across the network. Drifts in phase are compensated by phase shifting devices to enforce the uniform phase property across the AC power network. Drifts in frequency are compensated at the generators. Such frequency variations are typically caused by variances between the loads and generated power. The effect of these compensations is to operationally provide essentially constant frequency and uniform phase throughout the AC power network. The AC power distribution frequency in the United States, Canada, Mexico and some other countries is 60 Hz and in some other countries is 50 Hz. In certain cases, the power is distributed in a 2-phase or a 3-phase transmission scheme.

A grid as used herein will refer to an electrical power system which may comprise more than one AC power network as well as DC power lines which may transfer energy between nodes of different AC power networks or between nodes of a single AC power network.

Cities, generators and the like act as the nodes of an AC power network. A specific node may actually comprise more than one generator or load. A bus locally connects these local facilities of a node. High voltage AC transmission lines transfer power between the cities and the generators in major load centers of an AC power network. By way of example, in the United States, there's an AC power network called the Western States Coordinating Council, which covers British Columbia in Canada down to Northern Mexico and over to the Rocky Mountains. There's another AC power network in Texas and there's another AC power network essentially covering the rest of the United States and Canada, with the exception of a portion of Quebec. These three AC power networks are connected together by direct current lines to form the North American grid. They're not connected in AC. They are asynchronous, in that they are not synchronized either in terms of frequency or phase across the United States, Canada and northern Mexico.

Electrical power generation can readily be seen to be ephemeral and fungible. One kilowatt is reasonably treated the same as another, persisting only a relatively short period of time. Electrical power transmission can also be seen as ephemeral and fungible. Electrical power transmission is most commonly performed as AC transmission lines between nodes of an AC power network. DC power lines are used additionally to connect specific nodes of either a single or more than one distinct AC power networks.

Electrical power storage is of typically limited time duration, often for no more than a day or two. It should be noted that the interface points for power into such systems are ephemeral and fungible.

Power switching between lines involving high power (megawatts and above) is not commonly done. Power switching today typically involves no more than a fraction of a megawatt. However, if such systems components someday become capable of handling large power lines, power traversing the interfaces of such switches to a power network would still be ephemeral and fungible.

There are some basic physical properties distinguishing AC power distribution systems from other flow-based systems such as DC power, gas, water and oil transmission systems. AC power networks differ from gas, water, oil and other fluid flow distribution systems in that changes in power generation and loading propagate across such networks at approximately the speed of light. The effect of power generation and power loading effects the whole AC power network in a manner that, for practical purposes, is simultaneous.

Due to the stability of frequency and phase across an AC power network, changes in power have a super positioning effect. This insures that the power being carried on any line in the network is essentially a linear function of the generators and loads on the network. Furthermore, if a path of lines connects two nodes, generating power at the first node carried by the path is offset by power generated at the second node, as related by the above mentioned linear function.

These AC power networks are operated within a safe range, so that the patterns of flows are fairly predictable, given the configuration of the network does not change. The National Electric Reliability Council computes a system of a set of numbers called power transfer distribution factors available on the North American Reliability Council website, www.nerc.com, showing how the power is distributed across these various lines. It is a linear function of the amount injected, which changes sign when the direction of transfer changes from Node1 to Node2 into Node2 to Node1. Such functions are skew symmetric with respect to the nodes.

Consider a DC network: one can directly control the delivery of power from one point to another. This cannot be done on AC power networks. It is a characteristic of AC power networks that all lines are affected in roughly fixed proportions, by the previously mentioned transfer distribution factors and by the generating and loading at specific nodes.

A flowgate of a given AC power network will refer herein to a collection of at least one line whose total maximum safe carrying capacity will act as a congested element of the network, constraining AC power delivery between two or more nodes of that network.

All lines have maximum safe carrying capacities and thus could be considered flowgates, of a sort. However, historical congestion analysis of specific AC power networks reveals that only a small number of flowgates account for almost all congestion problems. Such flowgates will be herein referred to as significant flowgates.

The associated AC power transfer across a given flowgate is additive due to the super positioning effects previously discussed. Thus in sending 100 megawatts along a path, the transmission may have a 10% impact on the flowgate, putting 10 megawatts on the flowgate. A second generator may have a 5% impact on that flowgate. Generating 100 megawatt at the second generator would add 5 megawatts across the flowgate.

Note that these AC power functions are essentially linear and can be described by their coefficients.

Note that the facilities at these nodes, connected by an associated buss, often vary greatly in terms of generation capacity as well as loading capacity. By way of example, a city often consumes far more AC power than it generates. Another example, a node for a major hydroelectric dam such as Grand Coulee Dam would tend to generate far more AC power than it consumed.

The historical market of electrical power and electrical power transmission has, for a variety of historical and technological reasons, long been a notable exception to a commodity market approach. The ability of buyers and sellers to negotiate and implement deals remains severely restricted, even where the electric power industry has been deregulated. The usual argument for these restrictions revolves around reliability.

In the United States, the Federal Energy Regulatory Commission (FERC) called for the development of Regional Transmission Organizations (RTOs) to better coordinate markets and foster reliability (Docket No. RM99-2-06 issued May 13, 1999).

The electric power industry has a long history of using centralized dispatch to manage generation, as opposed to open markets. Centralized dispatch was suited to an industry consisting of vertically integrated monopolies. The traditional approach to RTO design so far has been to retain as much of this centralized control as possible, while opening access to competitive wholesale and retail participants. The result has been volatile prices, settlement disputes, and difficulties matching supply and demand on an instantaneous basis. The basic problem is that centralized dispatch does not work well where participants do not have common ownership or objectives.

RTO's have certain essential technical functions: providing an overall focus on reliability, regional security coordination and emergency operator intervention. RTO's have problems in the areas of scheduling, congestion management, ancillary service provisions, metering, billing and settlements. As used herein, an ancillary service often involves power generation. A power generation facility will reserve some production capacity to be available at the operators request in real-time to support balancing the network and to deal with emergency requirements which can rapidly be addressed by the reserved production capacity. Note that all the problem areas involve ephemeral, fungible electrical commodities or the economic results of transactions involving ephemeral, fungible electrical commodities.

Consider how AC power transfers are managed today in most of North America. Transmission rights are considered and negotiated in terms of point-to-point transfers within the network known as contract paths. Such thinking is contrary to the previously discussed physics of these AC power networks, because changes in power generation or load at any node have an essentially linear effect on all transmission lines in the network, and consequently impact all flowgates within that network to some extent.

This contract path system of scheduling power transmission reserves transmission rights along a particular, direct path through the AC power network. This is done by purchasing transmission rights from each of the transmission line owners for each of the lines making up the direct path. It often occurs that some constraint, occurring across a significant flowgate off that direct path, actually limits the transmission capability on the direct path.

The contract path system maintains the fiction that AC power can be directed to follow a path through the network chosen as one might with natural gas. By changing the valves, one can mythically direct AC power a particular way through the AC power network. The contract path system was put in place because it was thought conceptually easier since one only had to make reservations along the single path. The fundamental problem with the contract path approach is that the contract path arrangement for transmission does not accord with the way the power actually flows in an AC power network.

Today's contract path is based upon a first-come, first-served priority scheme. What is bought has very limited resale capability. By way of example, consider three nodes A, B and C forming a triangle in an AC power network. Suppose one bought a power transmission from A to B and bought a transmission from B to C. Using the contract path approach, that purchase does not mean one owns the power transmission from A to C, because contract paths are not additive. Owning power transmission from A to B and from B to C would not entitle power transmission from A to C. To transport from A to C, one would have to purchase separately transmission from A to C. This is because there might be some flowgate constraint which would not be met in the two separate paths which would be triggered in the combined path. So in the contract based market, which is the traditional market, once you have purchased the transmission from A to B, it's only value is for moving energy from A to B.

Today, there are several ad hoc approaches to limiting flow on one path because of the impact on another path. These contract path approaches ignore the physics of AC power networks. This leads to situations where even though some other path may actually be the constraint, when a particular path becomes over-constrained, cuts are issued to compensate. The central operator acts, because a flowgate will attempt to exceed its safe carrying capacity, forbidding transmission often across apparently irrelevant paths to compensate. The result is market chaos, since participants do not have reasonable assurance that their deals will actually go to delivery.

Another alternative approach is to take all of these generator costs, and the preferences of the buyers, into a mathematical optimization program, and figure out the optimal flow. This alternative approach has significant disadvantages. In a commercial market, getting people to reveal all their costs is quite difficult. Most people are very reluctant to do that. Further, such costs frequently change. The loads will have to reveal their preferences between consuming and non-consuming players, which is a tremendous informational burden. It is extremely unlikely that they could or would do it. Even if they did, all this information is a tremendous burden on the central operator collecting all the information.

Such an alternative approach requires two-way communication among all the players, with all these devices and systems to control, when the people consume power and when they turn on and off these distributed devices. It has proven impossible to provide the requisite level of reliable communication and direct control systems. Besides, people are unwilling to turn over control of their business lives to a central operator.

Another approach in industry is used by a system operator called PJM, for Pennsylvania, New Jersey and Maryland, who has developed a system called Locational Marginal Pricing(LMP). It is a central dispatched methodology. However, a local flow model is buried within it. It supports some centralized management of generators, related equipment and facilities in order to get a consistent solution that is based upon the power distribution matrix. This is a matrix of all power transfer distribution factors between nodes of the AC power network.

This approach suffers from at least the same problems facing any other centralized control scheme. There is a very limited amount of detailed information such a system can acquire, or use, to optimize AC power transfers. The power users are again blind to their options. The players cannot determine what works best for them. The central operator dictates to them. This situation is not optimal. Also, under LMP, prices are not known until after the deal is done, which may be at the time of delivery or a day ahead of delivery. Generation operators do not obtain the information they need to plan their hydroelectric, maintenance, and unit commitment decisions. Nor can price risks be easily hedged.

NERC has developed a methodology addressing flowgates to some extent. This is discussed in a document entitled “Discussion Paper on Aligning Transmission Reservations and Energy Schedules to Actual Flows”, distributed in November, 1998 by the NERC Transaction Reservation and Scheduling Self-Directed Work Team. This team proposed an electrical power industry shift to a system of reserving and scheduling transmission based on actual use of congested flowgates, which they called the FLOWBAT method. Their proposal suffers from a serious omission, it does not address the issue of allocating flowgate capacity when demand exceeds supply. By their silence on this issue, it appears that they would continue the current practice of first-come, first-served allocation. The flaws discussed above for centralized planning continue to be relevant in this approach.

NERC has also supported the General Agreement on Parallel Paths Experiment (GAPP). GAPP is a system whereby one transmission provider compensates a second transmission provider for the parallel power flows occurring on a second transmission provider's system caused by transactions authorized by the first transmission provider. GAPP relies on distribution functions, in this case called Transaction Participation Functions (TPFs). These distribution functions refer to transmission paths rather than flowgates. GAPP attempts to align compensation paid by transmission users with actual power flows. However, GAPP is strictly an after-the-fact settlement system. It alters the current contract path scheme only to redistribute the revenue. It does not attempt to allocate scarce transmission capacity.

Certain economists have expressed reservations with a flowgate market model utilizing a limited number of flowgates. They believe that leaving any flowgates out of the system, even minor ones, introduces gaming opportunities, which will cause the RTO to incur costs that must be paid by everyone. However, flowgates are numerous, and may arise unpredictably. It may not be feasible to trade every flowgate, as would be required to overcome the potential for gaming.

Supporting a large number of flowgates in a market model leads to several other problems. First, there is the technical problem of providing a user interface that makes it possible for users to cope with the complexity of numerous flowgates.

Second, there is the problem of maintaining liquidity with this many flowgates. Customers want to buy and sell the bundles of flowgates they need to move energy from one point in the network to another. They may not feel comfortable posting bids and offers for individual flowgates without an assurance that they will be able to buy or sell the remaining flowgates they need for their bundle at a reasonable price. If everyone withholds bids and offers from the market until they see bids and offers for all the flowgates they want to buy or sell, the market could significantly lack liquidity.

What is needed is a method and system supporting markets for large numbers of flowgates, providing users with straightforward trading mechanisms for AC power transfer which insure compliance with flowgate constraints, and thus the physics of AC power networks, while discouraging gaming opportunities.

What is needed is a system supporting trading transmission rights and energy in the form of complete bundles. These complete bundles would allow purchase of delivered energy with one transaction. Customers would no longer need to be aware of the underlying flowgate rights. The system should permit the bundles to be internally large and complicated, supporting trading in every flowgate right, and potential flowgate right.

LMP accomplishes this, but does so at a cost of forcing participants to trade FTRs at a limited number of discrete times. What is needed is an approach combining the flexibility of LMP with the benefits of true continuously traded forward markets.

Certain RTO's do not want to identify a small number of commercially significant constraints. They want the market to identify the significant constraints.

Other efforts at trading ephemeral, fungible commodities have tended to focus on auction mechanisms such as found in U.S. Pat. No. 5,905,975 entitled “Computer implemented methods and apparatus for auctions” by Ausubel. Consider the third example of that patent's application involving a region's electric power pool seeking to arrange for the production of electric power at various times of day via a dynamic auction. There is an inherent problem with such mechanisms in that they lack the ability to recognize the ephemeral and fungible nature of the commodities involved. Such auction approaches fail to appreciate the ever approaching moment of existence, and subsequent non-existence, the ephemeral nature, of the involved commodities. The fungible, ephemeral nature of electric power, that at a given place, for a given period of time, one kilowatt is essentially the same as another, is completely missing in such systems. The auction paradigm is of a one way trade, completely lacking the multiple directional trading aspect which far more optimally supports this inherent fact of the physics, that at a given place, for a given period of time, one kilowatt is essentially the same as another.

What is needed includes methods and systems coupling automated settlement engines and scheduling engines based upon a client collection and commitment collection involving at least some of those clients. What is further needed includes methods and systems supporting automatic and reliable generation of settlements based upon known commitments between clients. What is further needed includes the generation of schedules of at least some of those commitments to those clients.

What is needed is a shared database including at least the client list and commitment list accessible to at least two of the following: a market engine managing one or more forms of client-based trading to provide commitments for the commitment list; a scheduling engine generating schedules for at least one client based upon accessing the commitment list; and the settlement engine generating settlements for clients based upon at least the commitment list.

Additionally, reliable distributed computer systems have been developed in the prior art, as in Reliable Distributed Computing With the Isis Toolkit, edited by Birman and Van Renesse, ISBN 0-8186-5342-6, © 1994 Institute for Electrical and Electronic Engineers, Inc. These reliable distributed systems are based around process groups of cooperating concurrent processes redundantly performing the same operations on copies of the same data while being distributed through a multi-computer system.

The prior art (particularly in Chapter 11, “Reliable Communication in the Presence of Failures” pages 176-200, in Reliable Distributed Computing With the Isis Toolkit) discloses basic communication protocols, ABCAST and GBCAST, for broadcasting messages within a process group and for detecting and reacting to network failures. The protocols provide strong guarantees for message delivery causality and message delivery atomicity. Message delivery causality is the guarantee that a message should not be delivered before its predecessor. Message delivery atomicity guarantees that two messages are delivered in the same sequence to all recipients.

However, the ABCAST and GBCAST protocols are not sufficient by themselves to implement a message driven architecture. A message driven architecture requires that objects can not only send messages to each other, but also reply to those messages. This can be seen in the following example:

Consider a process group of three members: P1, P2 and P3. Suppose that P1 were to send a message A to everyone (P1, P2 and P3). Message A could be something like: ‘Now is TTT o'clock and it is time to run the auction for market XXX’. Supposed the process group wanted to send message B in response to message A. Message B could be something like: ‘The auction for market XXX was run and the new price is YYY’. Who will send the response message B? Since A is sent to all members of the group and all members behave identically, then any of them could in principle be sending B. In reality, however, it is undesirable for all three processes to send the same reply, so the most senior process is chosen to send the message B.

From the point of view of ABCAST and GBCAST, both messages A and B are treated identically, i.e. they will be broadcast to all members of the process group using the same protocol. From the point of view of a message driven architecture, messages A and B are essentially different. The difference lies in the cause for each message and that difference will effect the way the two messages are handled.

Message A is caused by an asynchronous event. For example, suppose P1 looked at a timer and decided that it is time to send message A. If P1 crashed shortly before sending A, the next available process looks at its timer and sends A. That could be a few minutes later than P1, but it would not matter, because the precise timing of A in virtual time does not matter.

Message B, on the other hand is caused by a synchronous event. That is, message B was sent as a result of receiving message A. Consequently, sending message B must happen in a precise moment in virtual time. Therefore, if the process, which happens to send B, died shortly before sending it, another process will have to take over. However unlike the case with message A the process which takes over must send B in the exact virtual time in which the original process had sent it and B must contain the exact same information.

The above discussion points out that A and B must be treated differently, but ABCAST and GBCAST make no provisions for that. What is needed is a mechanism compliant with ABCAST and GBCAST, which further supports message replies within a reliable distributed system.

To summarize, what is needed is a trading mechanism for electrical ephemeral, fungible commodities optimizing the scheduling, congestion management, ancillary services, metering, billing and settlements of accounts for electrical grids. Further, what is needed is an AC power transmission market system complying with the physics of AC power networks. Further, what is needed should account for the effect on at least the significant flowgates for each contracted transmission. A method and mechanism is needed for trading generation and transmission rights in a timely, reliable and efficient manner which automatically guarantees correct operation of the power grid.

What is needed includes methods and systems coupling automated settlement engines and scheduling engines based upon a client collection and commitment collection involving at least some of those clients. What is further needed includes methods and systems supporting automatic and reliable generation of settlements based upon known commitments between clients. What is further needed includes the generation of schedules based upon at least some of those commitments to those clients. What is further needed includes methods and systems supporting automated metering data entry and the generation of settlements based additionally upon the metering data.

What is needed is a shared database including at least the client list and commitment list accessible to at least two of the following: a market engine managing one or more forms of client-based trading to provide commitments for the commitment list; a scheduling engine generating schedules for at least one client based upon accessing the commitment list; and the settlement engine generating settlements for clients based upon at least the commitment list. What is needed includes the shared database further maintaining metering data for at least some of the clients.

The trading operations need to reliably interface with grid management, scheduling, and settlement functions including billing and conflict resolution. The interface of these operations must seamlessly provide not only trading in futures, but also ancillary services and various attributes of the traded commodities.

These operational systems should support potential system access through messaging protocols. Such messaging protocols should include error recovery protocols such as found in TCP-IP and its application to Intranets, the Internet and Extranets. Such messaging operational systems should also provide for secure transactions. Such secure transactions should start with login, and include at least some of the following: trading positions, ordering, commitment, scheduling, performance communication, billing, conflict resolution and customer support.

Further, operational systems should provide system level interface capabilities to external load forecast modules, tagging/OASIS systems, and SCADA/EMS systems. Operational systems should further provide a modular, system level approach to meet the evolving needs for the power network community, including the evolving compliance standards.

### SUMMARY OF THE INVENTION

Certain embodiments of the invention fulfill at least the requirements and needs discussed with regards to the prior art.

Certain embodiments include a method and apparatus for a computing system supporting transactions involving fungible, ephemeral commodities including electrical power, the transmission of electrical power, trading such commodities to create commitments, scheduling and settling those commitments. A market engine integrates the trading activities between certified clients. A scheduling engine integrates scheduling for the certified clients. A settlement engine provides settlements for certified clients.

This partitioning supports efficient, reliable servicing of the diverse needs and complex transactions needed for the planning and control of networks possessing nodes and transfer routes for fungible, ephemeral commodities such as electrical power and the transfer rights for commodities such as electrical power in such networks.

Certain embodiments include a market engine supporting not only a virtual trading floor, but also bilateral trading and external market trading by certified clients of the system.

The support of not only the very powerful and versatile virtual trading floor, but also the transactions involving bilateral trading and external market trading provides increased flexibility, as well as the ability to interact with other trading mechanisms.

Certain embodiments include databases and database engines coupling at least some of the market engine, scheduling engine and settlement engine.

Such database components offer a modularity whereby upgrades to one component, say the market engine or scheduling engine, do not alter the integrity of the other components. Database components further provide access to other engines, such as the market engine, whereby processors within a process group implementing the market engine may cache relevant parts of the database.

Certain embodiments support Web site support. Such support provides for access to powerful tools on both the client side as well as on the server side.

These and other advantages of the present invention will become apparent upon reading the following detailed descriptions and studying the various figures of the drawings.

### BRIEF DESCRIPTION OF THE DRAWINGS

FIG. 1A depicts a detail flowchart of operation 6000 of FIG. 2A performing a method of interacting with at least a first active certified client and a second certified client both belonging to a certified client collection and supporting transactions involving at least one fungible, ephemeral commodity;

FIG. 1B depicts a detail flowchart of operation 6012 of FIG. 1A further operating the market engine;

FIG. 1C depicts a detail flowchart of operation 6022 of FIG. 1A further operating the scheduling engine, for each of the certified clients belonging to the certified client collection;

FIG. 1D depicts an alternative detail flowchart of operation 6022 of FIG. 1A further operating the scheduling engine, for each of the certified clients belonging to the certified client collection;

FIG. 1E depicts a detail flowchart of operation 6032 of FIG. 1A further operating the settlement engine;

FIG. 1F depicts a detail flowchart of operation 6192 of FIG. 1E further processing the settlement for each of the certified clients belonging to the certified client collection;

FIG. 2A depicts a simplified system block of a computing system 3000 supporting interaction between a collection of certified clients and a computing system based upon supporting operations of a market engine, a scheduling engine, a settlement engine, in accordance with certain embodiments of the invention;

FIG. 2B depicts a refinement of computing system 3000 as a system diagram in FIG. 2A; This computing system is comprised of a client computer collection and a server system 3500 coupled to a network 3200;

FIG. 2C depicts a refinement of computing system 3000 as a system diagram in FIG. 2B; This computing system is comprised of a client computer collection and a server system 3500 coupled to a network 3200;

FIG. 2D depicts a grid management system providing functions and services for grid market operations including a collection of client computers 3700, 3720, 3740, 3760 and 3780 respectively coupled through network 3200 to server system 3500 including server computer 3520, and web server computer 3560, as well as server computer 3580 and database engine 3590;

FIG. 3A depicts a virtual trading floor 1000, containing validated orders and market intervals with associated market states and further containing a certified client collection of certified clients in accordance with certain embodiments of the invention;

FIG. 3B depicts a market interval containing a product type, location and time interval in accordance with certain embodiments of the invention; The product types may include ephemeral, fungible commodities; All product types may be ephemeral, fungible commodities;

FIG. 3C depicts a refinement of a market interval as depicted in FIG. 3B further containing multiple time intervals;

FIG. 4 depicts a flowchart of operations for a method of a virtual trading floor trading ephemeral, fungible commodities in accordance with certain embodiments of the invention;

FIG. 5A depicts a validated order 1200 of the validated order collection in accordance with certain embodiments of the invention;

FIG. 5B depicts a refinement of FIG. 5A of a validated order 1200 of the validated order collection;

FIG. 6A depicts a refinement of FIG. 3B of a market interval of an energy product type;

FIG. 6B depicts a refinement of FIG. 3B of a market interval of an AC power transfer product type;

FIG. 6C depicts a refinement of FIG. 6B of a market interval of an AC power transfer product type;

FIG. 6D depicts a refinement of FIGS. 6B and 6C of a market interval of an AC power transfer point-to-point product type;

FIG. 7 depicts a validated order 1200 comprised of at least two validated orders, each with an associated market interval in accordance with certain embodiments of the invention;

FIG. 8A depicts a market interval of a DC power line in accordance with certain embodiments of the invention;

FIG. 8B depicts market interval 1100 of FIG. 3B further containing a window time interval during which the market interval is active only within the window time interval;

FIG. 8C depicts market interval 1100 of FIG. 8B containing a window time interval and multiple time intervals;

FIG. 9A depicts a detail flowchart of operation 2000 of FIG. 4 performing establishing a real time;

FIG. 9B depicts a detail flowchart of operation 2022 of FIG. 4 performing determining whether to remove a validated order from the validated order collection when its associated market interval's window has passed;

FIG. 10A depicts a detail flowchart of operation 2000 of FIG. 4 performing contracting to create an agreed contract from the validated order collection;

FIG. 10B depicts a detail flowchart of operation 2092 of FIG. 10A performing contracting to create an agreed contract from the validated order collection;

FIG. 11A depicts a detail flowchart of operation 2022 of FIG. 4 performing removing first bid and first ask validated orders from the validated order collection;

FIG. 11B depicts a detail flowchart of operation 2142 of FIG. 11A performing removing the first bid validated order from the multiple validated order, where the first bid validated order is originally contained in a multiple validated order containing a second validated order;

FIG. 11C depicts a detail flowchart of operation 2152 of FIG. 11A performing removing the first ask validated order from a multiple validated order, where the first ask validated order is originally contained in a multiple validated order containing a second validated order;

FIG. 12A depicts a detail flowchart of operation 2000 of FIG. 4 performing maintaining a certified client collection of certified clients;

FIG. 12B depicts a detail flowchart of operation 2022 of FIG. 4 performing receiving an order message from a certified client, processing and inserting it into the validated order collection, in accordance with certain embodiments of the invention where each of the validated orders of the validated order collection contains an ordering client;

FIG. 13 depicts a detail flowchart of operation 2092 of FIG. 10A performing notified biding and asking clients of the agreed contract for their respective validated orders;

FIG. 14A depicts a detail flowchart of operation 2004 of FIG. 4 performing calculating the market price of each market interval in the market interval collection;

FIG. 14B depicts a refinement of FIG. 3B of a market interval 1100 further containing a capacity option type 1118;

FIG. 14C depicts a refinement of the validated order of FIG. 5B further containing 1340 a capacity option price 1342;

FIG. 15A depicts a detail flowchart of operation 2112 of FIG. 10B performing determining bid order agreement with ask order for an associated capacity option market interval;

FIG. 15B depicts a detail flowchart of operation 2116 of FIG. 10B performing calculating an agreed option amount;

FIG. 15C depicts a detail flowchart of operation 2120 of FIG. 10B performing creating the agreed contract at the agreed price and the agreed option price for the agreed amount whenever the first bid order agrees with the first ask order in terms of the price and the option price;

FIG. 16A depicts a market state 1102 associated with a market interval 1100 as show in FIGS. 3A and 14B in accordance with certain embodiments of the invention;

FIG. 16B depicts a detail flowchart of operation 2004 of FIG. 14A performing calculating the capacity option price 1102-2 for the market state 1102 as shown in FIG. 16A of a market interval as shown in FIG. 14B containing a capacity option 1118;

FIG. 17 depicts a method of controlling the interaction between a client 1400 and a virtual trading floor comprising maintaining a session component 3300, participant component 3320 and market segment 3340 in accordance with certain embodiments of the invention;

FIG. 18 depicts five functional levels implemented within each process group, in accordance with certain embodiments of the invention;

FIG. 19 depicts a detail flowchart of operation 6042 of FIG. 1B further supporting bilateral trading;

FIG. 20 depicts a detail flowchart of operation 6042, of FIG. 1B further contracting the received bilateral order;

FIG. 21 depicts a detail flowchart of operation 6052 of FIG. 1B further supporting external market trading;

FIG. 22 depicts a detail flowchart of operation 6012 of FIG. 1A further operating the market engine;

FIG. 23 depicts a detail flowchart of operation 6512 of FIG. 22 further recording the validated orders;

FIG. 24A depicts a detail flowchart of operation 6000 of FIG. 1A further performing the method of interacting with at least two active certified clients both belonging to a certified client collection and supporting transactions involving at least one fungible, ephemeral commodity;

FIG. 24B depicts a detail flowchart of operation 6722 of FIG. 24A further maintaining a web site communicating with at least two clients;

FIG. 25A depicts a detail flowchart of operation 6000 of FIG. 1A further performing the method of interacting with at least two active certified clients and supporting transactions involving at least one fungible, ephemeral commodity;

FIG. 25B depicts a detail flowchart of operation 6802 of FIG. 25A further operating the database engine;

FIG. 26A depicts a detail flowchart of operation 6852 of FIG. 25B of the database engine further interacting with the market engine;

FIG. 26B depicts a detail flowchart of operation 6862 of FIG. 25B the database engine further interacting with the settlement engine;

FIG. 27A depicts a detail flowchart of operation 6000 of FIG. 1A further performing the method of interacting with at least two active certified clients and supporting transactions involving at least one fungible, ephemeral commodity;

FIG. 27B depicts a detail flowchart of operation 6912 of FIG. 27A further operating the scheduling engine;

FIG. 27C depicts a detail flowchart of operation 6802 of FIG. 25A further operating the database engine;

FIG. 28A depicts a detail flowchart of operation 6932 of FIG. 27B further processing the capacity option request;

FIG. 28B depicts a detail flowchart of operation 6980 of FIG. 28A further processing the capacity offer list;

FIG. 29A depicts a capacity option request 1500 including at least one market interval 1510 and optionally including an ask-limit amount 1520 and optionally including an ask-limit price 1530; and

FIG. 29B depicts a detail flowchart of operation 6980 of FIG. 28A further processing the capacity offer list.

### DETAILED DESCRIPTION OF THE INVENTION

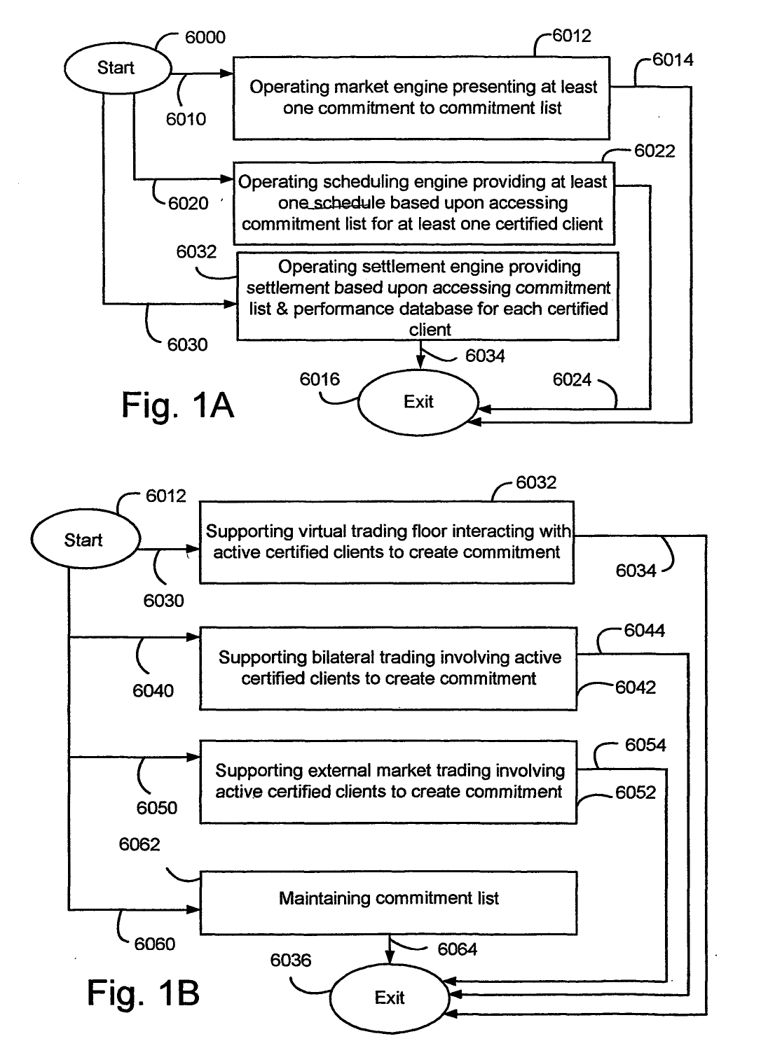

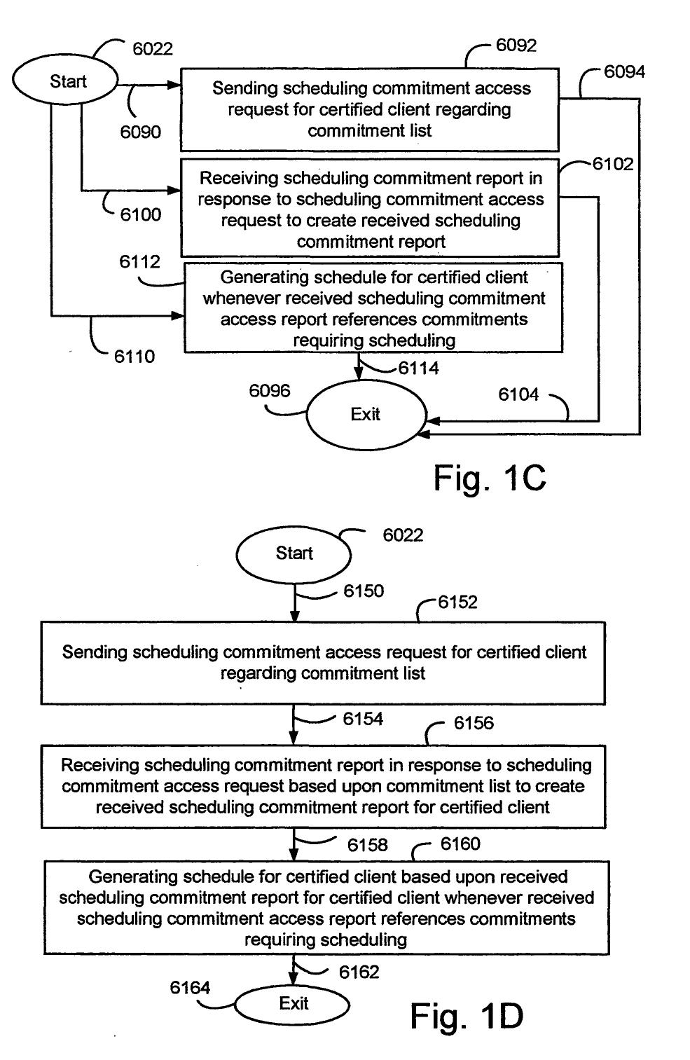

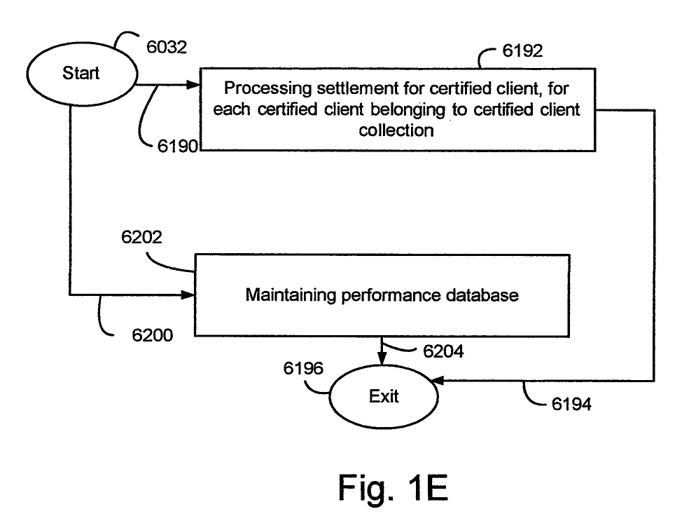

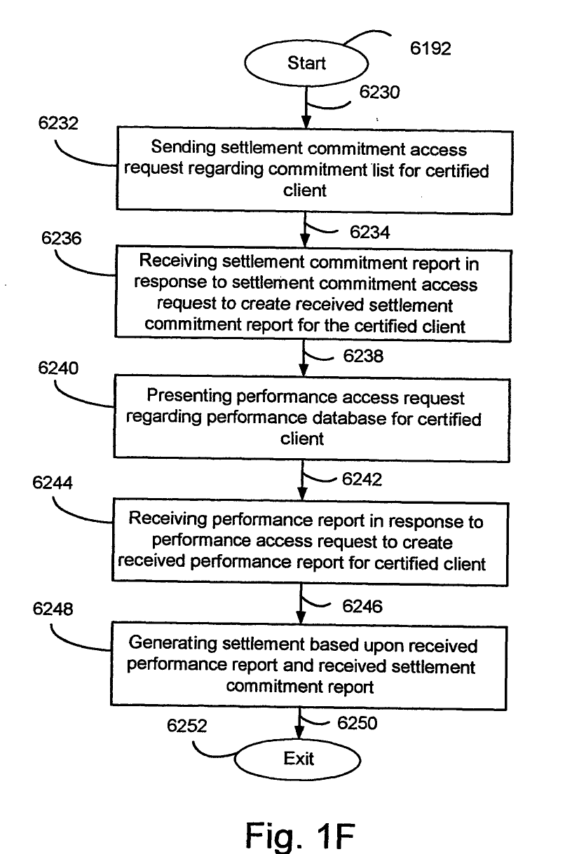

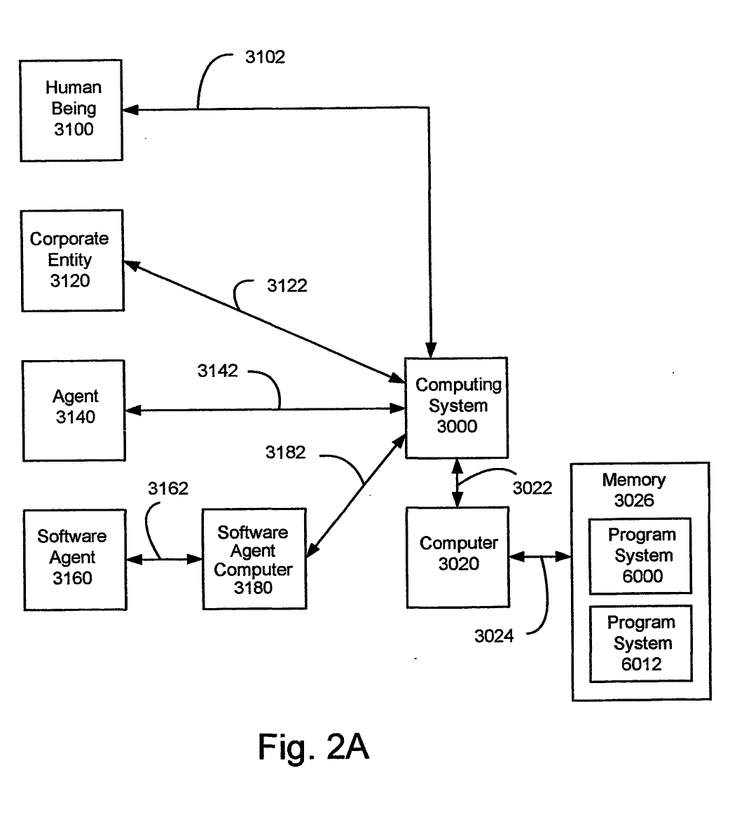

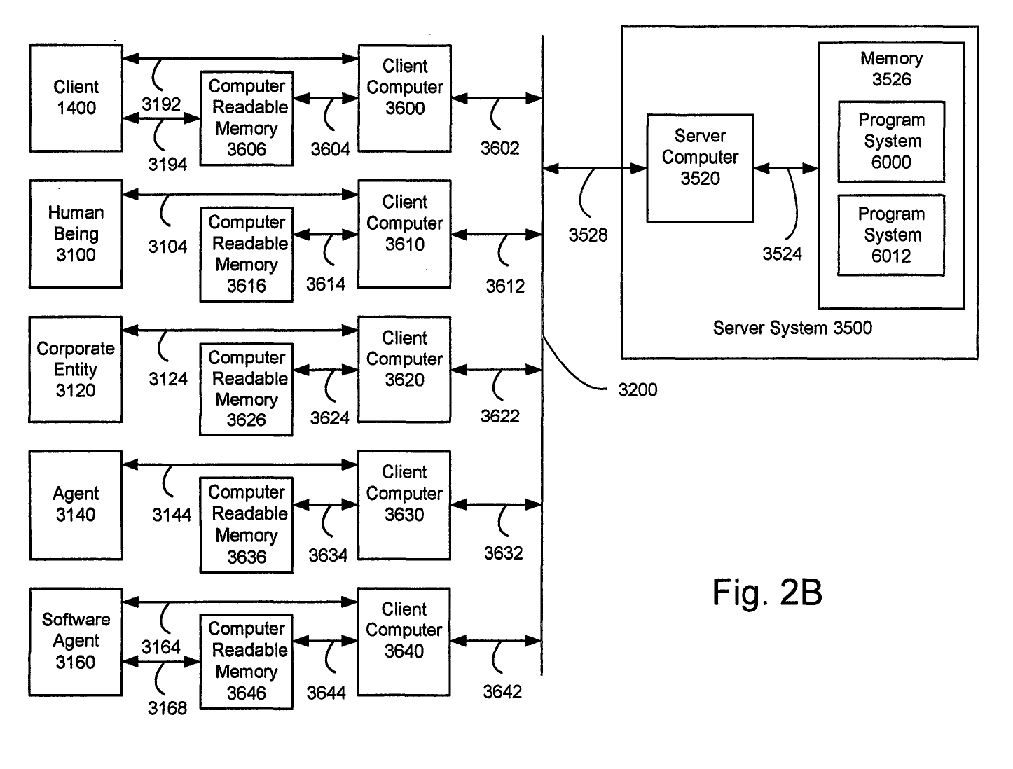

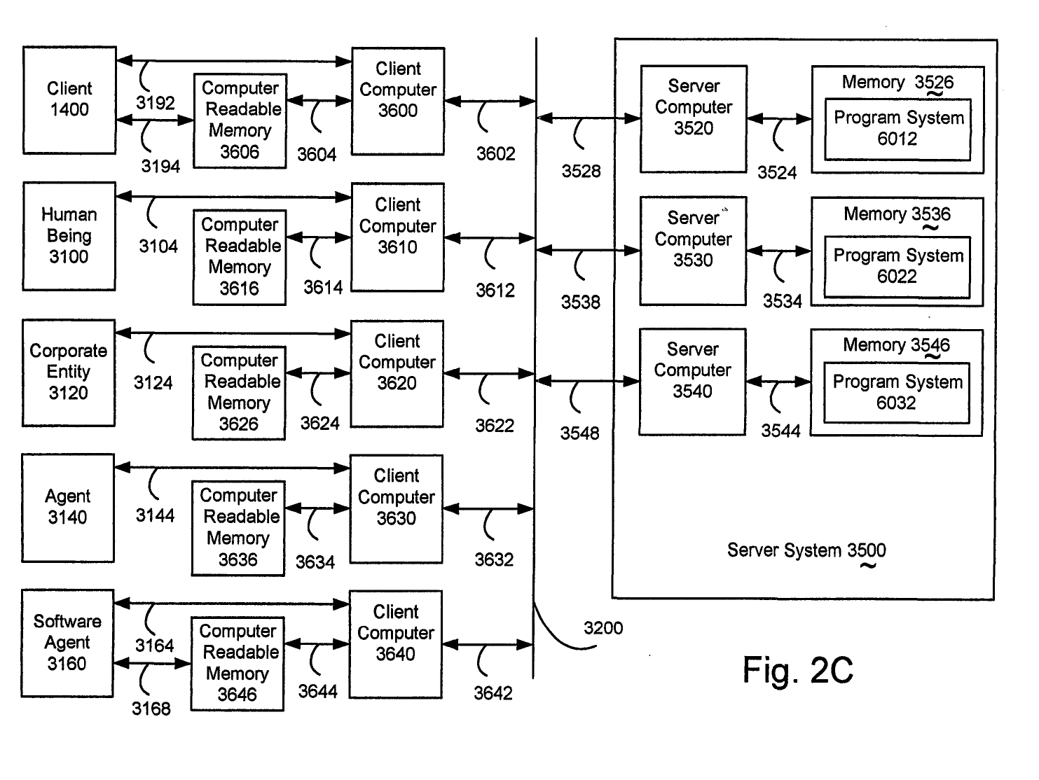

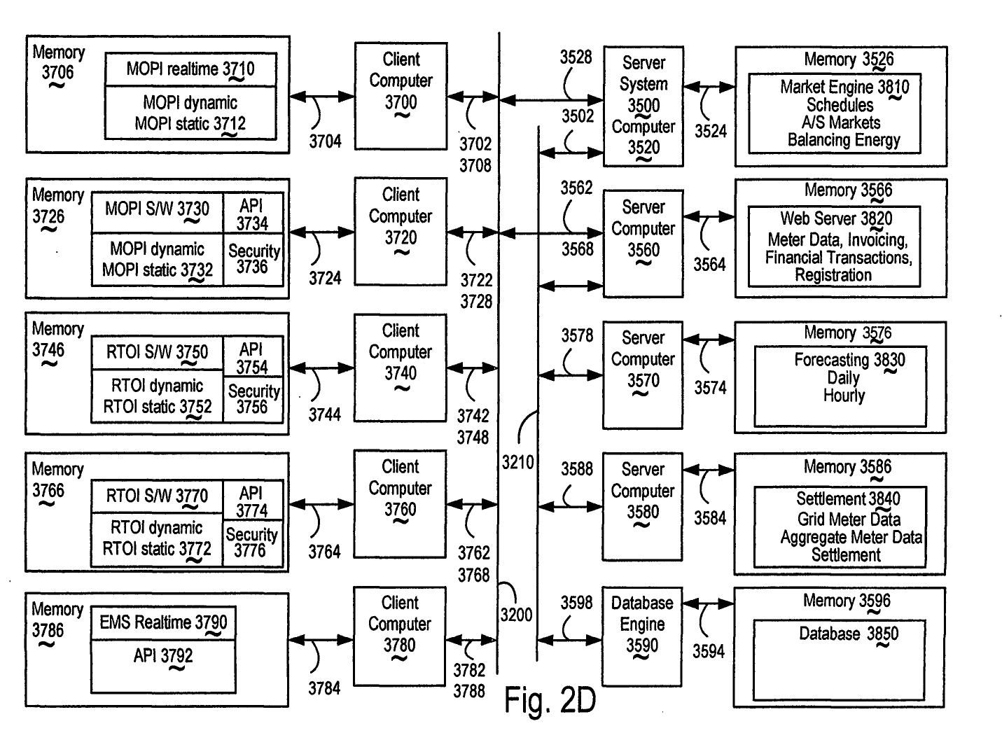

FIG. 1A depicts a detail flowchart of operation 6000 of FIG. 2A performing a method of interacting with at least a first active certified client and a second certified client both belonging to a certified client collection and supporting transactions involving at least one fungible, ephemeral commodity. Arrow 6010 directs the flow of execution from starting operation 6000 to operation 6012. Operation 6012 performs operating a market engine presenting at least one commitment to a commitment list. Arrow 6014 directs execution from operation 6012 to operation 6016. Operation 6016 terminates the operations of this flowchart.

Arrow 6020 directs the flow of execution from starting operation 6000 to operation 6022. Operation 6022 performs operating a scheduling engine providing at least one schedule based upon accessing the commitment list for at least one of the certified clients belonging to the certified client collection. Arrow 6024 directs execution from operation 6022 to operation 6016. Operation 6016 terminates the operations of this flowchart.

Arrow 6030 directs the flow of execution from starting operation 6000 to operation 6032. Operation 6032 performs operating a settlement engine providing a settlement based upon accessing the commitment list and based upon a performance database for each of the certified clients belonging to the certified client collection. Arrow 6034 directs execution from operation 6032 to operation 6016. Operation 6016 terminates the operations of this flowchart.

Certain embodiments of the invention include two or more of following: operating the market engine 6012, operating the scheduling engine 6022, and operating the settlement engine 6032.

FIG. 1B depicts a detail flowchart of operation 6012 of FIG. 1A further operating the market engine.

Arrow 6050 directs the flow of execution from starting operation 6012 to operation 6052. Operation 6052 performs supporting a virtual trading floor interacting with the active certified clients to create the commitment. Arrow 6054 directs execution from operation 6052 to operation 6056. Operation 6056 terminates the operations of this flowchart.

Arrow 6060 directs the flow of execution from starting operation 6012 to operation 6062. Operation 6062 performs supporting bilateral trading involving the active certified clients to create the commitment. Arrow 6064 directs execution from operation 6062 to operation 6056. Operation 6056 terminates the operations of this flowchart.

Arrow 6070 directs the flow of execution from starting operation 6012 to operation 6072. Operation 6072 performs supporting external market trading involving the active certified clients to create the commitment. Arrow 6074 directs execution from operation 6072 to operation 6056. Operation 6056 terminates the operations of this flowchart.

Arrow 6080 directs the flow of execution from starting operation 6012 to operation 6082. Operation 6082 performs maintaining the commitment list. Arrow 6084 directs execution from operation 6082 to operation 6056. Operation 6056 terminates the operations of this flowchart.

Certain embodiments of the invention include operating the market engine including at least the operations of FIG. 1B.

FIG. 1C depicts a detail flowchart of operation 6022 of FIG. 1A further operating the scheduling engine, for each of the certified clients belonging to the certified client collection.

Arrow 6090 directs the flow of execution from starting operation 6022 to operation 6092. Operation 6092 performs sending a scheduling commitment access request for the certified client regarding the commitment list. Arrow 6094 directs execution from operation 6092 to operation 6096. Operation 6096 terminates the operations of this flowchart.

Arrow 6100 directs the flow of execution from starting operation 6022 to operation 6102. Operation 6102 performs receiving a scheduling commitment report in response to the scheduling commitment access request based upon the commitment list to create the received scheduling commitment report for the certified client. Arrow 6104 directs execution from operation 6102 to operation 6096. Operation 6096 terminates the operations of this flowchart.

Arrow 6110 directs the flow of execution from starting operation 6022 to operation 6112. Operation 6112 performs generating the schedule for the certified client based upon the received scheduling commitment report for the certified client whenever the received scheduling commitment access report references commitments requiring scheduling. Arrow 6114 directs execution from operation 6112 to operation 6096. Operation 6096 terminates the operations of this flowchart,

FIG. 1D depicts an alternative detail flowchart of operation 6022 of FIG. 1A further operating the scheduling engine, for each of the certified clients belonging to the certified client collection.

Arrow 6150 directs the flow of execution from starting operation 6022 to operation 6152. Operation 6152 performs sending a scheduling commitment access request for the certified client regarding the commitment list. Arrow 6154 directs execution from operation 6152 to operation 6156. Operation 6156 performs receiving a scheduling commitment report in response to the scheduling commitment access request based upon the commitment list to create the received scheduling commitment report for the certified client. Arrow 6158 directs execution from operation 6156 to operation 6160. Operation 6160 performs generating the schedule for the certified client based upon the received scheduling commitment report for the certified client whenever the received scheduling commitment access report references commitments requiring scheduling. Arrow 6162 directs execution from operation 6160 to operation 6164. Operation 6164 terminates the operations of this flowchart.

One skilled in the relevant arts will note that FIGS. 1C and 1D perform equivalent operations, and represent two of many equivalent implementations. FIG. 1C represents a typical style of partitioning activities employed in real time event driven operating environments. FIG. 1D represents another typical style of partitioning showing the successive operations performed for the certified client. Note that FIG. 1D hides the messaging control, while FIG. 1C makes the succession of operations for the certified client less apparent. From hereon, the discussion will focus on whichever approach is more transparent, while it is to be understood that either approach may be found in specific embodiments of the invention.

Note that a commitment may be performed without requiring a schedule. For example, a first certified client may buy a certain amount of green tickets from a second certified client. In such situations, there might be no schedule generated for that commitment, but each certified client involved in the commitment would find the commitment referenced in the settlement.

A commitment may be scheduled for performance, but not actually be performed. For example, a network operator may curtail the availability of electrical power to consumers in certain areas to avert a blackout. Those consumers, while having scheduled commitments, did not fully enjoy the performance of the commitments. While the schedule would reflect the commitment, the settlements for those consumers would reference the actual performance of that commitment.

FIG. 1E depicts a detail flowchart of operation 6032 of FIG. 1A further operating the settlement engine.

Arrow 6190 directs the flow of execution from starting operation 6032 to operation 6192. Operation 6192 performs processing a settlement for the certified client, for each of the certified clients belonging to the certified client collection. Arrow 6194 directs execution from operation 6192 to operation 6196. Operation 6196 terminates the operations of this flowchart.

Arrow 6200 directs the flow of execution from starting operation 6032 to operation 6202. Operation 6202 performs maintaining a performance database. Arrow 6204 directs execution from operation 6202 to operation 6196. Operation 6196 terminates the operations of this flowchart.

A performance database may include metering data indicating the performance of various commitments.

FIG. 1F depicts a detail flowchart of operation 6192 of FIG. 1E further processing the settlement for each of the certified clients belonging to the certified client collection.

Arrow 6230 directs the flow of execution from starting operation 6192 to operation 6232. Operation 6232 performs sending a settlement commitment access request regarding the commitment list for the certified client. Arrow 6234 directs execution from operation 6232 to operation 6236. Operation 6236 performs receiving a settlement commitment report in response to the settlement commitment access request to create the received settlement commitment report for the certified client. Arrow 6238 directs execution from operation 6236 to operation 6240. Operation 6240 performs presenting a performance access request regarding the performance database for the certified client. Arrow 6242 directs execution from operation 6240 to operation 6244. Operation 6244 performs receiving a performance report in response to the performance access request to create the received performance report for the certified client. Arrow 6246 directs execution from operation 6244 to operation 6248. Operation 6248 performs generating the settlement for the certified client based upon the received performance report for the certified client and based upon the received settlement commitment report for the certified client. Arrow 6250 directs execution from operation 6248 to operation 6252. Operation 6252 terminates the operations of this flowchart.

FIG. 2A depicts a simplified system block of a computing system 3000 supporting interaction between a collection of certified clients and a computing system based upon supporting operations of a market engine, a scheduling engine, a settlement engine, in accordance with certain embodiments of the invention.

Computing system 3000 is comprised of at least one computer 3020 coupled 3024 to computer readable memory 3026. The communication and interaction between computing system 3000 and computer 3020 is denoted by arrow 3022. Such communication and interaction 3022 may employ a variety of communications technologies, including a wireless physical transport layer in certain embodiments of the invention. Alternatively, communication and interaction 3022 may employ a wireline physical transport layer.

Note that these entities, the human being 3100, corporate entity 3120, agent 3140 and software agent 3160 may communicate with computing system 3000 by use of messages as represented by arrows 3102, 3122, 3142, and 3182, respectively. Such messages may use a wireline physical transport layer as represented by one or more of the arrows 3102, 3122, 3142, and 3182. Such messages may use a wireless physical transport layer as represented by one or more of the arrows 3102, 3122, 3142, and 3182. Such messages may use body signals in certain further embodiments of the invention. Such messages may further use hand signals. Such message may also use acoustic signaling of messages. Such messages may also further use verbal messages in a human language.

Note that certain embodiments of the invention may include only a market engine of the invention supporting at least any two of the following: a virtual trading floor 6032, bilateral trading 6042 and/or external market trading 6052, as well as maintain the commitment list 6062.

FIG. 2B depicts a refinement of computing system 3000 as a system diagram in FIG. 2A. This computing system is comprised of a client computer collection and a server system 3500 coupled to a network 3200.

The client computer collection is comprised of at least one client computer 3600 operated (used) 3192 by certified client 1400. Client computer 3610 may be operated (used) 3104 by a human being as client 3100. Client computer 3620 may be operated (used) 3124 by a corporate entity as client 3120. Client computer 3630 may be operated (used) 3144 by an authorized agent as client 3140. The certified client may be represented by an agent, authorized by the first party, to act on behalf of the first party with respect to contracting.

Server system 3500 includes at least one server computer 3520 coupled to network 3200. Network 3200 further couples 3602, 3612, 3622, 3632 and 3642 to client computers 3600, 3610, 3620, 3630 and 3640, respectively. Network 3200 at least supports communication between client computers and at least one server computer 3520 of server system 3500. As used herein, the term network refers not only to Local Area Networks (LANs), but also to Wide Area Networks (WANs). Network supported communication as used herein includes, but is not limited to, digital communication protocols as well as analog communication protocols. Network supported communication as used herein further includes, but is not limited to, message passing protocols and packet based protocols. Network supported communication as used herein further includes, but is not limited to, communication protocols including TCP/IP. Network supported communication as used herein further includes, but is not limited to, communication protocols supporting the Internet. Network supported communication as used herein further includes, but is not limited to, communication protocols supporting the World Wide Web.

Client computer 3610 with coupled 3614 computer readable memory 3616 may be operated 3104 by a client 1400 further coupled 3194 to computer readable memory 3606. Client computer 3640 with coupled 3644 computer readable memory 3646 may be operated 3164 by a software agent as client 3160. The coupling 3194 may provide various personal optimizations and shortcuts, including, but not limited to, macro style functions and standard contract forms employed by the client 1400.

Server system 3500 may include at least one server computer 3520 coupled 3524 to computer readable memory 3526.

FIG. 2C depicts a refinement of computing system 3000 as a system diagram in FIG. 2B. This computing system is comprised of a client computer collection and a server system 3500 coupled to a network 3200.

Server system 3500 may include at least one server computer 3520 coupled 3524 to computer readable memory 3526.

Note that server computer coupled computer readable memory may contain a read-write accessible memory. Note that the read-write accessible memory may contain at least one mass storage unit. In certain a mass storage unit may include a disk drive. A mass storage unit may be accessed using a file management system. A mass storage unit may be accessed as a database.

Certain embodiments of the invention include a method of operating a client computer with a client computer message address interfaced with a reliable distributed system composed of a server system containing server computers with associated messaging addresses. The method includes a login procedure, a message composition procedure for an outgoing message to the reliable distributed system, and a message analysis procedure for an incoming message from the reliable distributed system.

The login procedure may maintain a list of messaging addresses of the collection of computers of the distributed system, a first login message and a login protocol and performs the following:

a. A first server computer of the server system is selected, and a first login message is sent to the associated address of the first server computer.

b. If there is a first acknowledgement message received from the first server computer message address then the login procedure proceeds to perform the login protocol.

c. Whenever the login protocol fails with the first server computer or

whenever there is no acknowledgement message received from the first server computer within a predetermined amount of time or

whenever there remain server computers in the server system for which login has not been attempted,

a new first server computer is selected from the remaining server computers of the server system and these steps are repeated.

d. Whenever the login protocol succeeds with the first server computer, the first server computer is designated the connection computer.

The message composition procedure for an outgoing message to the distributed system may comprise performing the following: Maintaining a list of message formats. Determining the selection of a first message format. Using the first message format to create an outbound message. Sending the outbound message to the connection computer.

The message analysis procedure for an incoming message from the distributed system may comprise performing the following: Receiving the message from the connection computer. Validating the received message creates a valid received message.

An object class structure may be used to support message passing, each message comprising a message type and at least one message field. Each message-passing object comprises handling an unknown message type and handling for an unknown message field.

Handling an unknown message type for a received message from a first object by a second object may comprise the first object sending the second object a reply message indicating unknown received message type and referencing the received message.

Handling an unknown message field of the received message by the second object may comprise handling the other fields of the received message by the second object.

Certain embodiments of the invention may operate a reliable distributed system of a collection containing at least one process group running on several computers comprising receiving confirmed messages from certified clients and maintaining a group state. Each process group computer possesses a messaging address. The computers of a process group communicate amont themselves with a virtually synchronous messaging system.

Receiving a confirmed message from a certified client may occur at one computer of the first collection of computers running the process group. Upon receipt the receiving computer broadcasts the confirmed message from the certified client to all computers of the first collection of computers.

Maintaining a group state on each computer of the first collection of computers of the process group may comprise the following operations: Each computer processes the confirmed message from the certified client to create a group state candidate. Each computer broadcasting a virtually synchronous group state candidate message to the other computers. Each computer receives the virtually synchronous group state candidate messages of the other computers. Each computer analyzes the received virtually synchronous group state candidate messages and its own virtually synchronous group state candidate to create a new group state.

Certain embodiments of the invention employ a messaging system for message passing concurrent objects, instances of which reside on computers each possessing a controller belonging to a collection of computers comprising ABCAST protocol and GBCAST protocol. The ABCAST protocol is an atomic broadcast protocol used to communicate messages between object instances across the computers of the collection of computers. The GBCAST protocol is a global broadcast protocol to communicate messages between controllers of the computers of the collection of computers.

Certain embodiments of the invention employ an object class structure executing in a process group of computers communicating with each other via a messaging protocol supporting at least virtual synchrony. Each instance of each object of the object class structure comprises an object instance clone reading on each of the process group computers.

Each object instance may further send and receive messages from other object instances and each object instance clone communicates with messages to other object instance clones of the same object instance.

Each object class may further possess a state, which is a member of a collection of states. Each instance of each object class state changes as an atomic event. All activities of each object class occur as atomic events. Atomic events may be triggered by message reception. Each instance of an object receives messages triggering state changes in the same sequence as all other instances of that object. This enforces all R-Object instances changing their state through exactly the same sequence without having to directly communicate that new state amongst themselves.

A concurrent computing entity may reside on each of the computers of a process group of computers where it owns access to a binary file or memory used for storing the resilient object instance state. It executes updates to the binary file as a transaction. The storage in the binary file is organized into table objects. Each table object consists of a set of records.

FIG. 2D depicts a grid management system providing functions and services for grid market operations including a collection of client computers 3700, 3720, 3740, 3760 and 3780 respectively coupled through network 3200 to server system 3500 including server computer 3520, and web server computer 3560, as well as server computer 3580 and database engine 3590.

The discussion of variations regarding the use of client computers is found in FIGS. 2B and 2C. A certified client, possibly a human being, corporate entity, agent, or software agent may each control any of client computers 3700, 3720, 3740, 3760 and 3780.

As used herein, MOPI refers to Market Operations Participant Interface. MOPI is an interface that may include, but is not limited to, the functions and capabilities of Participants, who are certified clients of the system.

As used herein, RTOI refers to RTO Operator Interface. RTOI is an interface that may include, but is not limited to, the functions and capabilities of Participants, who are certified clients of the system and who interact as RTO Operators within one or more grids. RTOI components may further perform operations including, but not limited to,

Receiving energy management schedules,

Confirming receipt of energy management schedules,

Receiving requests for energy equipment status,

Providing energy equipment status,

Sending requests for energy equipment status,

Receiving energy equipment status reports,

Receiving metering data about transmission lines,

Receiving frequency data about transmission lines, and

Sending output adjustment commands to remote energy generation sites.

Note that these output adjustment commands have the effect of modifying the transmission line frequencies and the output adjustment commands take into account the effect on transmission line frequencies as well as flowgate constraints in making these commands.

Command override messages which put a specific remote energy site off limits to automated control and places it under manual control of the operator.

As used herein, EMS will refer to Energy Management System. EMS realtime components may perform operations including, but not limited to,

Receiving energy management schedules,

Confirming receipt of energy management schedules,

Receiving requests for energy equipment status,

Providing energy equipment status,

Receiving requests for energy equipment status,

Providing energy equipment status,

Sending requests for energy equipment status

Receiving energy equipment status reports

Receiving Metering data about transmission lines

Receiving frequency data about transmission lines

Sending output adjustment commands to remote energy generation sites.

Note these output adjustment commands have the effect of modifying the transmission line frequencies and the output adjustment commands take into account the effect on transmission line frequencies as well as flowgate constraints in making these commands.

Command override messages which put a specific remote energy site off limits to automated control and places it under manual control of the operator.

In certain embodiments of the invention, there may be client computers with accessible memory containing MOPI components such as client computers 3700 and 3720 or containing RTOI components such as client computers 3740 and 3760 or containing EMS components such as client computer 3780. There may be no client computers with accessible memory containing MOPI components such as client computers 3700 and 3720. There may be no client computers with accessible memory containing RTOI components such as client computers 3740 and 3760. There may be no client computers with accessible memory containing EMS components such as client computer 3780.

In certain embodiments of the invention, client computer 3700 accessibly couples 3704 to computer readable memory 3706 as well as communicatively couples 3702 to network 3200. The MOPI realtime component 3710 and MOPI dynamic and static component 3712 may both reside in accessibly coupled memory 3706.

The MOPI realtime component 3710 may include a method of using market engine 3810 with MOPI dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The MOPI realtime component 3710 may include the ability to use communication with more than one server computer 3520 within server system 3500 to communicate within a session with the market engine 3810.

The MOPI realtime component 3710 may include the ability to encrypt the communication with server system 3500. Alternatively, the client computer 3700 may include security devices insuring security independently of the method of using the market engine. Additionally both the MOPI realtime component 3710 and the client computer 3700 may act together to provide two layers of security.

In certain embodiments of the invention, client computer 3720 accessibly couples 3724 to computer readable memory 3726 as well as communicatively couples 3722 to network 3200. The MOPI software component 3730 and MOPI dynamic and static component 3732 may both reside in accessibly coupled memory 3726.

The MOPI realtime component 3730 may include a method of using market engine 3810 with MOPI dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The MOPI realtime component 3730 may include the ability to use communication with more than one server computer 3520 within server system 3500 to communicate within a session with the market engine 3810. MOPI realtime component 3730 may further include API 3734, which controls the ability to use communication with more than one server computer 3520 within server system 3500 to communicate within a session with the market engine 3810.

The MOPI realtime component 3730 may include the ability to encrypt the communication with server system 3500. Alternatively, the client computer 3720 may include security devices insuring security independently of the method of using the market engine. Additionally both the MOPI realtime component 3730 and the client computer 3720 may act together to provide two layers of security. MOPI realtime component 3730 may include security module 3736 providing the ability to encrypt the communication with server system 3500.

Client computer 3740 accessibly couples 3744 to computer readable memory 3746 as well as communicatively couples 3742 to network 3200. The RTOI software component 3750 and RTOI dynamic and static component 3752 may both reside in accessibly coupled memory 3746.

The RTOI realtime component 3750 may include a method of using market engine 3810 with RTOI dynamic and static component 3712. The method of using market engine 3810 may include, but is not limited to, participating in sessions with market engine 3810 in which at least one of the following m [symbol] occur. An order may be sent, which may include one or more ask orde [symbol] and/or one or more bid orders. A market price may be requested. A mark [symbol] price may be received. A validated commitment may be received. Notificatio [symbol] of the opening or closing of a market interval may be received.

The RTOI realtime component 3750 may include the ability to use communication with more than one server computer 3520 within server system 3500 to communicate within a session with the market engine 3810. RTOI realtime component 3750 may further. include API 3754, which controls the ability to use communication with more than one server computer 3520 within server system 3500 to communicate within a session with the market engine 3810.

The RTOI realtime component 3750 may include the ability to encrypt the communication with server system 3500. Alternatively, the client computer 3740 may include security devices insuring security independently of the method of using the market engine. Additionally both the RTOI realtime component 3750 and the client computer 3740 may act together to provide two layers of security. RTOI realtime component 3750 may include security module 3756 providing the ability to encrypt the communication with server system 3500.

Client computer 3760 accessibly couples 3764 to computer readable memory 3766 as well as communicatively couples 3762 to network 3200. The RTOI software component 3770 and RTOI dynamic and static component 3772 may both reside in accessibly coupled memory 3766.

The RTOI realtime component 3770 may include a method of using market engine 3810 with RTOI dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The RTOI realtime component 3770 may include the ability to use communication with more than one server computer 3520 within server system 3500 to communicate within a session with the market engine 3810. RTOI realtime component 3770 may further include API 3774, which controls the ability to use communication with more than one server computer 3520 within server system 3500 to communicate within a session with the market engine 3810.

The RTOI realtime component 3770 may include the ability to encrypt the communication with server system 3500. Alternatively, the client computer 3760 may include security devices insuring security independently of the method of using the market engine. Additionally both the RTOI realtime component 3770 and the client computer 3760 may act together to provide two layers of security. RTOI realtime component 3770 may include security module 3776 providing the ability to encrypt the communication with server system 3500.

Client computer 3780 accessibly couples 3784 to computer readable memory 3786 as well as communicatively couples 3782 to network 3200. The EMS realtime component 3790 may both reside in accessibly coupled memory 3706.

The EMS realtime component 3790 may include a method of using market engine 3810 with EMS dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The EMS realtime component 3790 may include the ability to use communication with more than one server computer 3520 within server system 3500 to communicate within a session with the market engine 3810. EMS realtime component 3790 may further include API 3794, which controls the ability to use communication with more than one server computer 3520 within server system 3500 to communicate within a session with the market engine 3810.

The EMS realtime component 3790 may include the ability to encrypt the communication with server system 3500. Alternatively, the client computer 3780 may include security devices insuring security independently of the method of using the market engine. Additionally both the EMS realtime component 3790 and the client computer 3780 may act together to provide two layers of security. EMS realtime component 3790 may include security module 3796 providing the ability to encrypt the communication with server system 3500.

Since many components are integrated into the architecture, they are available to all operational functions. The RTOI software component 3750 and RTOI dynamic and static component 3752, for example, may share the common communications and communicate directly with the RTO participants and RTO staff simultaneously. This permits the creation of integrated user interfaces that contain all of the functions of the services delivered via these systems in a single point of contact. The users are not forced to deal with integration issues and disparate mechanisms to communicate with the RTO.

In certain embodiments of the invention, all individuals wishing to access the RTO systems must establish a login session with the appropriate system. This applies to RTO participants, RTO staff, as well as other systems that are integrated into the platform. Each login session is established under the protocols of the security integrated into the RTO systems. The location of the session may not be important to the system, allowing the RTO to operate multiple sites. The multiple RTO sites may each operate as a monitor site, a failover site, or to share workload. Login session at multiple sites can be connected to server system 3500 simultaneously, and are synchronized by server system 3500.

Each RTO participant may share the same security information for authorized scheduling entities (ASEs), RTO operators, and transmission operators (TOs). This security information may be maintained through the registration interface, through which all permissions for each participant may be maintained. This information may be used to validate all login sessions.

Access to the server system 3500 and/or server computer 3560 may be obtained by establishing a login session with the appropriate system. This may apply to RTO participants, including ASEs, RTO operators, and TOs, as well as other computer systems, such as EMS/SCADA systems. This ensures that only authorized individuals and systems can access the APX systems.

The security information may be checked each time that an RTO participant or computer system attempts to log into server system 3500 or server computer 3520 or web server 3560. Login information may include a login ID and password. Login information may be passed in an encrypted form. If access is permitted, the login session may then be configured in accordance with the permissions associated with the particular login ID.

This ensures that each RTO participant may access only those systems and data to which the participant is authorized.

Access to each system may also be controlled in terms of modes including at least receiving data, placing bids, and viewing positions. This mechanism restricts each login session to its authorized systems, making available only its authorized information, and does so in only its authorized modes.

Each login session may include a real-time, two-way communication session or a secure web-based connection between the RTO participant software and the servers. Each session may rely on one or more encryption mechanisms to encode the communication. For the real-time connections, this mechanism may include frequent encryption key change, which may further be invisible to the user to ensure privacy of communication between each RTO participant and the systems 3500 and 3560.

Certain embodiments may include help desk staff. The help desk staff may not have access to market data, scheduling data, or any participant business data. Further, the help desk staff may be unable observe A/S auction or EIS market activity. The help desk staff may not know who or what was selected or dispatched, or at what price. The help desk staff may in certain embodiments only monitor system conditions, such as the number of sessions logged on, the level of activity in the market (for performance monitoring), and when bidding is opened or closed. The help desk staff may maintain reliable data archives and backups on all servers. The help desk staff may perform these maintenance and archival tasks without regard to content.

In certain embodiments, certified users are primarily approved scheduling entities (ASEs), the control area operators (CAOs), and the RTO operators (regardless of location). These certified users may participate in the RTO at the operational level, using services of the server system 3500 or web server 3560.

Certain embodiments include a method of operating a client computer communicatively coupled to an engine system. The engine system includes at least one of the following: a market engine, a scheduling engine and a settlement engine. The client computer communicating with the engine system supports certified client transactions regarding market intervals. Each market interval contains at least one fungible, ephemeral commodity, a location and a time interval.

An engine group includes at least two engine group computers, each implementing a market engine, a scheduling engine or a settlement engine. Note that two engine group computers may redundantly implement a market engine. Alternatively, two engine group computers may redundantly implement a scheduling engine. Additionally, two engine group computers may redundantly implement a settlement engine. An engine group may include two engine group computers implementing different engines. The engine group provides multiple access mechanisms by which communications between the client computer and the engine system may take place.

Note that the engine system may include one or more engine groups. Note that the engine system may be implemented as an engine group.

The client computer may interact with at least one member of the engine group by establishing the client computer as the certified client through communication with the engine system and participating as the certified client communicating with the engine system.

The engine group advantageously removes the potential for a single point of failure in the communication between the client and the engines implemented by the engine group, increasing the overall communication system reliability.

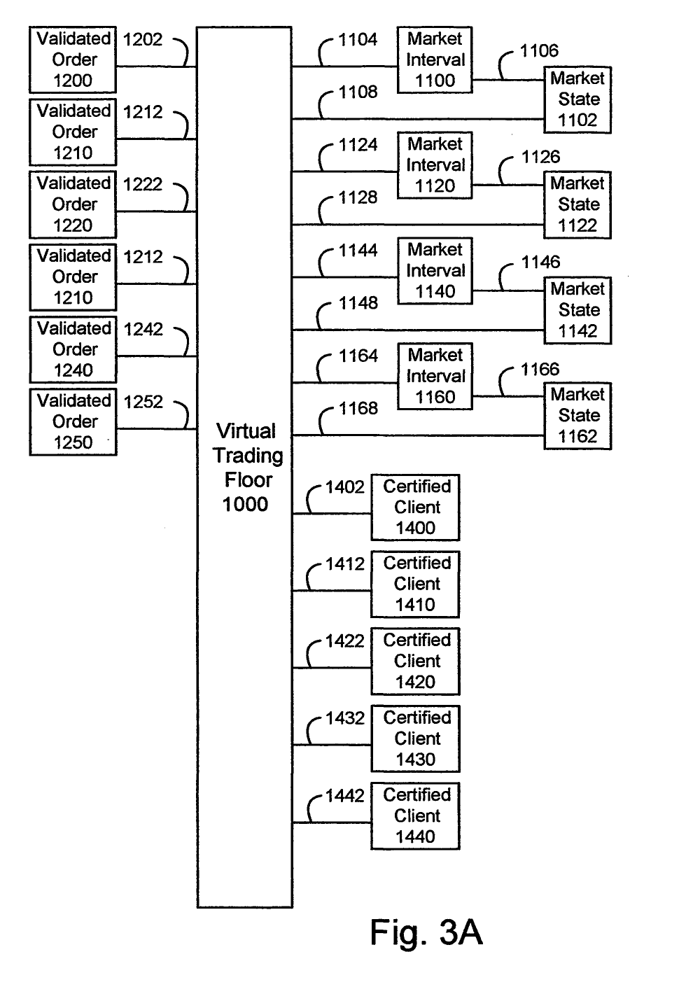

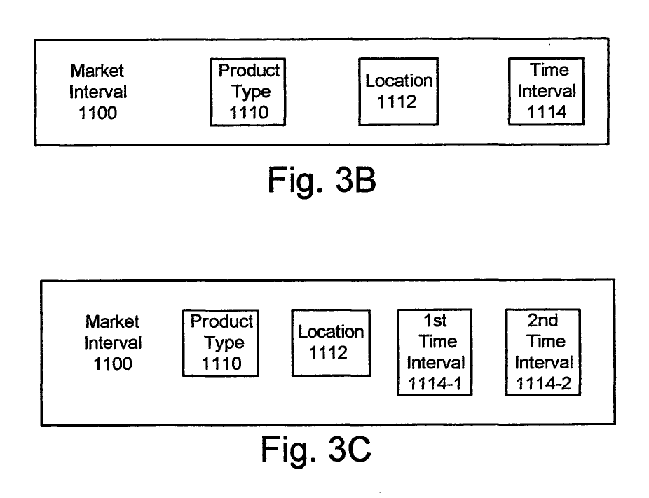

FIG. 3A depicts a virtual trading floor 1000, containing validated orders and market intervals with associated market states and further containing a certified client collection of certified clients in accordance with certain embodiments of the invention.

The virtual trading floor mechanism 1000 comprises a collection of market intervals, each with an associated market state, and validated orders. A market contains a product type and a location. Trading in the market is done in terms of market intervals 1100, 1120,1140 and 1160. Each market interval of a market contains the market product type, market location, plus a calendar scheme with an interval end. The market state of a market interval comprises a market price for the market interval product type at the market interval location during the market interval time interval.

A validated order may contain an amount of the market interval product type, a price for the market interval product type. The validated order is either a bid validated order or an ask validated order.

This figure also depicts a certified client collection comprised of certified clients. Certified clients may include, but are not limited to, human beings. Certified clients may further include, but are not limited to, corporate entities. Certified clients may also further include agents authorized by the certified clients to represent them in interactions regarding the virtual trading floor. Certified clients may also further include software agents executing on software agent computers authorized by certified clients to represent them in interactions regarding the virtual trading floor. Note that in certain embodiments of the invention, the market engine manages and/or maintains the certified client collection.

A virtual trading floor may support trading ephemeral, fungible commodities of an electrical power grid containing at least one AC power network. Each AC power network further contains a node collection of at least two nodes. The product type of the market intervals of the market interval collection may be a member of a product type collection comprised of energy and AC power transfer. The location of a market interval having an energy product type may be a first node of the node collection of an AC power network contained in the electrical power grid. The location of a market interval having an AC power transfer product type may be from a first node of a first AC power network contained in the electrical power grid to a second node of the first AC power network.

Some certified clients may be “market makers”. Market makers are market participants who have taken on the additional role of attempting to arbitrage in transmission. Market makers use the computing system to access point-to-point transmission orders and individual flowgate orders. Market makers may also have their own inventories of point-to-point transmission rights and flowgate rights, which they may or may not choose to post in the market.

Market makers may also be described as market providers in certain economic systems, where the term “market maker” has a pre-established and divergent meaning.

Market makers may receive “request for quotes” triggered whenever a participant opens an Energy Market screen for a particular facility, market, strip, and lot size. Using mathematical models of their own choosing, market makers may generate quotes for the transmission products displayed on the participant's screen. These quotes may be submitted to the computing system as market maker quotes.

The computing system may identify market maker quotes, and may keep them separate from the standing orders submitted by participants who actually own, or wish to buy, transmission. The reason is that the market maker quotes are derived from the standing orders, and market makers will not want to consider these derived quotes when creating new derived quotes. If they did, the number of possibilities for them to consider would explode, with no gain in information.

Market makers may interactively submit their quotes to the computing system. Speed in calculating quotes would be of the essence, since the only real risk to the market maker is posting a quote based on stale data.

Market makers may withdraw their quotes at any time, even after the participant has signaled his/her acceptance and it is on the way back through the network to the market maker. Market makers may not, however, refuse an order that is based on a quote that is still posted at the time they receive that order. Not having this rule would open the way for all kinds of gaming by market makers, which would undermine the integrity of the market. Like market makers everywhere, market makers in this system must be constantly reevaluating and updating their quotes.

A single market could have multiple competing market makers. Market makers may compete for competitive advantage based on the speed of their responses (thereby minimizing losses due to stale quotes), the ability of their algorithms to find the best price, their skill at maintaining strategic inventories of flowgates and point-to-point transmission rights, and their operating costs. This kind of competition encourages innovation, low costs, and liquidity, and will be good for the participants.

Market makers may be allowed to go into a negative position in individual flowgate rights, or even point-to-point rights, assuming they have sufficient credit with the RTO. If the market maker is still in a negative position at the scheduling deadline, he/she will be billed for the missing transmission rights, just as if they had submitted an uncovered schedule. To the participant who bought the transmission right from a market maker with a negative position, the transmission right is the same as any other. This rule provides a “cushion” that insures liquidity in the market. It means that market makers always have a way to quote a price for any transmission the participants may desire to buy or sell. The rule is harmless, in such embodiments, all of these transmission rights affect only the financial settlement.

Allowing market makers to go into negative positions in transmission rights also removes any incentive to hoard transmission rights. Without this rule, hoarding could be attractive in a system with hundreds of flowgates, since one participant could buy up all the rights to some flowgate that is not perceived as scarce for very little money. Without a liquid market in even one flowgate, it might be impossible for market makers to create quotes for many point-to-point rights.

There may be rules prohibiting a single participant from owning more than a certain fraction of a single flowgate. But such rules require policing and can get in the way of some participants with legitimate needs, and might not be effective if several participants act in concert (with or without explicit collusion).

The RTO's role may begin with the initial auctions. The RTO auctions both flowgate rights and point-to-point rights, based on an algorithm that maximizes the value received. This algorithm is similar to the algorithm currently used by PJM to auction FTRs.

Under normal conditions, the RTO stands behind all point-to-point rights, both those auctioned initially and those created (and recreated) by market makers and participants. Any participant can obtain reasonable price certainty by buying a point-to-point right. In the event that one of the 400 flowgates has to be de-rated, the RTO may buy back the flowgate rights or optionally redispatch around the problem.

In the event that a new constraint appears in the system that is not one of the traded flowgates, the RTO may buy back existing flowgate rights in order to force flows to meet the new constraint, or optionally redispatch around the problem. No new flowgates are ever added after the initial auction. With hundreds of degrees of freedom, the RTO has plenty of levers to deal with virtually any constraint that may occur. The real-time LMP runs as if the constraints are on the traded flowgates that the RTO actually uses to limit flow, not the unrepresented constraint.

In general, not representing a constraint in the network creates a potential opportunity for gaming, since the participant could create congestion on the constraint, then get paid by the RTO to mitigate it. However, in a system with hundreds of flowgates, an individual participant is not likely to be able to create much congestion on an unrepresented constraint without exceeding the limit on flowgates that are represented. If the congestion on the unrepresented constraint is due to an equipment failure, the RTO may pay to mitigate the problem, as it would do under FTRs.

In extreme situations, it may not be possible for the RTO to buy back flowgate rights or redispatch at a reasonable cost. In these situations, the RTO may be allowed to buy-back rights from participants on a pro-rata basis at a preset ceiling price.

Such bundled point-to-point rights possess at least the following advantages.

Forward price discovery of congestion costs allows planning of unit maintenance, unit commitment, and hydroelectric resources.

Bundled point-to-point rights advantageously minimize market involvement of RTO in the market, including involvement in the selection of commercially significant flowgates.

Easily traded market instruments for hedging congestion costs, providing virtually complete hedging of risk for participants.

Flowgates provide a mechanism for resolving seams issues between control areas.

Bundled point-to-point rights with a flowgate foundation assure least cost redispatch within system constraints.

Bundled point-to-point rights with a flowgate foundation give a complete set of congestion costs between all locations at delivery time.

Bundled point-to-point rights with a flowgate foundation support participants producing and consuming energy with minimal advance scheduling.

Bundled point-to-point rights with a flowgate foundation provide the ability to handle large numbers of constraints.

FIG. 3B depicts a market interval containing a product type, location and time interval in accordance with certain embodiments of the invention. The product types may include ephemeral, fungible commodities. All product types may be ephemeral, fungible commodities.

Location may refer to a single node. A node may be specified geographically. A node may be specified in terms of nodes in a network. The network may contain both a collection of nodes and a collection of lines, each line extends from a first node to a second node. Note that the term line as used herein does not exclusively imply a straight line. A node may be specified in terms of a node of a network contained in a grid of one or more networks, further containing special lines connecting nodes of potentially distinct networks.

Location may additionally refer to a transition or transfer from a first node to a second node.

A market interval has a uniform price for its product type within the time interval. A market interval may also have uniform buy and sell positions, to support uniform movement of the product within the market interval. A single market interval may be seen to act as an independent commodity market of the fungible, ephemeral commodity for its product type.

FIG. 3C depicts a refinement of a market interval as depicted in FIG. 3B further containing multiple time intervals.

In FIG. 3C, two time intervals are depicted by way of example. More than two time intervals may be contained in one market interval. Each of the multiple time intervals may not temporally overlap the other contained time intervals of the market interval.

Note that both market positions and market prices may have similar formats. Both market positions and market prices may include representations as a quantity, which is a scalar value, and a point or set of points over a calendar line known herein as a time interval. Arithmetic functions and operations including but not limited to addition, subtraction, negation, multiplication, minimums and maximums are readily extended to apply to these scalar values over calendar time.

As stated elsewhere in this document, the minimal condition placed upon the time intervals of a market interval is that they not overlap. It is often advantageous to place further constraints on market intervals in terms of the orders submitted to a virtual trading floor.

These constraints can be thought of as follows: if order market intervals were the footprints on the calendar line, a strip may be considered the shoe that left those footprints. While there may be an indefinitely large number of orders covering the calendar line, there are usually only a small finite number of shoes, i.e. strips involved with those orders. An order's market interval may be further constrained to only begin at discrete points on the calendar line.

By way of example, consider the following strips:

An hourly strip is a market interval that allows orders to be submitted for market intervals that start on the hour and last for an hour.

A daily strip is a market interval that allows orders to be submitted for market intervals that start on the local time day boundary and end on local time boundaries. As used here, local time means the local time with respect to the location of the market segment. Note that because the strip is specified in terms of the local time, the actual length may vary depending on the current calendar day at that location. For example, during daylight to standard time transition in the United States, the daily strip spans 25 hours instead of the standard 24 hours.

A daily off-peak strip allows orders for market intervals that start at the local time day boundary and continue until 6:00 AM local time and then start again at 10:00 PM and continue until the ending day boundary.

Other examples may include, but are not limited to, five-minute strips, monthly strips and yearly strips. The set of strips a market may support must ensure that orders are submitted for non-partially overlapping intervals. These constraints require that strips either be sub-periods of another strip or compliment the strip. An example of two strips, which cannot co-exist in the same market, are the weekly strip and the monthly strip. This is because not all weeks are sub-periods of any one month.

A lot is the quantity in multiples of which an order must be contracted.

A basic function of a market segment is to match buy and sell orders at a single price. Certain embodiments of the invention will satisfy differing rules established for different markets belonging to different regulatory regions regarding that matching process. By way of example, in a bid-ask market, an incoming buy/sell order is immediately matched with the best buy/sell order standing in the market with the trade price as the limit price of the standing order.

In a call-auction market, buy and sell orders are collected together in a batch and matched sometime after they have been submitted. All orders in the batch are traded at the same price, which is calculated based upon the limit prices of all orders in the batch.

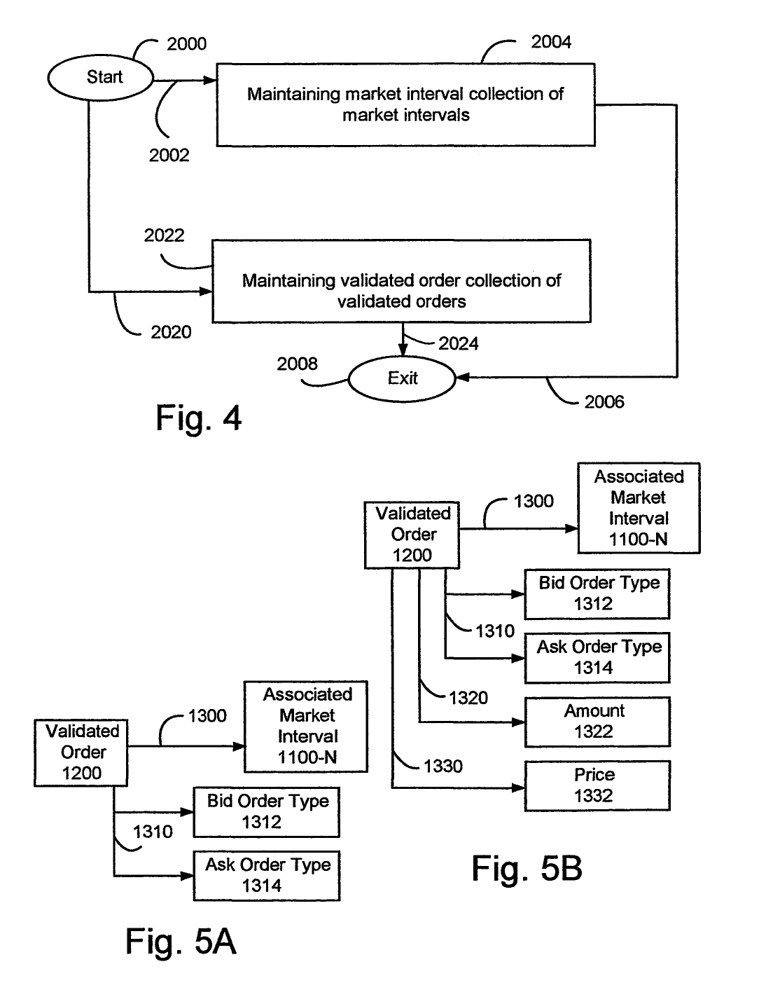

FIG. 4 depicts a flowchart of operations for a method of a virtual trading floor trading ephemeral, fungible commodities in accordance with certain embodiments of the invention.

Operation 2000 starts the operations of this flowchart. Arrow 2002 directs the flow of execution from operation 2000 to operation 2004. Operation 2004 performs maintaining a market interval collection of market intervals. Arrow 2006 directs execution from operation 2004 to operation 2008. Operation 2008 terminates the operations of this flowchart.

Arrow 2020 directs the flow of execution from starting operation 2000 to operation 2022. Operation 2022 performs maintaining a validated order collection of validated orders. Arrow 2024 directs execution from operation 2022 to operation 2008. Operation 2008 terminates the operations of this flowchart.

These operations may be supported by a program step residing in a coupled computer readable memory on at least one computer in a computing system supporting the virtual trading floor for ephemeral, fungible commodities.

Note that FIG. 4 refers as well to operation 6032 of FIG. 1B, supporting a virtual trading floor.

As used herein, the term computer refers to devices including instruction set computers, inferential computers, and analog computers, as well as aggregates of these basic kinds of computers. A computer will also refer to informational appliances incorporating one or more computers in their construction. Such informational appliances may be physically distinct units, or they may be tangibly integrated into other devices, or they may be tangibly integrated into the physically mobile neighborhood of one or more human beings.

As used herein, certain computers, including instruction-processing computers and inferential computers, include coupled computer readable memory to hold what will be termed herein as instructions. Instructions as used herein with regard to instruction set computers will refer to information controlling state transitions of such instruction computers. Based upon the current individual instructions or collections of instructions being executed, and its internal state, the instruction-processing computer will determine its future state. Note that these instructions may either be directly executed by the instruction-processing computer or may be interpretively executed by the instruction-processing computer.

Instructions as used herein with regard to inferential computers refer to information presented to the inferential computer used to infer the future state of the computer based upon an inference base of the inferential computer directed by the presented instruction. Such an inference base may reside internal to the inferential computer in certain cases, or reside in coupled computer accessible memory, which may be both read and written by the inferential computer. Note that inferential computers include, but are not limited to, machines executing various forms of Horn clause predicates as well as constraint rules, pattern recognition templates, fractal pattern templates and fuzzy logic predicate structural elements.

Analog computers as used herein include, but are not limited to, devices directly coupling to analog circuitry. Such analog circuitry as used herein includes, but is not limited to, radio frequency IF stages, opto-electronic interfaces such as lasers embedded in fiber optic communications systems, audio and video pattern recognition circuitry, audio and video output devices. Analog computers as used herein include, but are not limited to, acoustic interfaces to humans, audio and visual identification portals to the contracting of AC power transfer regarding flowgates, encoding and decoding mechanisms used in long distance communication and interfaces to recording devices of agreed contracts.

A program step as used herein refers to instructions in a form executably directing and/or inferentially directing a computer. The program step may reside in computer readable memory accessibly coupled to the computer. Note that, program steps may be native executable instructions of an instruction-processing computer. Program steps may be interpretively executed instructions of an instruction-processing computer.

Certain embodiments of the invention include program operating systems comprised of program steps residing on at least one computer readable memory accessibly coupled to a computer. These program operating systems will be referred to as the program system hereafter. Such embodiments advantageously support utilization of computers to implement such embodiments.

Certain embodiments advantageously support the operations discussed herein as program steps included in a program system executed by a computing system including at least one computer with coupled computer readable memory. The program steps are not required to all belong to the same instruction execution family, they may advantageously include program steps executing on multiple computers.

FIG. 5A depicts a validated order 1200 of the validated order collection in accordance with certain embodiments of the invention.

Validated order 1200 has an associated 1300 market interval 1100-N of the market interval collection. The market interval collection is separately maintained in certain embodiments of the invention. Maintaining the validated order collection and market interval collections may be coupled.

Each validated order 1200 further contains a member of the order type collection 1310 which is either a bid order 1312 of the associated 1300 market interval 1100-N or an ask validated order 1314 of the associated 1300 market interval 1100-N.

FIG. 5B depicts a refinement of FIG. 5A of a validated order 1200 of the validated order collection.

As depicted in FIG. 5A, validated order 1200 has an associated 1300 market interval 1100-N of the market interval collection. The market interval collection is separately maintained in certain embodiments of the invention. Maintaining the validated order collection and market interval collections may be coupled.

As depicted in FIG. 5A, each validated order 1200 further contains a member of the order type collection 1310 which is either a bid order 1312 of the associated 1300 market interval 1100-N or an ask validated order 1314 of the associated 1300 market interval 1100-N.

A validated order may contain 1320 an amount 1322 of the product type 1110-N of the associated 1300 market interval 1100-N.

A validated order may contain 1330 a price 1332 of the product type 1110-N of the associated 1300 market interval 1100-N.

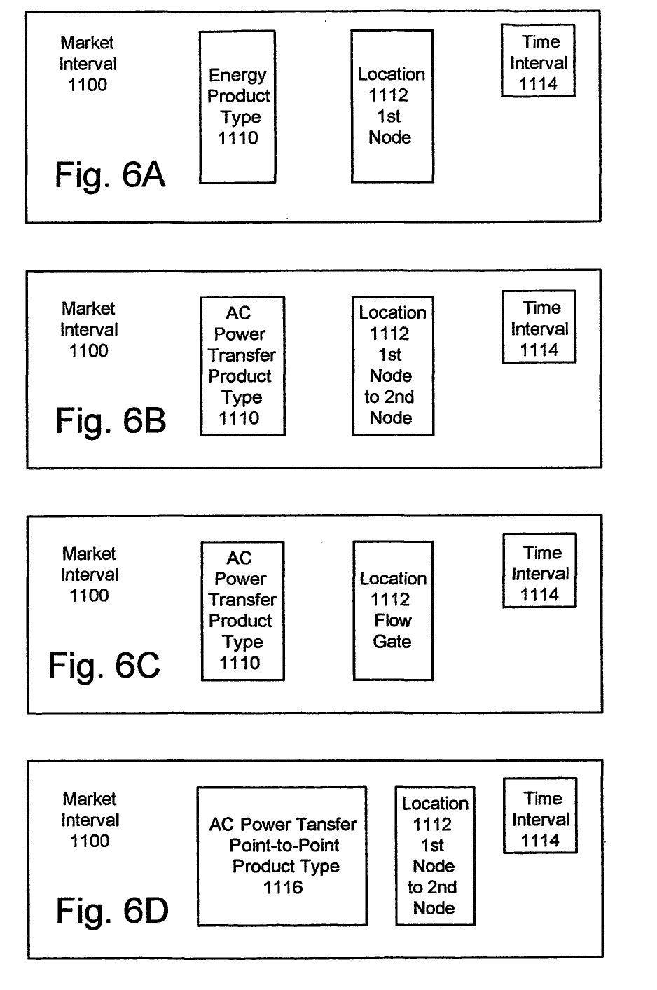

FIG. 6A depicts a refinement of FIG. 3B of a market interval of an energy product type. The product type 1110 of the market interval is further described as an energy product type 1110. The location 1112 is a first node of an AC power network contained in the electrical power grid.

FIG. 6B depicts a refinement of FIG. 3B of a market interval of an AC power transfer product type. The product type 1110 of the market interval is further described as an Energy product type 1110. The location 1112 is from a first node of a first AC power network contained in the electrical power grid to a second node of the first AC power network. Note that this form of location represents a transmission between the first node of the first AC power network and the second node of the first AC power network.

FIG. 6C depicts a refinement of FIG. 6B of a market interval of an AC power transfer product type. The product type 1110 of the market interval is described as an Energy product type 1110. The location 1112 is a flowgate of the flowgate collection of a first AC power network contained in the electrical power grid. Note that flowgates can represent a congestion constraint across more than one transmission line, and may not have a specific first node to second node description.

Such embodiments of the invention of a flowgate market interval are advantageous in providing a market to trade transfer capability between users. Because of the linear nature of AC power transfer throughout an AC power network, these transfer rights can be linearly accumulated to insure the contracted transfers are physically feasible in satisfying the overall flowgate constraints of the AC power network.

FIG. 6D depicts a refinement of FIGS. 6B and 6C of a market interval of an AC power transfer point-to-point product type. The product type 1116 of the market interval is a refinement of the AC power product type 1110 as depicted in FIG. 6B. The product type 1116 of the market interval is further described as an Energy product type 1110. The location 1112 is from a first node of a first AC power network contained in the electrical power grid to a second node of the first AC power network.

Note that as in FIG. 6B, this form of location represents a transmission between the first node of the first AC power network and the second node of the first AC power network. However, a market interval for an AC power transfer point-to-point product type further possesses all the ancillary flowgate transmission rights required for the power transmission from the first node to the second node of the AC power network.

Such market intervals support trading in bundles of flowgates rights as point-to-point rights. From a user perspective, point to point rights are what the market participants really want to buy and sell. They are much simpler to deal with and comprehend than flowgate rights.

In terms of maintaining market liquidity, participants should be very comfortable posting bids and offers for point-to-point AC power transfer rights, since they constitute complete products from a participant perspective.

Bids for AC power transfer point-to-point market intervals are comprised of bids for at least one flowgate transmission right sharing the same location.

Bids for AC power transfer point-to-point market intervals may further comprise bids for each of the flowgates of the flowgate collection sharing the same location. Bids for AC power transfer point-to-point market intervals may further comprise transmission rights for at least one flowgate with differing location. This advantageously supports creating transmissions canceling adverse effects on one or more flowgates.

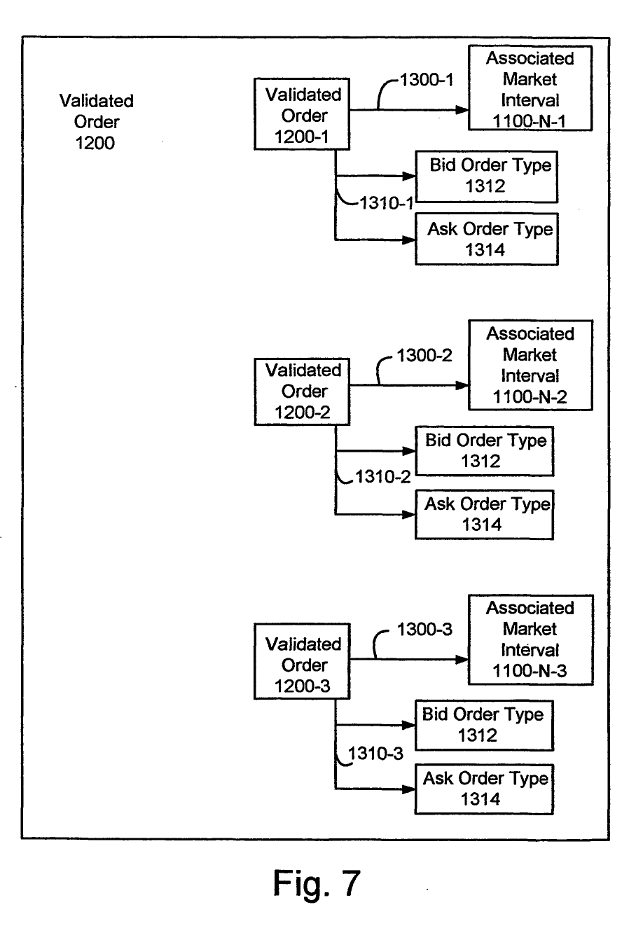

FIG. 7 depicts a validated order 1200 comprised of at least two validated orders, each with an associated market interval in accordance with certain embodiments of the invention.

Validated order 1200-1 has an associated 1300-1 market interval 1100-N-1 of the market interval collection. Validated order 1200-1 further contains a member of the order type collection 1310-1 which is either a bid order 1312 of the associated 1300 market interval 1100-N-1 or an ask validated order 1314 of the associated 1300 market interval 1100-N-1.

Validated order 1200-2 has an associated 1300-2 market interval 1100-N-2 of the market interval collection. Validated order 1200-2 further contains a member of the order type collection 1310-2 which is either a bid order 1312 of the associated 1300 market interval 11 00-N-2 or an ask validated order 1314 of the associated 1300 market interval 11 00-N-2.

Validated order 1200-3 has an associated 1300-3 market interval 11 00-N-3 of the market interval collection. Validated order 1200-3 further contains a member of the order type collection 1310-3 which is either a bid order 1312 of the associated 1300 market interval 1100-N-3 or an ask validated order 1314 of the associated 1300 market interval 1100-N-3.

There may be no specific limit to the number of validated orders comprising a validated order. There may be a limit to the number of validated orders comprising a validated order.

The associated market intervals of multiple validated orders within a validated order may share the same product type. The associated market intervals of multiple validated orders within a validated order may share the same location.

The associated market intervals of multiple validated orders within a validated order may differ in product type. The associated market intervals of multiple validated orders within a validated order may differ in location.

As discussed in the background, the physics of AC power networks indicates each AC power network contained in the electrical power grid further contains a flowgate collection of flowgates. Each flowgate location being either from an associated first node of the AC power network to an associated second node of the AC power network, or in the case of a collection of constrained transmission lines, will be denoted by a flowgate designator. An AC power transfer amount from node1 to node2 produces an amount of AC power transfer across the flowgate as essentially an associated linear, skew-symmetric function of the amount from node1 to node2, for each of the flowgates of the flowgate collection. For each of the flowgates of the flowgate collection, there is at least one market interval in the market interval collection of AC power transfer product type with the flowgate location.

Each validated order of the validated order collection with the AC power transfer product type of the associated market interval may further contain an amount. A validated order of AC power transfer product type from the first node to the second node may be further comprised of a validated order of the flowgate associated market interval. The amount ordered for that flowgate is essentially the associated linear, skew-symmetric function of the amount from the first node to the second node, for each of the flowgates of the flowgate collection.

Note that there may be a price associated with each validated order of the AC power transfers of the flowgates. There may be a price associated with the AC power transfer from the first node to the second node.

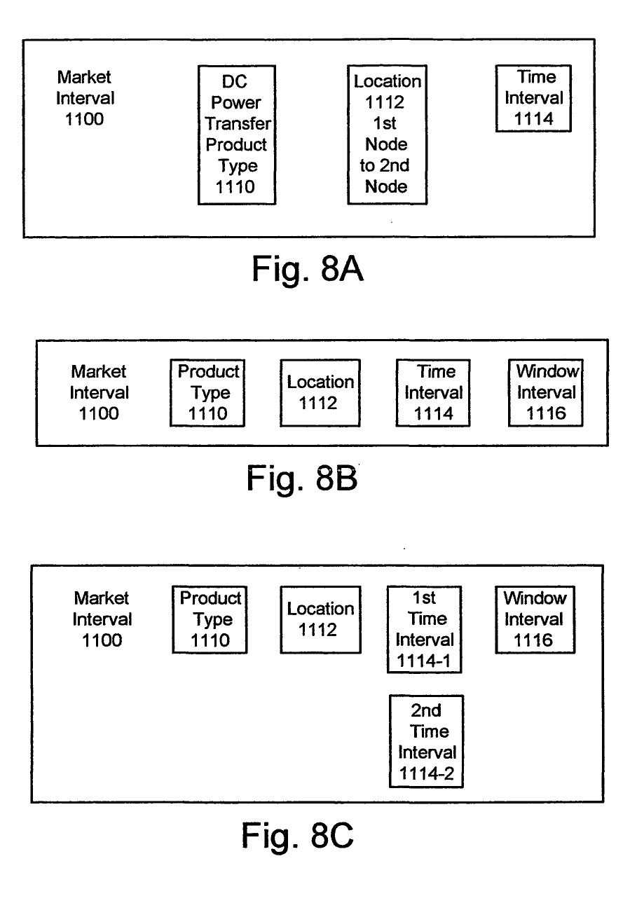

FIG. 8A depicts a market interval of a DC power line in accordance with certain embodiments of the invention. An electrical power grid may further contain a DC power line collection of at least one DC power line at the location of the DC power line from a first node of a first AC power network to a second node of a second AC power network. The product type collection further comprises DC power transfer. For each DC power line of the DC power line collection, there is at least one associated market interval with DC power transfer product type, with the location as the location of the DC power line.

FIG. 8B depicts market interval 1100 of FIG. 3B further containing a window time interval during which the market interval is active only within the window time interval. The window time interval of the market interval entirely occurs before the time interval contained in the market interval for each market interval.

FIG. 8C depicts market interval 1100 of FIG. 8B containing a window time interval and multiple time intervals. Each of the time intervals does not overlap the other time intervals. The window time interval occurs before each of the time intervals.

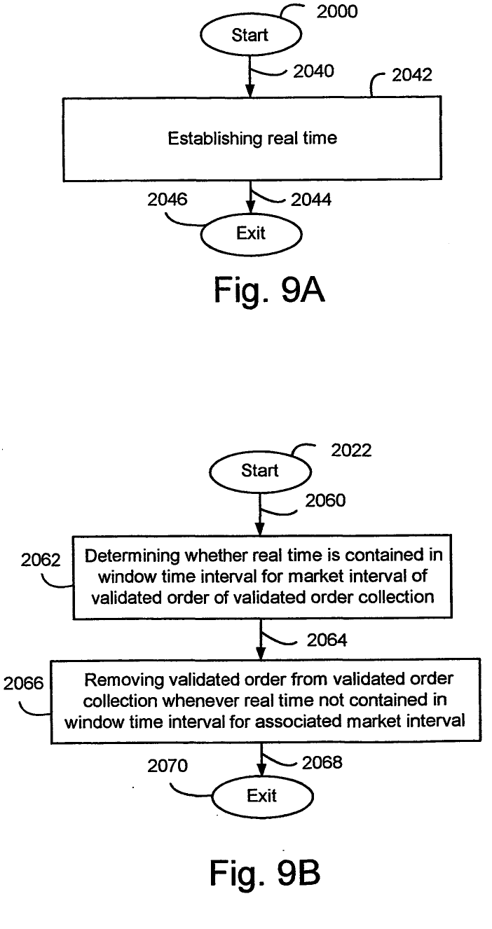

FIG. 9A depicts a detail flowchart of operation 2000 of FIG. 4 performing establishing a real time. A real time is a temporal reference used to determine whether the window time interval contains the real time, making validated orders with the associated market interval active.

Arrow 2040 directs the flow of execution from starting operation 2000 to operation 2042. Operation 2042 performs establishing a real time. Arrow 2044 directs execution from operation 2042 to operation 2046. Operation 2046 terminates the operations of this flowchart.

These operations may be supported by a program step residing in a coupled computer readable memory on at least one computer in a computing system supporting a virtual trading floor for ephemeral, fungible commodities.

FIG. 9B depicts a detail flowchart of operation 2022 of FIG. 4 performing determining whether to remove a validated order from the validated order collection when its associated market interval's window has passed.

Arrow 2060 directs the flow of execution from starting operation 2022 to operation 2062. Operation 2062 performs determining whether the real time is contained in the window time interval for the market interval of the validated order of the validated order collection. Arrow 2064 directs execution from operation 2062 to operation 2066. Operation 2066 performs removing the validated order from the validated order collection whenever the real time is not contained in the window time interval for the associated market interval of the validated order. Arrow 2068 directs execution from operation 2066 to operation 2070. Operation 2070 terminates the operations of this flowchart.

These operations may be supported by a program step residing in a coupled computer readable memory on at least one computer in a computing system supporting a virtual trading floor for ephemeral, fungible commodities.

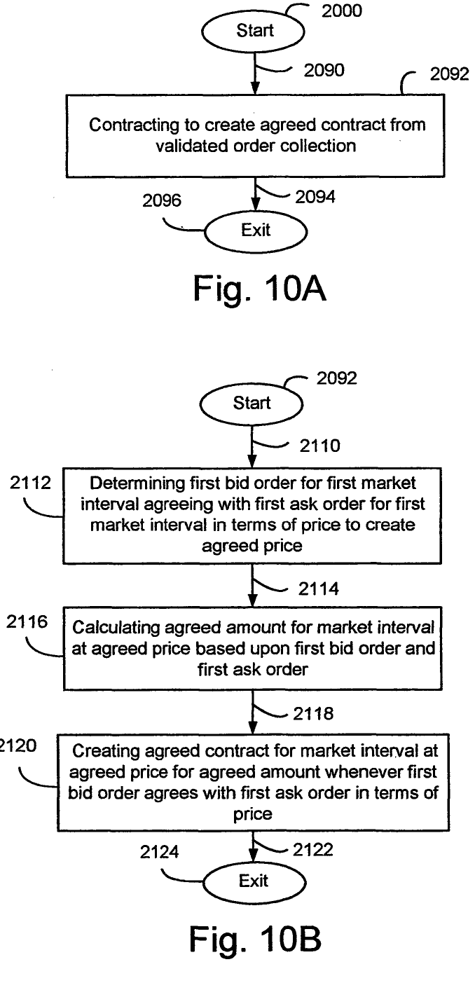

FIG. 10A depicts a detail flowchart of operation 2000 of FIG. 4 performing contracting to create an agreed contract from the validated order collection.

Arrow 2090 directs the flow of execution from starting operation 2000 to operation 2092. Operation 2092 performs contracting to create an agreed contract from the validated order collection. Arrow 2094 directs execution from operation 2092 to operation 2096. Operation 2096 terminates the operations of this flowchart.

These operations may be supported by a program step residing in a coupled computer readable memory on at least one computer in a computing system supporting a virtual trading floor for ephemeral, fungible commodities.

FIG. 10B depicts a detail flowchart of operation 2092 of FIG. 10A performing contracting to create an agreed contract from the validated order collection.

Arrow 2110 directs the flow of execution from starting operation 2092 to operation 2112. Operation 2112 performs determining a first bid order for a first market interval agreeing with a first ask validated order for the first market interval in terms of price to create an agreed price. Arrow 2114 directs execution from operation 2112 to operation 2116. Operation 2116 performs calculating an agreed amount for the market interval at the agreed price based upon the first bid order and first ask validated order. Arrow 2118 directs execution from operation 2116 to operation 2120. Operation 2120 performs creating the agreed contract for the market interval at the agreed price for the agreed amount whenever the first bid order agrees with the first ask validated order in terms of the price. Arrow 2122 directs execution from operation 2120 to operation 2124. Operation 2124 terminates the operations of this flowchart.

Not all validated orders may have a price associated with them. Consider an AC power transfer from node1 to node2 of an AC power network. Assume that the AC power network has a collection of at least three flowgates. A validated order for an AC power transfer amount from node1 to node2 may contain validated orders for an associated amount for each flowgate of the flowgate collection. Each of the flowgate validated orders may contain prices for their respective flowgate. The agreed amount would be calculated based upon the associated amounts and pricing of the flowgates. Alternatively, all validated orders may have a price associated with them.

These operations may be supported by a program step residing in a coupled computer readable memory on at least one computer in a computing system supporting a virtual trading floor for ephemeral, fungible commodities.

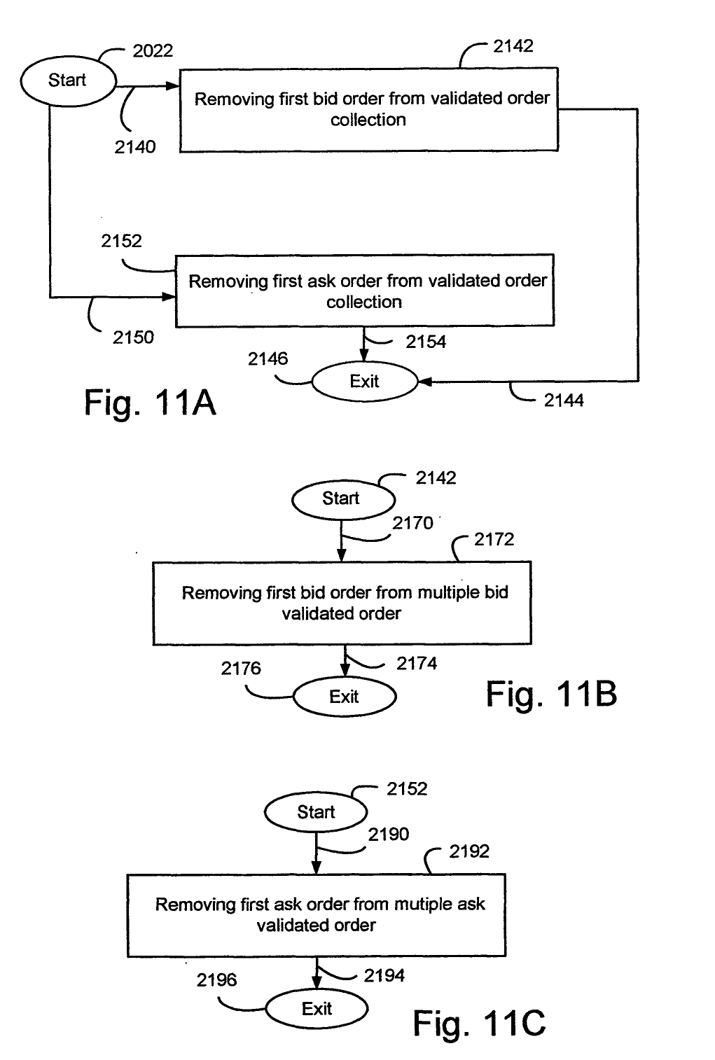

FIG. 11A depicts a detail flowchart of operation 2022 of FIG. 4 performing removing first bid and first ask validated orders from the validated order collection.

Arrow 2140 directs the flow of execution from starting operation 2022 to operation 2142. Operation 2142 performs removing the first bid validated order from the validated order collection. Arrow 2144 directs execution from operation 2142 to operation 2146. Operation 2146 terminates the operations of this flowchart.

Arrow 2150 directs the flow of execution from starting operation 2022 to operation 2152. Operation 2152 performs removing the first ask validated order from the validated order collection. Arrow 2154 directs execution from operation 2152 to operation 2146. Operation 2146 terminates the operations of this flowchart.

These operations may be supported by a program step residing in a coupled computer readable memory on at least one computer in a computing system supporting a virtual trading floor for ephemeral, fungible commodities.

FIG. 11B depicts a detail flowchart of operation 2142 of FIG. 11A performing removing the first bid validated order from the multiple validated order, where the first bid validated order is originally contained in a multiple validated order containing a second validated order.

Arrow 2170 directs the flow of execution from starting operation 2142 to operation 2172. Operation 2172 performs removing the first bid validated order from the multiple validated order contained in the validated order collection comprises removing the first bid validated order from the validated order. Arrow 2174 directs execution from operation 2172 to operation 2176. Operation 2176 terminates the operations of this flowchart.

These operations may be supported by a program step residing in a coupled computer readable memory on at least one computer in a computing system supporting a virtual trading floor for ephemeral, fungible commodities.

FIG. 11C depicts a detail flowchart of operation 2152 of FIG. 11A performing removing the first ask validated order from a multiple validated order, in accordance with embodiments of the invention where the first ask validated order is originally contained in a multiple validated order containing a second validated order.

Arrow 2190 directs the flow of execution from starting operation 2152 to operation 2192. Operation 2192 performs removing the first ask validated order from the validated order. Arrow 2194 directs execution from operation 2192 to operation 2196. Operation 2196 terminates the operations of this flowchart.

These operations may be supported by a program step residing in a coupled computer readable memory on at least one computer in a computing system supporting a virtual trading floor for ephemeral, fungible commodities.

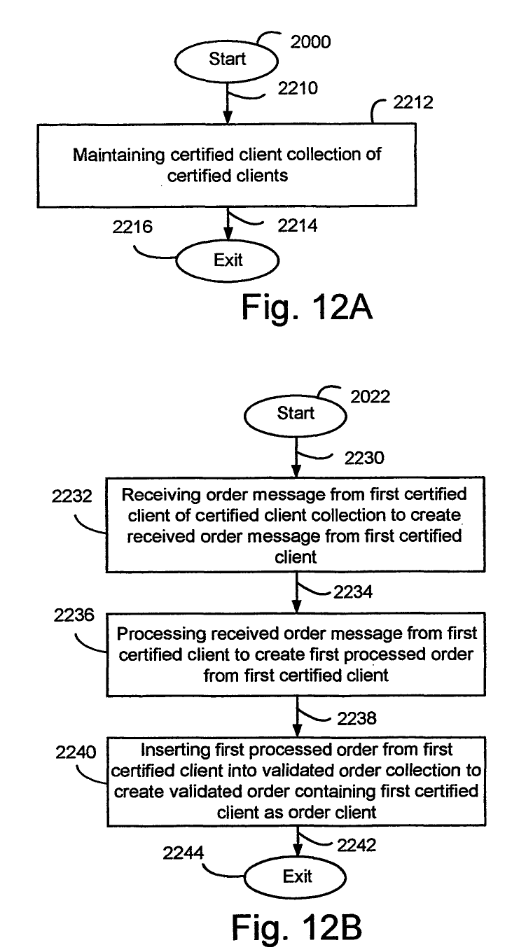

FIG. 12A depicts a detail flowchart of operation 2000 of FIG. 4 performing maintaining a certified client collection of certified clients.

Arrow 2210 directs the flow of execution from starting operation 2000 to operation 2212. Operation 2212 performs maintaining a certified client collection of certified clients. Arrow 2214 directs execution from operation 2212 to operation 2216. Operation 2216 terminates the operations of this flowchart.

These operations may be supported by a program step residing in a coupled computer readable memory on at least one computer in a computing system supporting a virtual trading floor for ephemeral, fungible commodities.

FIG. 12B depicts a detail flowchart of operation 2022 of FIG. 4 performing receiving an order message from a certified client, processing and inserting it into the validated order collection, in accordance with certain embodiments of the invention where each of the validated orders of the validated order collection contains an ordering client.

Arrow 2230 directs the flow of execution from starting operation 2022 to operation 2232. Operation 2232 performs receiving an order message from a first of the certified clients of the certified client collection to create a received order message from the first certified client. Arrow 2234 directs execution from operation 2232 to operation 2236. Operation 2236 performs processing the received order message from the first certified client to create a first processed order from the first certified client. Arrow 2238 directs execution from operation 2236 to operation 2240. Operation 2240 performs inserting the first processed order from the first certified client into the validated order collection to create a validated order containing the first certified client as the order client contained in the validated order collection. Arrow 2242 directs execution from operation 2240 to operation 2244. Operation 2244 terminates the operations of this flowchart.

These operations may be supported by a program step residing in a coupled computer readable memory on at least one computer in a computing system supporting a virtual trading floor for ephemeral, fungible commodities.

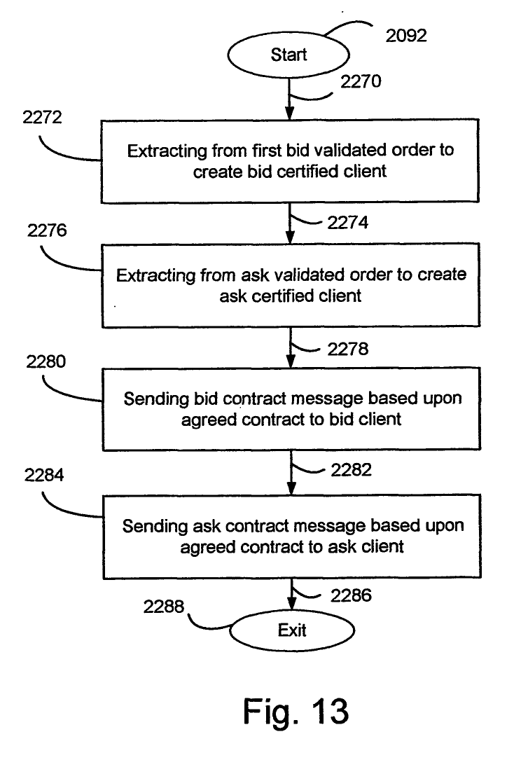

FIG. 13 depicts a detail flowchart of operation 2092 of FIG. 10A performing notified biding and asking clients of the agreed contract for their respective validated orders.

Arrow 2270 directs the flow of execution from starting operation 2092 to operation 2272. Operation 2272 performs extracting from the first bid validated order to create a bid certified client. Arrow 2274 directs execution from operation 2272 to operation 2276. Operation 2276 performs extracting from the ask validated order to create an ask certified client. Arrow 2278 directs execution from operation 2276 to operation 2280. Operation 2280 performs sending a bid contract message based upon the agreed contract to the bid client. Arrow 2282 directs execution from operation 2280 to operation 2284. Operation 2284 performs sending an ask contract message based upon the agreed contract to the ask client. Arrow 2286 directs execution from operation 2284 to operation 2288. Operation 2288 terminates the operations of this flowchart.

These operations may be supported by a program step residing in a coupled computer readable memory on at least one computer in a computing system supporting a virtual trading floor for ephemeral, fungible commodities.

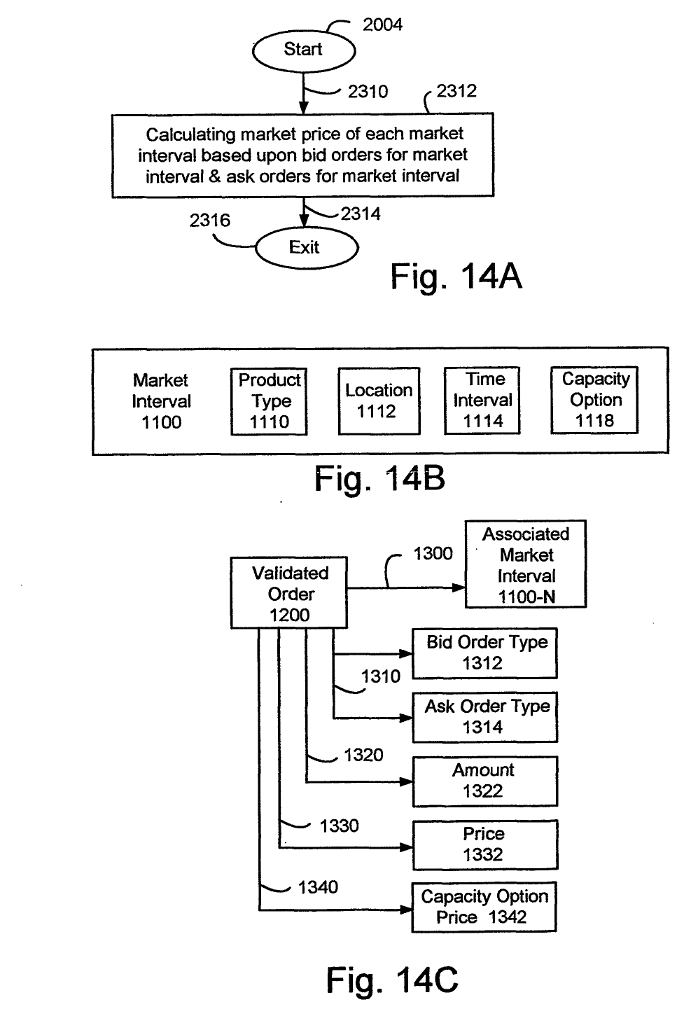

FIG. 14A depicts a detail flowchart of operation 2004 of FIG. 4 performing calculating the market price of each market interval in the market interval collection.

Arrow 2310 directs the flow of execution from starting operation 2004 to operation 2312. Operation 2312 performs calculating the associated market price of each of the market intervals of the market interval collection based upon the bid validated orders of the validated order collection for the market interval and the ask validated orders of the validated order collection for the market interval. Arrow 2314 directs execution from operation 2312 to operation 2316. Operation 2316 terminates the operations of this flowchart.

These operations may be supported by a program step residing in a coupled computer readable memory on at least one computer in a computing system supporting a virtual trading floor for ephemeral, fungible commodities.

FIG. 14B depicts a refinement of FIG. 3B of a market interval 1100 further containing a capacity option type 1118. In certain embodiments of the invention, capacity options are found as ancillary services in AC power networks providing network operators real-time resources to maintain AC power network operational parameters within regulatory and safety limits. In certain other embodiments of the invention, capacity options may be used by certified clients to provide for rapidly applied increases from production facilities of ephemeral, fungible commodities being traded on the virtual trading floor.

FIG. 14C depicts a refinement of the validated order of FIG. 5B further containing 1340 a capacity option price 1342. Capacity options may be traded to permit reservation of an ephemeral, fungible commodity amount. Such reservations have a price, the capacity option price, besides just a price of purchase. In agreeing to a capacity option contract, the seller is only guaranteed the earnings of the capacity option price, and the buyer acquires the right to buy the amount of capacity at or close to real time (subject to scheduling constraints). If the buyer elects to buy the optioned capacity, it is at the price already agreed upon in the contract. The seller then makes additional income from the actual purchased amount at the agreed price.

The virtual trading floor may apply to a power grid containing at least one AC power network, and capacity options can exist for a variety of generation options, including what are sometimes known as spinning and non-spinning resources. Spinning resources are often turbine generators rotating already at operational speed, and thus can be brought on line in a short time. Non-spinning resources include turbines, which are either still, or far below operational rates. Such turbines often take 15-30 minutes to come up to operational speed. These operational distinctions are part of the scheduling constraints that guide the use of such capacity option activities.

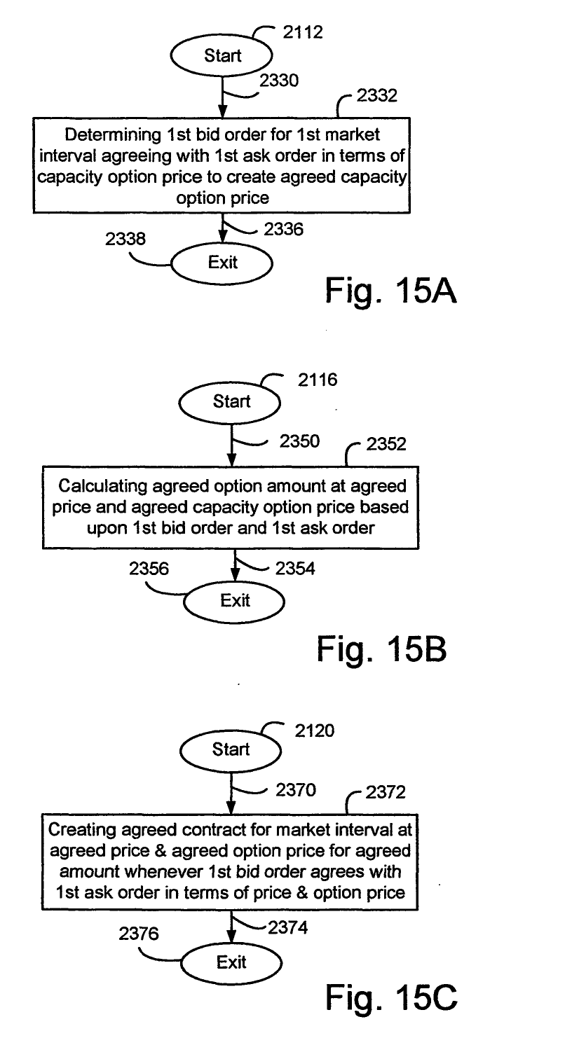

FIG. 15A depicts a detail flowchart of operation 2112 of FIG. 10B performing determining bid order agreement with ask order for an associated capacity option market interval.

Arrow 2330 directs the flow of execution from starting operation 2112 to operation 2332. Operation 2332 performs determining a first bid validated order for a first market interval agreeing with a first ask validated order for the first market interval in terms of capacity option price to create an agreed capacity option price. Arrow 2334 directs execution from operation 2332 to operation 2336. Operation 2336 terminates the operations of this flowchart.

These operations may be supported by a program step residing in a coupled computer readable memory on at least one computer in a computing system supporting a virtual trading floor for ephemeral, fungible commodities.

FIG. 15B depicts a detail flowchart of operation 2116 of FIG. 10B performing calculating an agreed option amount.

Arrow 2350 directs the flow of execution from starting operation 2116 to operation 2352. Operation 2352 performs calculating an agreed option amount for the market interval at the agreed price and the agreed capacity option price based upon the first bid validated order and first ask validated order. Arrow 2354 directs execution from operation 2352 to operation 2356. Operation 2356 terminates the operations of this flowchart.

These operations may be supported by a program step residing in a coupled computer readable memory on at least one computer in a computing system supporting a virtual trading floor for ephemeral, fungible commodities.

FIG. 15C depicts a detail flowchart of operation 2120 of FIG. 10B performing creating the agreed contract at the agreed price and the agreed option price for the agreed amount whenever the first bid order agrees with the first ask order in terms of the price and the option price.

Arrow 2370 directs the flow of execution from starting operation 2120 to operation 2372. Operation 2372 performs creating the agreed contract for the market interval at the agreed price and the agreed option price for the agreed amount whenever the first bid validated order agrees with the first ask validated order in terms of the price and the option price. Arrow 2374 directs execution from operation 2372 to operation 2376. Operation 2376 terminates the operations of this flowchart.

These operations may be supported by a program step residing in a coupled computer readable memory on at least one computer in a computing system supporting a virtual trading floor for ephemeral, fungible commodities.

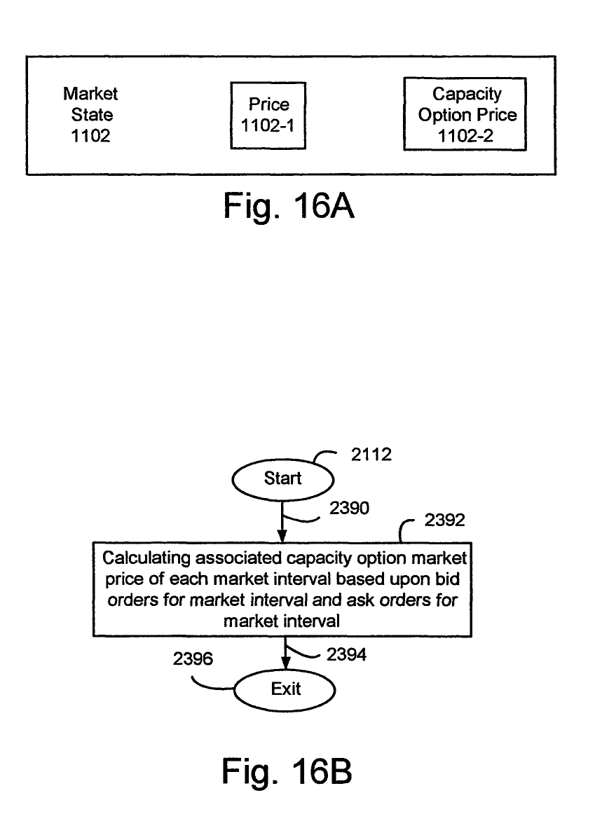

FIG. 16A depicts a market state 1102 associated with a market interval 1100 as show in FIGS. 3A and 14B in accordance with certain embodiments of the invention.

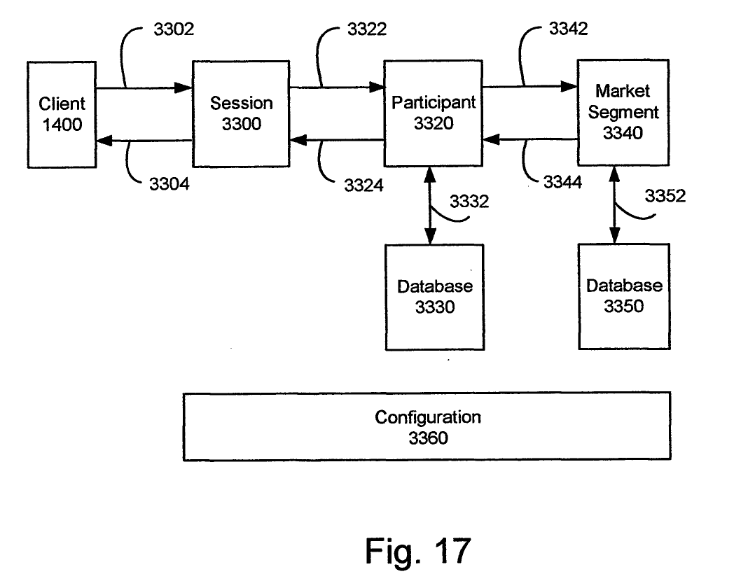

Market state 1102 may include a price 1102-1. Market state 1102 may be further associated with a market interval 1100 containing a capacity option type 1118 as shown in FIG. 17B. Market state 1102 may further contain a capacity option price 1102-2.

FIG. 16B depicts a detail flowchart of operation 2004 of FIG. 14A performing calculating the capacity option price 1102-2 for the market state 1102 as shown in FIG. 16A of a market interval as shown in FIG. 14B containing a capacity option 1118.

Arrow 2390 directs the flow of execution from starting operation 2004 to operation 2392. Operation 2392 performs calculating the associated capacity option market price of each market interval based upon the bid validated orders of the validated order collection for the market interval and the ask validated orders of the validated order collection for the market interval. Arrow 2394 directs execution from operation 2392 to operation 2396. Operation 2396 terminates the operations of this flowchart.

FIG. 17 depicts a method of controlling the interaction between a client 1400 and a virtual trading floor comprising maintaining a session component 3300, participant component 3320 and market segment 3340 in accordance with certain embodiments of the invention.

Maintaining the session component 3300 may comprise the following: Receiving an order request message 3302 from client 2190. Sending the received order request message 3322 to the participant component 3320 to create a forwarded order request message for the participant component. Receiving 3324 the acknowledgement message based upon the validated order request message and the relevant client list message for the validated order request message. Processing the received acknowledgement message and relevant client list for the validated order request message to create a broadcast update message for the validated order request message. Sending the broadcast update message 3304 to each of the clients 2190 of the relevant client list.

Maintaining the participant component 3320 may further comprise the following: Receiving the forwarded order request message 3302 from the session component. Maintaining 3332 a participant database 3330. Validating the received, forwarded order request message. And responding to the validated order request message whenever the received, forwarded order request message is validated.

Maintaining the participant database may further comprise the following. Adding the received, forwarded order request message 3332 to the participant database 3330. Validating the received, forwarded ordered request message requires examining 3324 and 3322 the session database based upon the received, forwarded order request message to create a validated order request message.

Responding to a validated message may comprise the participant component performing the following activities. Sending an acknowledgement message 3324 based upon the validated order request message to the session component 3300. Assembling a list of relevant clients for the validated order request message and sending 3324 the session component 3300 a relevant client list message for the validated order request message. Sending a market order request message 3342 to the market segment 3340 based upon the validated order request message.

Maintaining the market segment 3340 may comprise performing the following activities. Receiving the market order request message 3342. Maintaining 3352 a market segment database 3350 comprised of market intervals with associated market states as either active or closed. The market state of an active market interval comprises the total pending buy-position and the total pending sell-position.

A market segment may be considered the virtual trading floor for specific fungible, ephemeral commodities such as electricity commodities including, but not limited to, “energy”, “spinning reserve” and “transmission rights”. Additionally, a market segment is associated with a particular location, such as a delivery zone, hub or node in a grid, or a transmission path between two nodes in an AC electrical power network.

Maintaining the market segment database 3350 may comprise performing the following activities. Updating the market state of at least one market interval 3352 based upon the received market order request message 3342. Reconciling the total pending buy-position with the total pending sell-position of at least one market interval. Closing a market interval.

A virtual trading mechanism database may comprise a read-only database 3360 for market configuration and for participant configuration by the virtual trading mechanism. Settlement and schedule databases may not be directly accessed by the virtual trading mechanism.

As discussed earlier the messaging protocols associated with reliable distributed systems are known as the ABCAST and GBCAST protocols respectively. While these protocols provide some strong message delivery guarantees, namely atomicity and causality, they are insufficient for implementing message driven architectures. They do not provide sufficient level of abstraction at which objects can send messages to each other and reply to those messages.

Consider again a process group of three members: P1, P2 and P3. Suppose that P1 were to send a message A to everyone (P1, P2 and P3). Message A could be something like: ‘Now is TTT o'clock and it is time to run the auction for market XXX’. Supposed the process group wanted to send message B in response to message A. Message B could be something like: ‘The auction for market XXX was run and the new price is YYY’. Who will send the response message B? Since A is sent to all members of the group and all members behave identically, then any of them could in principle be sending B. In reality, however, it is undesirable for all three processes to send the same reply, so the most senior process is chosen to send the message B.

From the point of view of ABCAST and GBCAST, both messages A and B are treated identically, i.e. they will be broadcast to all members of the process group using the same protocol. From the point of view of a message driven architecture, messages A and B are essentially different. The difference lies in the cause for each message and that difference will effect the way the two messages are handled.

The above discussion points out that A and B must be treated differently, but ABCAST and GBCAST make no provisions for that. What is needed is a mechanism compliant with ABCAST and GBCAST, which further supports message replies within a reliable distributed system.

These provisions must be implemented on a higher level, but still as part of the functionality of the real-time operating system and not as part of the highest implementation levels, such as part of the business logic.

Certain embodiments of the invention are structured into several layers. The lowest layer is the Process View layer, which implements the ABCAST and GBCAST protocols. The next layer is the R-object View layer and that layer, amont other things, implements the functionality needed to support message replies (message B is an example of a message reply).

The R-object View layer includes at least two major innovations: reliable message replies and resilient objects.

The reliable message replies refers to the ability to reliably send replies like message B in the example above even in the event when the actual sender of B crashes. Roughly this capability works as follows:

1. Message A is received by all processes P1, P2 and P3. Since all of them are in virtual synchrony with each other, all of them are capable of acting on A in an identical manner and creating identical replies B.

2. Only one of these processes, however, physically sends B using the ABCAST protocol. The remaining processes only ‘pretend’ to send B, but in fact they store B into a temporary buffer.

3. When B is eventually delivered, to a process that only pretended to have sent B, then that process removes its copy of B from the temporary buffer.

4. If the process which was meant to send B, died shortly before B was sent, then the next available process (typically the next senior process) will re-send B from the copy that it had stored in its temporary buffer.

The above steps guarantee that a reply message B is always sent, regardless of individual process failures. This guarantee empowers a programmer who is writing an application for the APX Engine, to create a whole chain of replies, e.g. B replying to A, C replying to B, D replying to C. Such reply chain will have the guarantee that as long as it has been initiated (i.e. as long as A has been received) then all of the reply messages will eventually be received as well. This guarantee is much stronger than the guarantee which ABCAST or GBCAST provide.

Steps 1, 2, 3 and 4 may rely on the ability to generate unique IDs (also called Reply IDs) for the messages stored in the temporary buffers, such that those IDs are generated identically by all processes. The reason why this is necessary can be seen from step 3, where a process receives a message and must identify that message as identical to one that has been previously stored in a temporary buffer.

Resilient Objects is a concept which is used to combine the object oriented approach of programming with the message driven style of programming provided by the APX Engine. The prior art protocols discussed herein are only on the level of processes and process groups. However within each process there can be multiple objects that can exchange messages with each other.

APX Engine™ is a platform upon which any manner of application can be built. APX Engine™ is composed of (typically) 3 redundant processes forming an inter-networked process group.

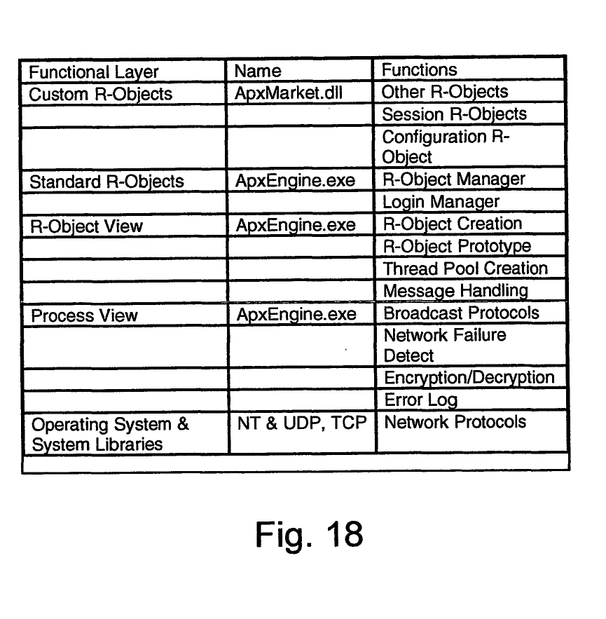

FIG. 18 depicts five functional levels implemented within each process group, in accordance with certain embodiments of the invention.

The focus of this discussion will be the upper 3 functional layers and in particular the description of innovative data processing structures called Resilient Objects or R-Objects. R-Objects are redundant entities that perform the same operations on the same data on each Process in the Process Group. R-Objects contribute programmability, configurability and reliability to the system built on the APX Engine™. APX Engine™ provides the lower level, general-purpose functionality of the system and R-Objects implement the higher level, business-specific functionality.

An R-Object exists as multiple, geographically-separated clones receiving and operating with identical messages and resulting in a robust data structure whose functionality is preserved even if disaster strikes one or all but one of the constituent clones. An R-Object clone, isolated from its fellow-clones, is as fragile a software construct as ever, but viewed collectively, it is a hardy, even resilient creature.

Custom R-Objects are the application designer's building blocks and may be as numerous and variegated as the particular business application calls for.

The challenge of designing a large, complex application is readily broken down into single tasks each of which becomes a single R-Object with only a few, well-defined inputs and outputs.

Use of the included R-Object prototype eases the R-Object developer's task by providing the basic structure and function of an R-Object. The developer need only add customization details to implement a particular task. Also, when programming a new type of R-Object message, the developer is unconcerned with how many and where the clones of this R-Object are or how to ensure the message's delivery—Process View takes care of all of these.

R-Objects are dynamic—coming into existence (creation) and going out of existence (destruction), growing and shrinking in response to a changing environment. There are 4 scenarios for the creation of R-Objects on a Process:

when the Process Group is started up for the very first time—in this case no initialization or state transfer is required as there is no previous state (history) to restore;

when the Process Group is re-started after having been shut down—in this case R-Objects on the first Process to come up must have their states restored from a history file (not the same as state transfer);

when a Process is started (or restarted) and joins a Process Group (state transfer is required for each of the R-Objects) and

when R-Objects come into being as a result of asynchronous events such as a Session R-Object created to accomodate a login user (state transfer is required for all but the initial Session R-Object clone).

There are 2 R-Objects that are non-application specific: R-Object Manager and Login Manager. These R-Objects provide functionality that any application will require and are not customizable by the R-Object designer. R-Object Manager's functionality is entirely hardcoded. R-Object Manager's state is the list of R-Objects that live (or will live) on that Process. R-Object Manager receives the list of R-Objects in a state transfer from an R-Object Manager on a Process already in the Process Group. Once instantiated, R-Object Manager participates in the creation of the Custom R-Objects and thereafter is responsible for maintaining the list of R-Objects on its Process.

Login Manager's functionality is created by R-Object View sending a message to R-Object Manager requesting it to create an R-Object of the Login Manager type. R-Object Manager then calls R-Object View's object creation method to create an object of the requested type. R-Object View's method calls the R-Object Factory which creates Login Manager's functionality. R-Object View then attaches a unique ID to the new R-Object, assigns it to one of the threads in the thread pool and sends a confirming message to R-Object Manager. Login Manager then receives its state from a Login Manager on a Process already in the Process Group.

In certain embodiments of the invention, application specific functionality is implemented in the Custom R-Objects. Two of the custom R-Objects have their name (class ID) specified (hardcoded) in APX Engine™: Configuration and Session. Although their names are not changeable all aspects of their functionality is customizable by the R-Object designer. Custom R-Objects' functionality is created by R-Object View sending a create-R-Object-request message to R-Object Manager for each R-Object in R-Object Manager's list of R-Objects. The same procedure as before executes: R-Object Manager calls R-Object View's object creation method to create an object of the requested type. R-Object View's method calls the R-Object Factory which creates the functionality of the requested class. R-Object View then attaches a unique ID to the new R-Object, assigns it to one of the threads in the thread pool and sends a confirming message to R-Object Manager. As each Custom R-Object is created, its state is transferred from its counterpart clone on a donor Process.

For example, in creating a Custom R-Object named, Market Segment, R-Object View sends the request to R-Object Manager who then calls R-Object View's object creation method to create the Market Segment type R-Object. R-Object View's method calls the R-Object Factory which creates the object. R-Object View then attaches a unique ID to the new R-Object, assigns it to one of the threads and sends R-Object Manager a message confirming that the Market Segment R-Object has been created.

As mentioned above, every R-Object gets its state from an already-existing R-Object of the same type. State transfer is accomplished through the collaboration of the donor and recipient R-Object Managers and the home thread of the donor R-Object. To the recipient R-Object, state transfer appears as a series of messages—each message carrying part of the state being transferred. State transfer must therefore be an atomic event (no intervening messages) with respect to other messages that may be sent to either the donor or recipient R-Object. This means that after initiation of state transfer, messages that would modify the state of either the recipient or donor R-object are buffered by the respective thread and are delivered only after the state transfer has completed. Prior to initiation of state transfer, all messages to the recipient R-Object are discarded, but are handled normally by the donor R-Object.

State transfer is accomplished in the following way:

The recipient R-Object Manager, having just created the R-Object initiates a state transfer to it by broadcasting a state transfer request message (identifying the R-Object in question) which both the donor R-Object thread and the recipient R-Object thread receive.

For the thread of both the donor and recipient R-Object, this message is a signal to hold all non-state transfer content messages received until the procedure is completed.

The donor R-Object thread then calls the donor R-Object's dump method which writes the donor R-Object's state to a byte stream.

The donor R-Object Manager divides the byte stream into separate state transfer content messages which are addressed to the recipient R-Object and are passed to Process View for network dispatch.

The recipient R-Object's home thread receives the state transfer content messages and reconstructs the original byte stream.

Each state transfer content message contains information about the total size of the byte stream and the offset of the data carried by that particular message. In this way messages received out of sequence (due to network latency) can be reordered correctly and the recipient thread knows when all of the state transfer content messages have been received.

When all of the state transfer content messages have been received, the recipient R-Object's thread calls that R-Object's read method to initialize (load) its state from the byte stream.

Once the donor R-Object thread has sent all of the state transfer content messages, it replays any messages which were received (suspended and buffered) while the state transfer was taking place. Likewise, the recipient R-Object's thread replays any messages that it received in the interim.

The new R-Object clone is now synchronized with its fellow clone(s) and has its initialization status property so marked in its R-Object Manager's R-Object list.

The destruction of an R-object follows a similar path to its creation. During normal operation, someone (i.e. another R-object) sends a destroy R-Object request message to the R-Object manager in order to destroy a certain R-object. For example, the Login Manager R-Object may send a request to destroy a certain Session R-object. An R-Object can also issue a request for its own destruction. In both cases, once the R-Object Manager receives the request, it removes the R-Object in question from its list of R-Objects and then tells R-Object View to remove the R-Object clone in question from the associated thread. The R-Object protype is designed in such a way that when all references to an R-Object (clone) have been removed, then the memory allocated for that R-Object (clone) is automatically released.

R-Objects may utilize each other's functionality by sending messages to each other. An R-Object clone is unaware of and does not care whether or how many other clones of its type exist in the Process Group. But it does care that other types of R-Objects exist somewhere in the Process Group (but again, doesn't care where) because it sends and receives messages to and from them in the course of carrying out its functionality. Process View ensures the clones of an R-Object stay in sync with each other by ensuring they all get the same messages and in the same order.

Virtual synchrony means the operational flow of an R-Object (or collectively, a Process) is controlled not by the progression of realtime but by the reception of messages. These messages are called Dependent messages and are the messages described so far in this document. Although a Dependent message is generated multiple times (once per Process), the Senior Process' Dependent message receives priority treatment. That is, the Senior Process' Dependent message replaces the Junior Process' Dependent message upon delivery to the Junior Process. Because Dependent messages form a continuous action-response chain, Dependent messages always have an antecedent. This action-response chain reaches all the way back to the first event (independent by definition) which occurred at the creation (bootup) of the Process Group.

R-Objects generate one other message type, Independent messages. Independent messages are not part of the action—response chain of messages (do not have an antecedent) and are therefore not synchronous. Independent Messages occur as a result of a timer event or a client session user input event. Timer event messages are similar to Sync messages in that although all Processes generate the message, only the Senior Process' message traverses the network and replaces the message on Junior Processes. Session R-Objects mediate user sessions. User input event messages that come out of these sessions are different in that they are only generated on the Process that the user is logged into and are thereafter sent to the other Processes, who, of course, do not have this message and so do not replace anything with it. Session R-Objects still retain their resiliency in that if the user connection is lost, the client portion of the R-Object will reestablish the connection and even if this connection is with a different Process (host) the appropriate (already existing) Session R-Object on this Process will be able to take up right where the old, disconnected Session R-Object left off.

R-Object View groups R-Object messages (which are generally very small) into larger data packets before passing them to Process View, thereby enhancing Process View's efficiency. Conversely, on the receive side, R-Object View separates incoming R-Object messages from the data packets that it receives from Process View.

R-Object Manager's principal responsibility is maintaining the list of R-Objects (the ID and the initialization status of each) on its Process. This is a number that comes from a 32-bit counter. After the counter is read and the value assigned as an R-Object's ID, the counter is incremented. Any clones of this newly-created R-Object receive the same ID and the counter on their Processes is set to the incremented value, thereby synchronizing them for future R-Object ID generation.

Each R-Object has an initialization status property which indicates whether or not it has received its state and whether it discards or handles incoming messages. Similarly, the collective initialization statuses of all of the R-Objects on a Process determines the readiness of that Process. A Process which has joined the Process Group but has not yet completed State Transfer for all of its R-Objects, results in a Process readiness value of “Not Ready”. This status is communicated by Process View to the other Processes in the Process Group. “Not Ready” allows the new Process to receive all messages that are broadcast within the Group, but is restricted from performing Process View-level activities such as Senior Process succession activities 1. Only R-Objects that are “Ready” are allowed to receive messages and perform computations or accept connections or messages from outside the Process Group (such as a client login). When all of a Process' R-Objects have completed State Transfer, the readiness of the new Process is set to “Ready”. Again, this status is communicated to the Process Group members. A Process becomes a full-fledged member of the Process Group after all of its R-Objects have been instantiated and have received their respective states. At that point the Process has all of the rights and responsibilities of a member of the Process Group.

R-Object View performs the following functions in addition to the R-Object creation function and R-Object message handling detailed above.

Custom R-Objects are not designed ‘from scratch’, but rather are built by the R-Object designer by modifying an object that is based on the R-Object prototype. The R-Object Prototype is included in R-Object and is like a base class, i.e. a description of the minimum attributes (properties) and functionality that every R-Object has.

R-Object Prototype attributes include:

R-Object Type.

R-Object ID.

R-Object Initialization Status.

R-Object Prototype functionality includes:

Receive a message.

Read its state from a byte stream.

Write its state to a byte stream

Run method. The Run method is periodically called by the thread to which the R-Object is assigned. In the implementation of its Run method the R-Object will perform whatever operation is required other than message handling (which is done in a different method). For example, the Login Manager R-Object (one of the Standard R-Objects) has its Run method called to check for incoming TCP connections.

Upon startup, R-Object View creates a pool of threads (a number specified in the bootscript) on the Process then, as each R-Object is created, R-Object View assigns it to one of these threads. Although multiple R-Objects run on a single thread, session R-Objects are not mixed with non-session R-Objects on the same thread. The reason for this is session R-Objects must be visited frequently by their home thread but only for a short time, whereas non-session R-Objects are visited less often and for a longer period of time. After meeting the requirement of not mixing session and non-session R-Objects on the same thread, the choice of where to place an R-Object is based on maintaining nearly equal distribution among the threads, thereby not overloading any one thread. R-Object View maintains a directory of what R-Objects live on what thread so that when a message is received, R-Object View knows which thread's queue to put it in based on the R-Object ID attached to the message.

Bilateral orders are used to create private contracts between two participants. In a bilateral transaction, one participant plays the role of initiator and the other plays the role of a responder, based on who initiates the bilateral transaction. The intiator can submit both buy and sell orders. Each order must indicate the responder participant. As soon as a bilateral order is submitted, the responder participant is notified. The responder then can either choose to confirm the entire order or reject it. When a bilateral order is confirmed, the APX Market Engine™ creates a counter order on behalf of the responder and marks both the initiator and responder orders as contracted.

In certain embodiments of the invention, although bilateral orders are not posted to any market segment, a bilateral transaction must take place with respect to a market segment, therefore each bilateral order must indicate an associated market segment. The reason for this requirement is that most of the parameters that define a market segment (such as product, location, time zone, currency etc.) are also required for processing a bilateral transaction. Furthermore, a bilateral transaction is represented and handled in virtually identical way to a regular market transaction.

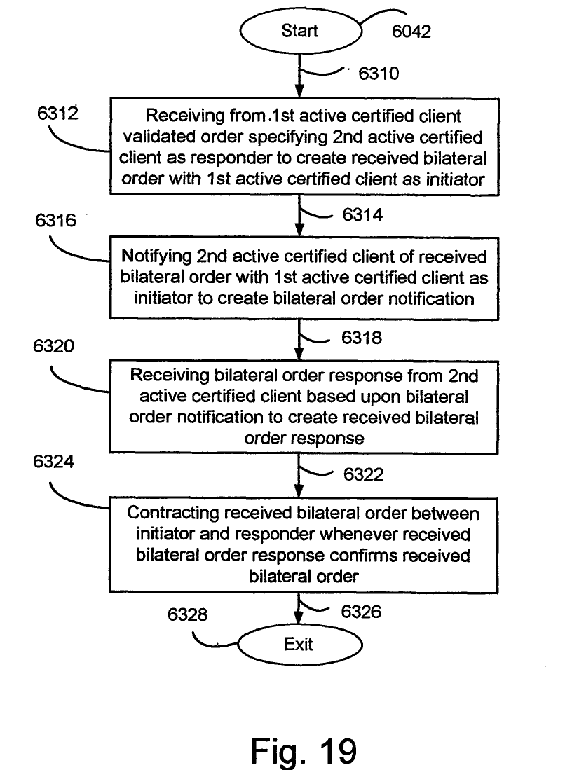

FIG. 19 depicts a detail flowchart of operation 6042 of FIG. 1B further supporting bilateral trading.

Arrow 6310 directs the flow of execution from starting operation 6042 to operation 6312. Operation 6312 performs receiving from the first active certified client a validated order specifying the second active certified client as the responder to create a received bilateral order with the first active certified client as initiator. Arrow 6314 directs execution from operation 6312 to operation 6316. Operation 6316 performs notifying the second active certified client of the received bilateral order with the first active certified client as the initiator to create a bilateral order notification. Arrow 6318 directs execution from operation 6316 to operation 6320. Operation 6320 performs receiving a bilateral order response from the second active certified client based upon the bilateral order notification to create a received bilateral order response. Arrow 6322 directs execution from operation 6320 to operation 6324. Operation 6324 performs contracting the received bilateral order between the initiator and the responder whenever the received bilateral order response confirms the received bilateral order. Arrow 6326 directs execution from operation 6324 to operation 6328. Operation 6328 terminates the operations of this flowchart.

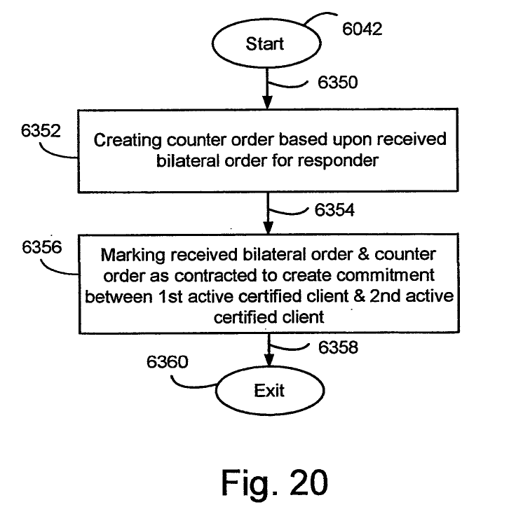

FIG. 20 depicts a detail flowchart of operation 6042 of FIG. 1B further contracting the received bilateral order.

Arrow 6350 directs the flow of execution from starting operation 6042 to operation 6352. Operation 6352 performs creating a counter order based upon the received bilateral order for the responder. Arrow 6354 directs execution from operation 6352 to operation 6356. Operation 6356 performs marking the received bilateral order and the counter order as contracted to create a commitment between the first active certified client and the second active certified client. Arrow 6358 directs execution from operation 6356 to operation 6360. Operation 6360 terminates the operations of this flowchart.

The APX Market Engine™ provides for ways to interface with external markets such as the Cal PX, CAL ISO, etc. markets. An external market behaves very similarly to a native APX market segment. The essential difference is that the market prices within an external market are determined outside the APX Market Engine™.

Therefore, the APX Market Engine™ implements an external market as simply a different market seg-ment, whose price adjustment parameters are set such that price is not updated automatically. Periodically, through an operations session (see “Sessions” on page 11), order submission and withdrawal for this market segment will be blocked and the pending orders in the market will be formatted in an appropriate form and submitted to the external market maker.

This design assumes that the response from the external market is in the form of contracted quantity and price calendar functions. The response quantity function is entered as at-market orders into the respective APX market segment, and the response price function is entered through an operations session. Market clearing is turned on and trading is unblocked again using an operations session.

The external market implementation provides for retroactive adjustment of the contract price for previously contracted at-market orders, which do not have a specified price of contract yet. The reason for this is that the APX implementation of an external market allows for at-market orders to contract before market price information is available. Once the market price information is available from the external market, the price of the contracted orders is adjusted so that it matches the price of the external market.

Depending on the external market maker, the process described above may take place with varied frequency. For example, in the case of the Cal PX hour-ahead market, this process needs to take place not more than once or twice a day. If however, the external market maker were using continuous real time market clearing, this process may be as frequent as every few minutes. Naturally, in the latter case the process must be fully automated.

The interaction between the APX Market Engine™ and an actual external market can be characterized by the following states. Each state is attributed to a region of the calendar line.

Accept Orders. In this state the APX Market Engine™ accepts client orders but does not reconcile them.

Accept and Reconcile At Market. In this state the APX Market Engine™ accepts client orders and reconciles at-market orders.

Block Orders. In this state the APX Market Engine™ does not accept new orders and does not allow the client to withdraw orders. The APX Market Engine™ transitions into this state shortly prior to sending order information to the external market. It remains in this state until the external market has replied with a price and quantity.

Block and Retrofit. In this state, the APX Market Engine™ retroactively adjusts the contracted price for at-market orders that have previously contracted at unknown price. New client orders are still blocked and the client is not allowed to submit orders. The APX Market Engine™ transitions into this state after receiving price information from the external market.

Block and Reconcile. In this state the APX Market Engine™ reconciles all orders in the market. This happens after it has received price Information from the external market.

Reconcile All. This state is only allowed (and is the only allowed state) for markets segments, which use automatic reconciliation. This state is only defined for completeness. External markets will not transit to this state.

The above states may be recorded into the market engine database, in order to ensure that the market engine can recover properly from a total failure.

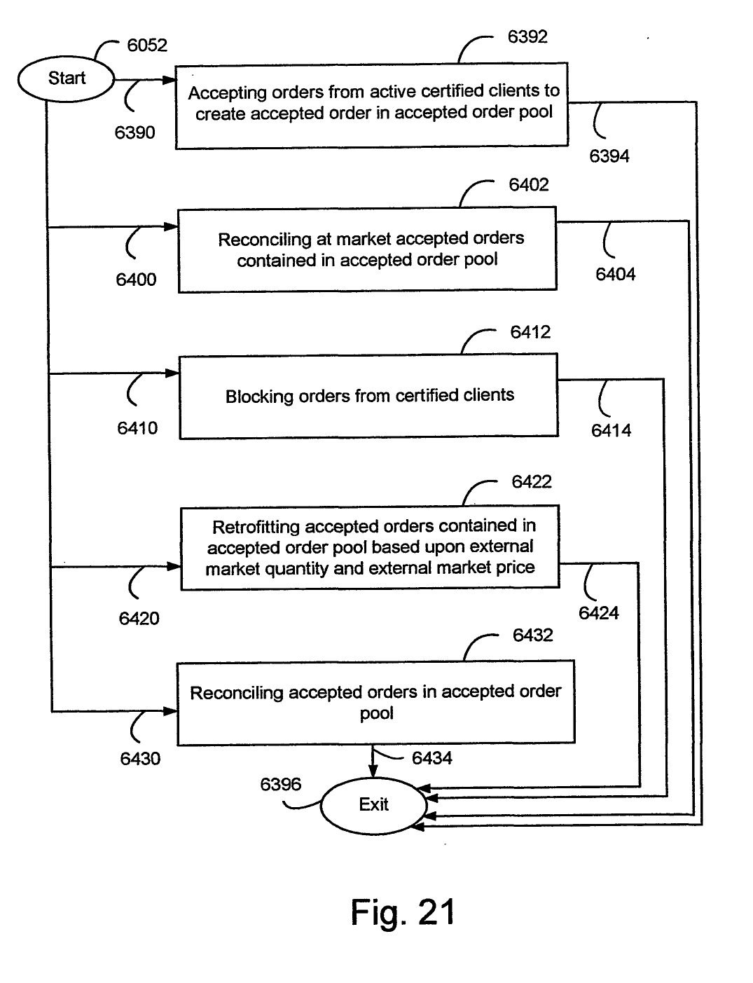

FIG. 21 depicts a detail flowchart of operation 6052 of FIG. 1B further supporting external market trading.

Arrow 6390 directs the flow of execution from starting operation 6052 to operation 6392. Operation 6392 performs accepting orders from the active certified clients to create an accepted order in an accepted order pool. Arrow 6394 directs execution from operation 6392 to operation 6396. Operation 6396 terminates the operations of this flowchart.

Arrow 6400 directs the flow of execution from starting operation 6052 to operation 6402. Operation 6402 performs reconciling at market the accepted orders contained in the accepted order pool. Arrow 6404 directs execution from operation 6402 to operation 6396. Operation 6396 terminates the operations of this flowchart.

Arrow 6410 directs the flow of execution from starting operation 6052 to operation 6412. Operation 6412 performs blocking the orders from the certified clients. Arrow 6414 directs execution from operation 6412 to operation 6396. Operation 6396 terminates the operations of this flowchart.

Arrow 6420 directs the flow of execution from starting operation 6052 to operation 6422. Operation 6422 performs retrofitting the accepted orders contained in the accepted order pool based upon an external market quantity and based upon an external market price. Arrow 6424 directs execution from operation 6422 to operation 6396. Operation 6396 terminates the operations of this flowchart.

Arrow 6430 directs the flow of execution from starting operation 6052 to operation 6432. Operation 6432 performs reconciling the accepted orders in the accepted order pool. Arrow 6434 directs execution from operation 6432 to operation 6396. Operation 6396 terminates the operations of this flowchart.

Note that certain embodiments of the invention may use a mechanism such as described in FIG. 21, wherein the state of the system may concurrently include more than one of the operations of the flowchart, such as blocking 6412 and retrofitting 6422, by way of example. The handling of external market trading in fungible, ephemeral commodities may include more than the states discussed herein. These schemes for handling external market trading are provided by way of example and are not intended to limit the scope of the claims.

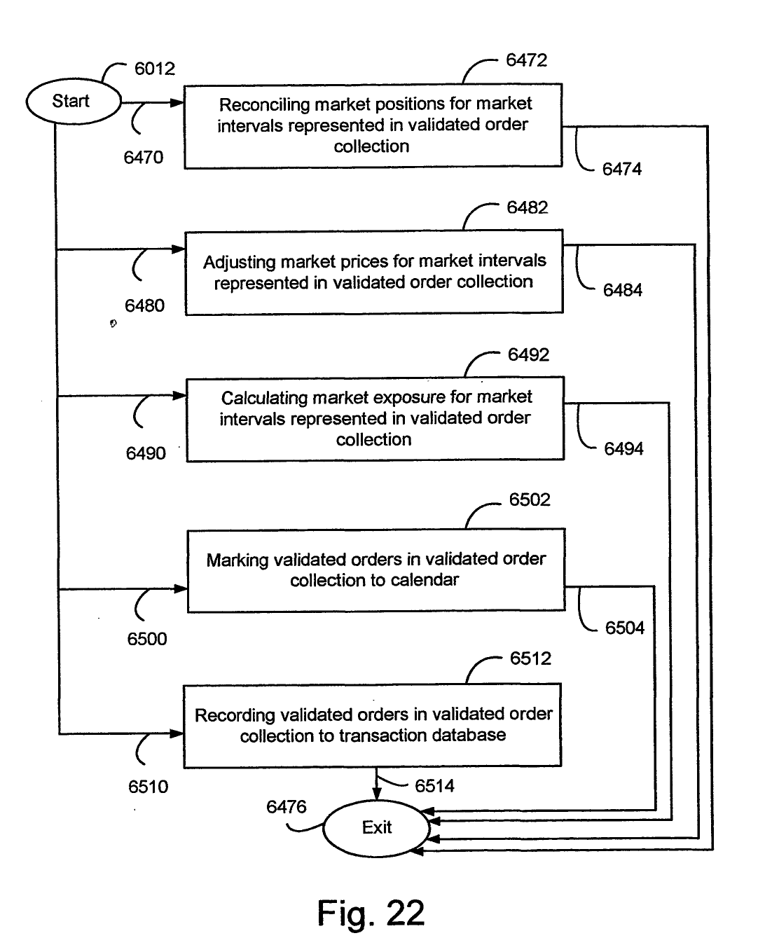

FIG. 22 depicts a detail flowchart of operation 6012 of FIG. 1A further operating the market engine.

Arrow 6470 directs the flow of execution from starting operation 6012 to operation 6472. Operation 6472 performs reconciling market positions for market intervals represented in the validated order collection. Arrow 6474 directs execution from operation 6472 to operation 6476. Operation 6476 terminates the operations of this flowchart.

Arrow 6480 directs the flow of execution from starting operation 6012 to operation 6482. Operation 6482 performs adjusting market prices for market intervals represented in the validated order collection. Arrow 6484 directs execution from operation 6482 to operation 6476. Operation 6476 terminates the operations of this flowchart.

Arrow 6490 directs the flow of execution from starting operation 6012 to operation 6492. Operation 6492 performs calculating market exposure for market intervals represented in the validated order collection. Arrow 6494 directs execution from operation 6492 to operation 6476. Operation 6476 terminates the operations of this flowchart.

Arrow 6500 directs the flow of execution from starting operation 6012 to operation 6502. Operation 6502 performs marking the validated orders in the validated order collection onto a calendar. Arrow 6504 directs execution from operation 6502 to operation 6476. Operation 6476 terminates the operations of this flowchart.

Arrow 6510 directs the flow of execution from starting operation 6012 to operation 6512. Operation 6512 performs recording the validated orders in the validated order collection to a transaction database. Arrow 6514 directs execution from operation 6512 to operation 6476. Operation 6476 terminates the operations of this flowchart.

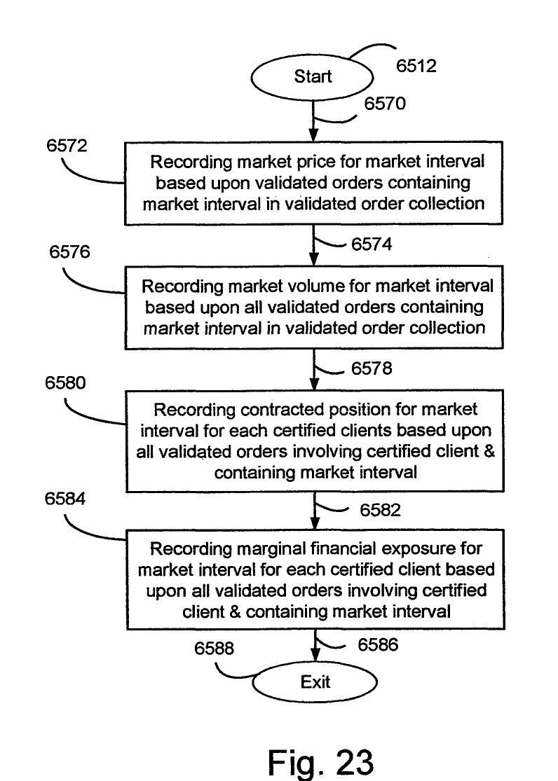

FIG. 23 depicts a detail flowchart of operation 6512 of FIG. 22 further recording the validated orders.

Arrow 6570 directs the flow of execution from starting operation 6512 to operation 6572. Operation 6572 performs recording the market price for a market interval based upon all validated orders containing the market interval in the validated order collection. Arrow 6574 directs execution from operation 6572 to operation 6576. Operation 6576 performs recording a market volume for the market interval based upon all validated orders containing the market interval in the validated order collection. Arrow 6578 directs execution from operation 6576 to operation 6580. Operation 6580 performs recording a contracted position for the market interval for each of the certified clients in the certified client collection based upon all validated orders involving the certified client and containing the market interval in the validated order collection. Arrow 6582 directs execution from operation 6580 to operation 6584. Operation 6584 performs recording a marginal financial exposure for a market interval for each of the certified clients in the certified client collection based upon all validated orders involving the certified client and containing the market interval in the validated order collection. Arrow 6586 directs execution from operation 6584 to operation 6588. Operation 6588 terminates the operations of this flowchart.

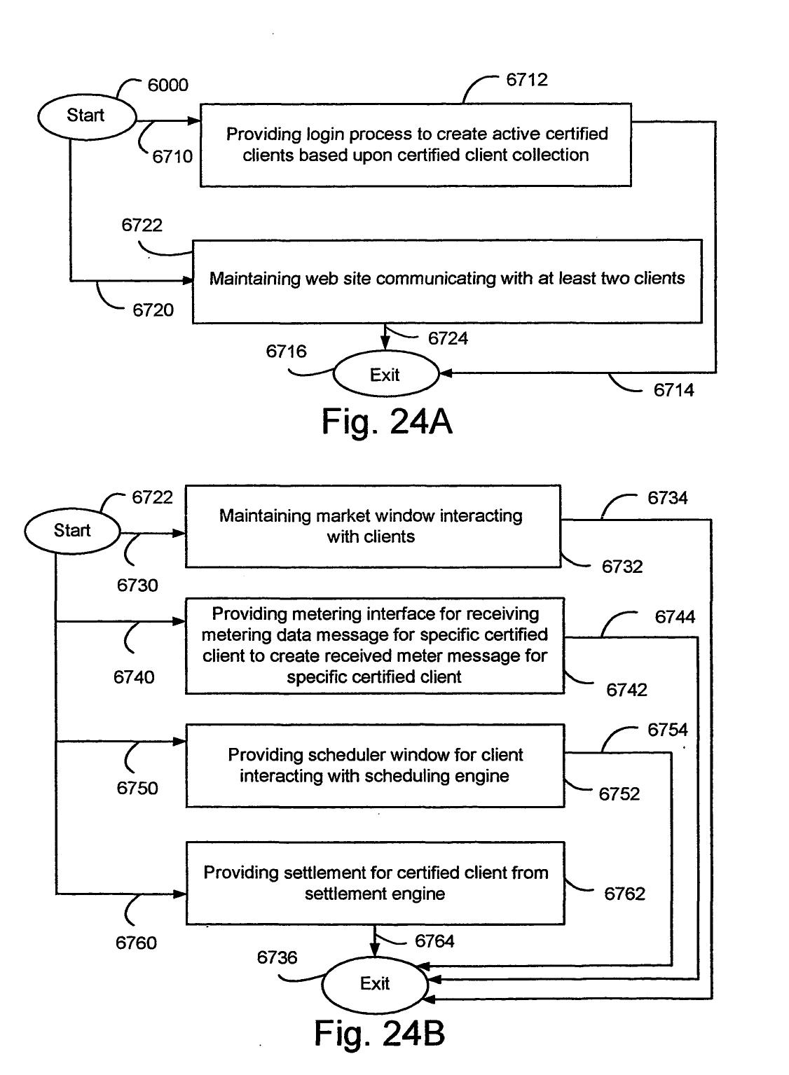

FIG. 24A depicts a detail flowchart of operation 6000 of FIG. 1A further performing the method of interacting with at least two active certified clients both belonging to a certified client collection and supporting transactions involving at least one fungible, ephemeral commodity.

Arrow 6710 directs the flow of execution from starting operation 6000 to operation 6712. Operation 6712 performs providing a login process to create the active certified clients based upon the certified client collection. Arrow 6714 directs execution from operation 6712 to operation 6716. Operation 6716 terminates the operations of this flowchart.

Arrow 6720 directs the flow of execution from starting operation 6000 to operation 6722. Operation 6722 performs maintaining a web site communicating with at least two clients. Arrow 6724 directs execution from operation 6722 to operation 6716. Operation 6716 terminates the operations of this flowchart.

FIG. 24B depicts a detail flowchart of operation 6722 of FIG. 24A further maintaining a web site communicating with at least two clients.

Arrow 6730 directs the flow of execution from starting operation 6722 to operation 6732. Operation 6732 performs maintaining a market window interacting with the clients. Arrow 6734 directs execution from operation 6732 to operation 6736. Operation 6736 terminates the operations of this flowchart.

Arrow 6740 directs the flow of execution from starting operation 6722 to operation 6742. Operation 6742 performs providing a metering interface for receiving a metering data message for a specific certified client to create the received meter message for the specific certified client. Arrow 6744 directs execution from operation 6742 to operation 6736. Operation 6736 terminates the operations of this flowchart.

Arrow 6750 directs the flow of execution from starting operation 6722 to operation 6752. Operation 6752 performs providing a scheduler window for the client interacting with the scheduling engine. Arrow 6754 directs execution from operation 6752 to operation 6736. Operation 6736 terminates the operations of this flowchart.

Arrow 6760 directs the flow of execution from starting operation 6722 to operation 6762. Operation 6762 performs providing the settlement for the certified client from the settlement engine. Arrow 6764 directs execution from operation 6762 to operation 6736. Operation 6736 terminates the operations of this flowchart.

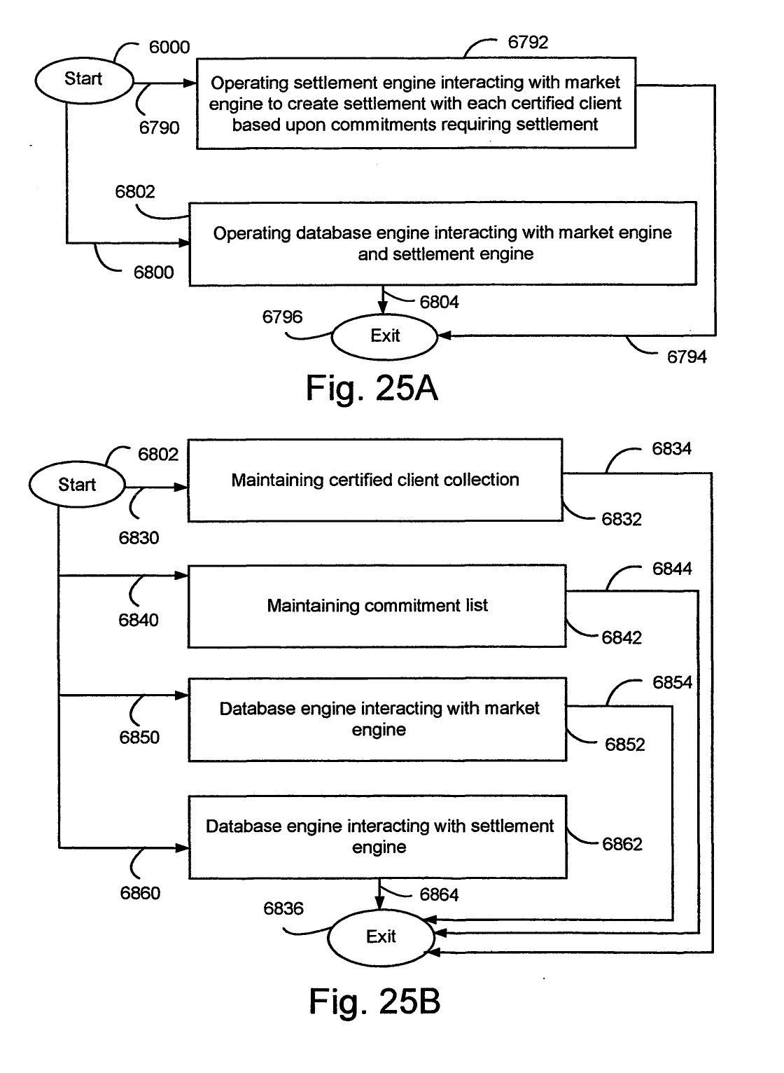

FIG. 25A depicts a detail flowchart of operation 6000 of FIG. 1A further performing the method of interacting with at least two active certified clients and supporting transactions involving at least one fungible, ephemeral commodity.

Arrow 6790 directs the flow of execution from starting operation 6000 to operation 6792. Operation 6792 performs operating a settlement engine interacting with the market engine to create a settlement with each of the certified clients based upon commitments in the commitment list requiring settlement by the certified client. Arrow 6794 directs execution from operation 6792 to operation 6796. Operation 6796 terminates the operations of this flowchart.

Arrow 6800 directs the flow of execution from starting operation 6000 to operation 6802. Operation 6802 performs operating a database engine interacting with the market engine and with the settlement engine. Arrow 6804 directs execution from operation 6802 to operation 6796. Operation 6796 terminates the operations of this flowchart.

FIG. 25B depicts a detail flowchart of operation 6802 of FIG. 25A further operating the database engine.

Arrow 6830 directs the flow of execution from starting operation 6802 to operation 6832. Operation 6832 performs maintaining the certified client collection. Arrow 6834 directs execution from operation 6832 to operation 6836. Operation 6836 terminates the operations of this flowchart.

Arrow 6840 directs the flow of execution from starting operation 6802 to operation 6842. Operation 6842 performs maintaining the commitment list. Arrow 6844 directs execution from operation 6842 to operation 6836. Operation 6836 terminates the operations of this flowchart.

Arrow 6850 directs the flow of execution from starting operation 6802 to operation 6852. Operation 6852 performs the database engine interacting with the market engine. Arrow 6854 directs execution from operation 6852 to operation 6836. Operation 6836 terminates the operations of this flowchart.

Arrow 6860 directs the flow of execution from starting operation 6802 to operation 6862. Operation 6862 performs the database engine interacting with the settlement engine. Arrow 6864 directs execution from operation 6862 to operation 6836. Operation 6836 terminates the operations of this flowchart.

Note that certain alternative embodiments of the invention may include a database engine concurrently interacting with one or more of the market engine, scheduling engine and settlement engine.

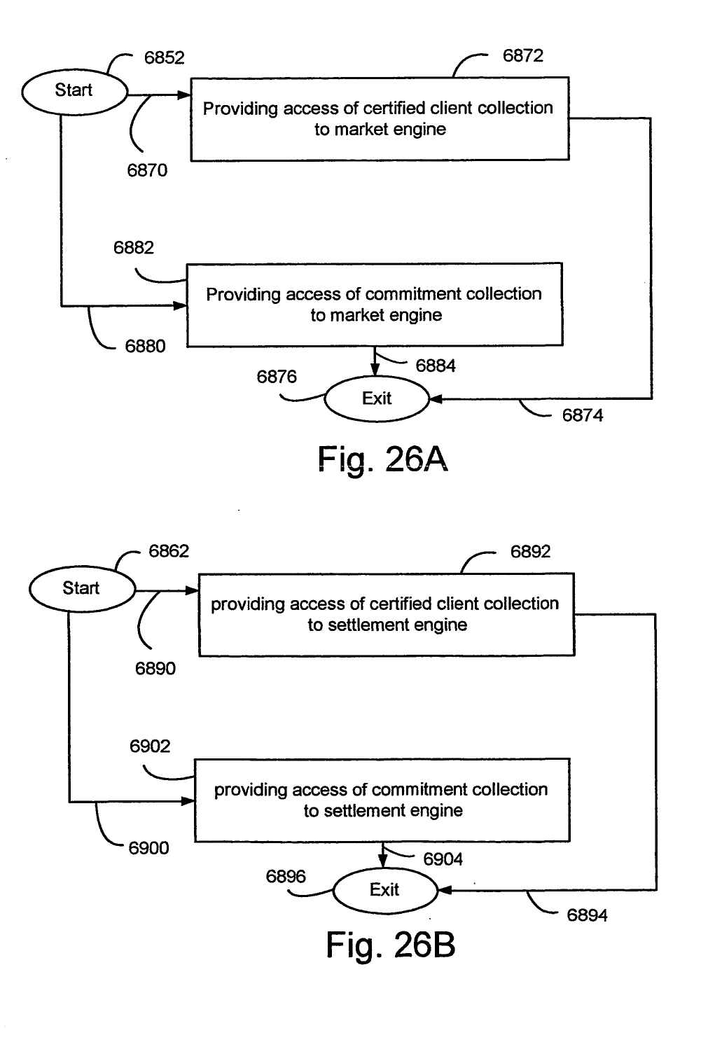

FIG. 26A depicts a detail flowchart of operation 6852 of FIG. 25B of the database engine further interacting with the market engine.

Arrow 6870 directs the flow of execution from starting operation 6852 to operation 6872. Operation 6872 performs providing access of the certified client collection to the market engine. Arrow 6874 directs execution from operation 6872 to operation 6876. Operation 6876 terminates the operations of this flowchart.

Arrow 6880 directs the flow of execution from starting operation 6852 to operation 6882. Operation 6882 performs providing access of the commitment collection to the market engine. Arrow 6884 directs execution from operation 6882 to operation 6876. Operation 6876 terminates the operations of this flowchart.

FIG. 26B depicts a detail flowchart of operation 6862 of FIG. 25B the database engine further interacting with the settlement engine.

Arrow 6890 directs the flow of execution from starting operation 6862 to operation 6892. Operation 6892 performs providing access of the certified client collection to the settlement engine. Arrow 6894 directs execution from operation 6892 to operation 6896. Operation 6896 terminates the operations of this flowchart.

Arrow 6900 directs the flow of execution from starting operation 6862 to operation 6902. Operation 6902 performs providing access of the commitment collection to the settlement engine. Arrow 6904 directs execution from operation 6902 to operation 6896. Operation 6896 terminates the operations of this flowchart.

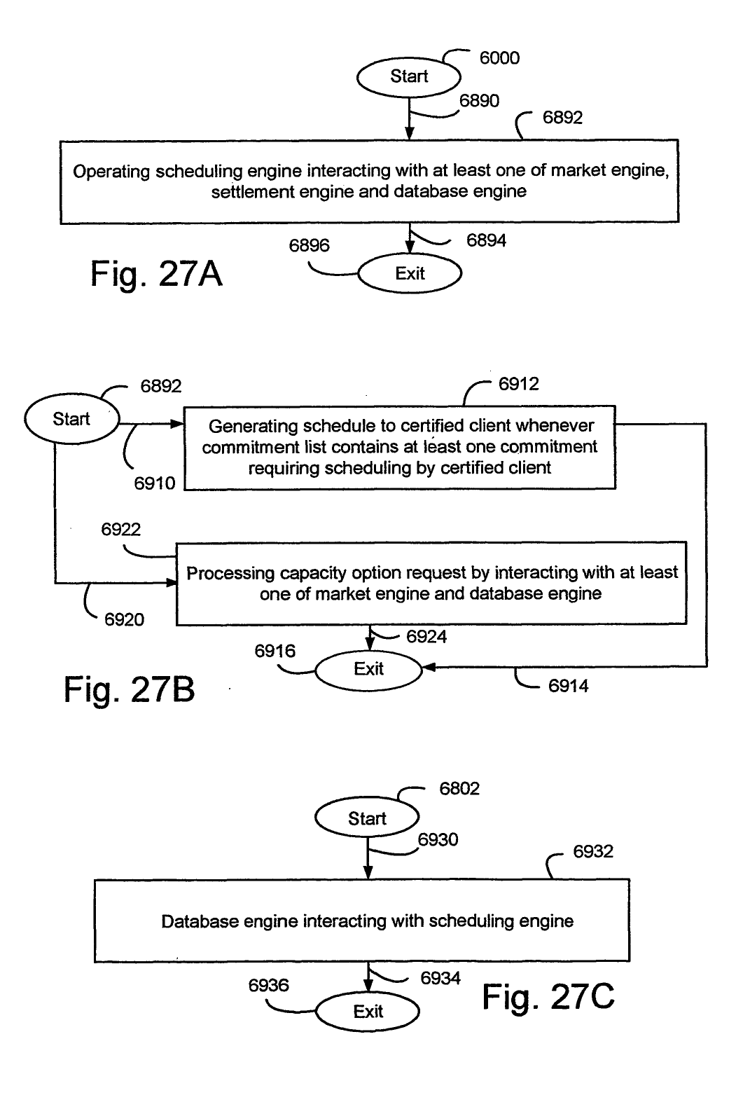

FIG. 27A depicts a detail flowchart of operation 6000 of FIG. 1A further performing the method of interacting with at least two active certified clients and supporting transactions involving at least one fungible, ephemeral commodity.

Arrow 6910 directs the flow of execution from starting operation 6000 to operation 6912. Operation 6912 performs operating a scheduling engine interacting with at least one member of the collection comprised of the market engine, the settlement engine and the database engine. Arrow 6914 directs execution from operation 6912 to operation 6916. Operation 6916 terminates the operations of this flowchart.

FIG. 27B depicts a detail flowchart of operation 6912 of FIG. 27A further operating the scheduling engine.

Arrow 6920 directs the flow of execution from starting operation 6902 to operation 6922. Operation 6922 performs generating the schedule to the certified client whenever the commitment list contains at least one commitment requiring scheduling by the certified client, for each of the certified clients belonging to the certified client collection. Arrow 6924 directs execution from operation 6922 to operation 6926. Operation 6926 terminates the operations of this flowchart.

Arrow 6930 directs the flow of execution from starting operation 6902 to operation 6932. Operation 6932 performs processing a capacity option request by interacting with at least one of the collection comprising said market engine and said database engine. Arrow 6934 directs execution from operation 6932 to operation 6926. Operation 6926 terminates the operations of this flowchart.

Certain embodiments of the invention include just the operation 6922.

Certain embodiments of the invention include at least one certified client with network operation authorization. Such certified clients may request of the scheduling engine that the market engine be examined for available capacity option bids for one or more market intervals. Operation 6932 depicts the scheduling engine processing such capacity option requests.

FIG. 27C depicts a detail flowchart of operation 6802 of FIG. 25A further operating the database engine.

Arrow 6940 directs the flow of execution from starting operation 6802 to operation 6942. Operation 6942 performs the database engine interacting with the scheduling engine. Arrow 6944 directs execution from operation 6942 to operation 6946. Operation 6946 terminates the operations of this flowchart.

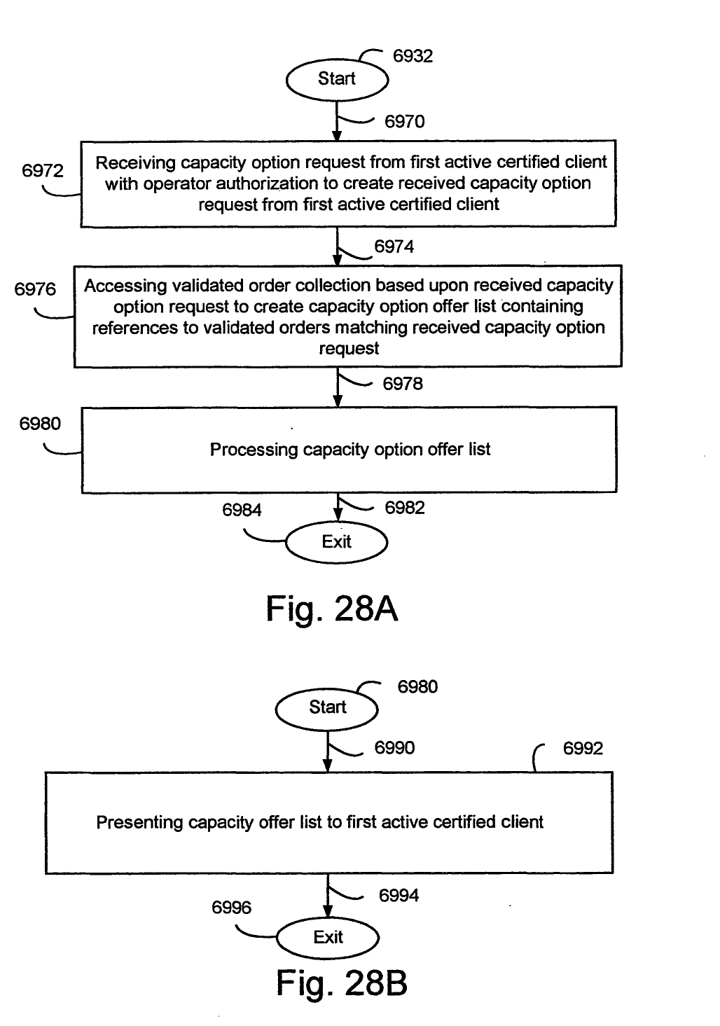

FIG. 28A depicts a detail flowchart of operation 6932 of FIG. 27B further processing the capacity option request.

Arrow 6970 directs the flow of execution from starting operation 6932 to operation 6972. Operation 6972 performs receiving the capacity option request from the first active certified client with operator authorization to create a received capacity option request from the first active certified client. Arrow 6974 directs execution from operation 6972 to operation 6976. Operation 6976 performs accessing the validated order collection based upon the received capacity option request to create a capacity option offer list containing a reference to each of the validated orders contained in the validated order collection matching the received capacity option request. Arrow 6978 directs execution from operation 6976 to operation 6980. Operation 6980 performs processing the capacity option offer list. Arrow 6982 directs execution from operation 6980 to operation 6984. Operation 6984 terminates the operations of this flowchart.

FIG. 28B depicts a detail flowchart of operation 6980 of FIG. 28A further processing the capacity offer list.

Arrow 6990 directs the flow of execution from starting operation 6980 to operation 6992. Operation 6992 performs presenting the capacity offer list to the first active certified client. Arrow 6994 directs execution from operation 6992 to operation 6996. Operation 6996 terminates the operations of this flowchart.

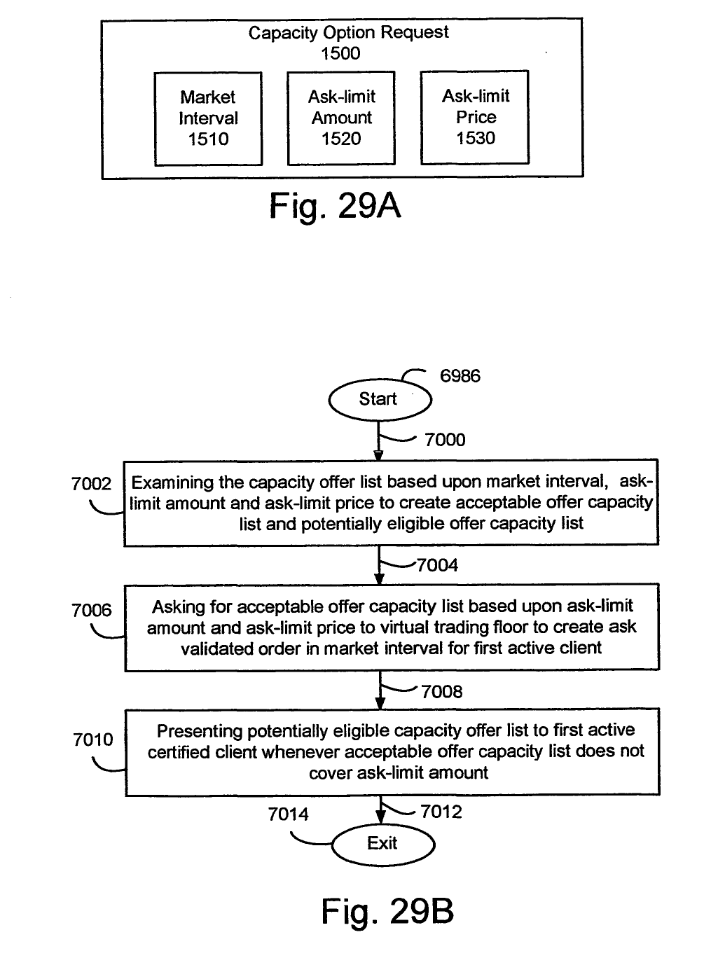

FIG. 29A depicts a capacity option request 1500 including at least one market interval 1510 and optionally including an ask-limit amount 1520 and optionally including an ask-limit price 1530.

Note that the capacity option request 1500 matching a validated order contained in the validated order collection would indicate that the validated order was a capacity option order for the same market interval 1510. Matching may further indicate that either the market interval of the validated order contains the market interval 1510, or alternatively market interval 1510 contains the market interval of the validated order.

FIG. 29B depicts a detail flowchart of operation 6980 of FIG. 28A further processing the capacity offer list.

Arrow 7000 directs the flow of execution from starting operation 6980 to operation 7002. Operation 7002 performs examining the capacity offer list based upon the market interval, the ask-limit amount, and the ask-limit price to create an acceptable offer capacity list and a potentially eligible offer capacity list. Arrow 7004 directs execution from operation 7002 to operation 7006. Operation 7006 performs asking for the acceptable offer capacity list based upon the ask-limit amount and based upon the ask-limit price to the virtual trading floor to create an ask validated order in the market interval for the first active client. Arrow 7008 directs execution from operation 7006 to operation 7010. Operation 7010 performs presenting the potentially eligible capacity offer list to the first active certified client whenever the acceptable offer capacity list does not cover the ask-limit amount. Arrow 7012 directs execution from operation 7010 to operation 7014. Operation 7014 terminates the operations of this flowchart.

The potentially eligible offer capacity list is only relevant whenever the acceptable offer capacity list does not cover the ask-limit amount within the ask-limit price for the market interval. In such circumstances, the potentially eligible offer capacity list is presented to the first active certified client.

Note that a scheduling engine may act as an agent responding to real-time operational shortfalls for a network operator or facility operator. The agent sees shortfalls in terms of the ask-limit amount and ask-limit price. The agent examines the capacity offer list to create the acceptable capacity offer list and potentially eligible capacity offer list. The agent then asks the virtual trading floor for the acceptable capacity offer list. The agent presents the potentially eligible offer capacity list whenever the acceptable offer capacity list does not cover the shortfalls.

The preceding embodiments of the invention have been provided by way of example and are not meant to constrain the scope of the following claims.

1. A system interacting with at least a first active certified client and a second certified client both belonging to a certified client collection supporting transactions involving at least one fungible, ephemeral commodity, comprising:
a computing system interacting with at least the first active certified client and the second certified client and controlled by at least a program system comprised of program steps contained in memory accessibly coupled to at least one computer included in the computing system, and
said program system comprising the program steps of:
operating a market engine presenting at least one commitment to a commitment list;
operating a scheduling engine providing at least one schedule based upon accessing said commitment list for at least one of said certified clients belonging to said certified client collection; and
operating a settlement engine providing a settlement based upon accessing said commitment list and based upon a performance database for each of said certified clients belonging to said certified client collection;
wherein the program step operating said market engine further comprising the program steps of:
supporting a virtual trading floor interacting with said active certified clients to create said commitment;
supporting bilateral trading involving said active certified clients to create said commitment;
supporting external market trading involving said active certified clients to create said commitment; and
maintaining said commitment list;
wherein the program step operating said scheduling engine is further comprised of, for each of said certified clients belonging to said certified client collection, the program steps of:
sending a scheduling commitment access request for said certified client regarding said commitment list;
receiving a scheduling commitment report in response to said scheduling commitment access request based upon said commitment list to create the received scheduling commitment report for said certified client; and
generating said schedule for said certified client based upon the received scheduling commitment report for said certified client whenever the received scheduling commitment access report references commitments requiring scheduling;
wherein the program step operating said settlement engine is further comprised of the program steps of:
processing a settlement for said certified client, for each of said certified clients belonging to said certified client collection; and
maintaining a performance database;
wherein the program step processing said settlement for said certified client is further comprised, for each of said certified clients belonging to said certified client collection, of the program steps of:
sending a settlement commitment access request regarding said commitment list for said certified client;
receiving a settlement commitment report in response to said settlement commitment access request to create said received settlement commitment report for said certified client;
presenting a performance access request regarding said performance database for said certified client;
receiving a performance report in response to said performance access request to create said received performance report for said certified client; and
generating said settlement for said certified client based upon the received performance report for said certified client and based upon said received settlement commitment report for said certified client;
wherein the program step maintaining said commitment list is further comprised of the program steps of:
receiving the sent commitment to create a received commitment added into said commitment list;
receiving a commitment access request for at least one of said certified clients belonging to said certified client collection from a requesting engine to create a received commitment request; wherein said requesting engine belongs to the collection comprising said market engine, said scheduling engine and said settlement engine; wherein said commitment access request belongs to an access request collection comprising a settlement commitment access request and a scheduling commitment access request; and
sending a commitment report of said commitments belonging to said commitment list in response to said commitment request to the requesting engine;
wherein the program step maintaining said performance database is further comprised of the program steps of:
receiving a metering data message for a specific certified client to create a received meter data for said specific certified client added into a performance database;
receiving a commitment performance access request for at least one of said certified clients belonging to said certified client collection from said requesting engine to create a received commitment performance request; and
sending a commitment performance report based in response to the received commitment performance request.

2. The system of claim 1,
wherein the program step of supporting bilateral trading is further comprised of the program steps of
receiving from said first active certified client a validated order specifying said second active certified client as said responder to create a received bilateral order with said first active certified client as initiator;
notifying said second active certified client of said received bilateral order with said first active certified client as said initiator to create a bilateral order notification;
receiving a bilateral order response from said second active certified client based upon said bilateral order notification to create a received bilateral order response; and
contracting said received bilateral order between said initiator and said responder whenever said received bilateral order response confirms said received bilateral order.

3. The system of claim 2,
wherein the program step of contracting the received bilateral order is further comprised of the program steps of:
creating a counter order based upon said received bilateral order for said responder; and
marking said received bilateral order and said counter order as contracted to create a commitment between said first active certified client and said second active certified client.

4. The system of claim 1,
wherein the program step of supporting external market trading is comprised of the program steps of:
accepting orders from said active certified clients to create an accepted order in an accepted order pool;
reconciling at market said accepted orders contained in said accepted order pool;
blocking said orders from said certified clients;
retrofitting said accepted orders contained in said accepted order pool based upon an external market quantity and based upon an external market price; and
reconciling said accepted orders in said accepted order pool.

5. The system of claim 1,
wherein the program step of operating said market engine is further comprised of the program steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar; and
recording said validated orders in said validated order collection to a transaction database.

6. The system of claim 5,
wherein the program step of recording the validated orders is further comprised of the program steps of:
recording said market price for a market interval based upon all validated orders containing said market interval in said validated order collection;
recording a market volume for said market interval based upon all validated orders containing said market interval in said validated order collection;
recording a contracted position for said market interval for each of said certified clients in said certified client collection based upon all validated orders involving said certified client and containing said market interval in said validated order collection; and
recording a marginal financial exposure for a market interval for each of said certified clients in said certified client collection based upon all validated orders involving said certified client and containing said market interval in said validated order collection.

7. The system of claim 1,
wherein said program system further comprises the program step of:
is providing a login process to create said active certified clients based upon said certified client collection.

8. The system of claim 1,
wherein said program system further comprises the program step of:
maintaining a web site communicating with at least two clients and further comprising at least one of the collection comprising the program steps of:
maintaining a market window interacting with said clients;
providing a metering interface for receiving a metering data message for a specific certified client to create said received meter message for said specific certified client;
providing a scheduler window for said client interacting with said scheduling engine; and
providing said settlement for said certified client from said settlement engine.

9. The system of claim 1,
wherein said computing system is further comprised of
a first computer group including at least one first computer with accessibly coupled memory, and
a second computer group including at least one second computer with accessibly coupled memory;
wherein said accessibly coupled memory of said first computer contains program steps operating said market engine;
wherein said accessibly coupled memory of said second computer is contains at least one program step of the collection of program steps comprising:
operating said scheduling engine; and
operating said settlement engine;
wherein said accessibly coupled memory of said second computer does not contain the program step operating said market engine;
wherein said accessibly coupled memory of said first computer does not contain the program steps:
operating said scheduling engine; and
operating said settlement engine;

10. The system of claim 1,
wherein the program step operating said scheduling engine is further comprised of the program step of
processing a capacity option request by interacting with at least one of the collection comprising said market engine and said database engine.

11. The system of claim 10,
wherein the program step processing said capacity option request is further comprised of the program steps of
receiving said capacity option request from said first active certified client with operator authorization to create a received capacity option request from said first active certified client;
accessing said validated order collection based upon said received capacity option request to create a capacity option offer list containing a reference to each of said validated orders contained in said validated order collection matching said received capacity option request; and
processing said capacity option offer list.

12. The system of claim 11,
wherein the program step processing said capacity offer list is further comprised of the program step of:
presenting said capacity offer list to said first active certified client.

13. The system of claim 11,
wherein said received capacity option request includes a market interval and includes an ask-limit amount and includes an ask-limit price;
wherein the program step processing said capacity offer list is further comprised of the program step of:
examining said capacity offer list based upon said market interval and based upon said ask-limit amount and based upon said ask-limit price to create an acceptable offer capacity list and to create a potentially eligible offer capacity list;
asking for said acceptable offer capacity list based upon said ask-limit amount and based upon said ask-limit price to said virtual trading floor to create an ask validated order in said market interval for said first active client; and
presenting said potentially eligible capacity offer list to said first active certified client whenever said acceptable offer capacity list does not cover said ask-limit amount.

14. A system interacting with at least a first active certified client and a second active certified client both belonging to a certified client collection and supporting transactions involving at least one fungible, ephemeral commodity, comprising:
a computing system interacting with at least the first active certified client and the second certified client and controlled by at least a program system comprised of program steps contained in-memory accessibly coupled to at least one computer included in the computing system, and
said program system comprising the program step of:
operating a market engine supporting at least two of the collection further comprising the program steps of:
operating a virtual trading floor involving said fungible, ephemeral commodities and interacting with said active certified clients;
supporting bilateral trading involving said active certified clients; and
supporting external market trading involving said active certified clients;
wherein the program step operating said virtual trading floor comprising the program steps of:
maintaining a market interval collection of at least one market intervals with said fungible, ephemeral commodity as the product type;
maintaining a validated order collection of at least one validated orders associated with at least one of said market intervals; and
contracting to create an agreed contract to be added to a commitment list, where the agreed contract is based upon at least two validated orders from the validated order collection.

15. The system of claim 14,
wherein the program step of supporting bilateral trading involving said active certified clients is further comprised of the program steps of
receiving from said first active certified client a validated order specifying said second active certified client as said responder to create a received bilateral order with said first active certified client as initiator;
notifying said second active certified client of said received bilateral order with said first active certified client as said initiator to create a bilateral order notification;
receiving a bilateral order response from said second active certified client based upon said bilateral order notification to create a received bilateral order response; and
contracting said received bilateral order between said initiator and said responder whenever said received bilateral order response confirms said received bilateral order.

16. The system of claim 15,
wherein the program step of contracting the received bilateral order is further comprised of the program steps of:
creating a counter order based upon said received bilateral order for said responder; and
marking said received bilateral order and said counter order as contracted to create an agreed contract between said first active certified client and said second active certified client.

17. The system of claim 14,
wherein the program step of supporting external market trading involving said active certified clients is comprised of the program steps of:
accepting an order from said first active certified client to create an accepted order in an accepted order pool;
reconciling at market said accepted orders contained in said accepted order pool;
blocking said order acceptance from said certified clients;
retrofitting said accepted orders contained in said accepted order pool based upon an external market quantity and based upon an external market price; and
reconciling said accepted orders in said accepted order pool.

18. The system of claim 14,
wherein the program step operating said market engine is further comprised of the program steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar;
recording said validated orders in said validated order collection to a transaction database.

19. The system of claim 18,
wherein the program step of recording said validated orders into said transaction database is further comprised of the program step of:
recording a contracted position for said market interval for each of said certified clients in said certified client collection based upon all validated orders involving said certified client and containing said market interval in said validated order collection into said transaction database.

20. The system of claim 19,
wherein the program step of recording the validated orders into the transaction database is further comprised of at least one the program steps of the collection comprising:
recording said market price for a market interval based upon all validated orders containing said market interval in said validated order collection into said transaction database;
recording a market volume for said market interval based upon all validated orders containing said market interval in said validated order collection into said transaction database; and
recording a marginal financial exposure for a market interval for each of said certified clients in said certified client collection based upon all validated orders involving said certified client and containing said market interval in said validated order collection into said transaction database.

21. The system of claim 14,
wherein said program system further comprising the program step of:
operating a settlement engine interacting with said market engine to create a settlement for each of said certified clients based upon commitments in said commitment list requiring settlement by said certified client.

22. The system of claim 21,
wherein said program system further comprising the program step of:
a database engine interacting with said market engine and with said settlement engine further comprising the program steps of
maintaining said certified client collection;
maintaining said commitment list;
said database engine interacting with said market engine; and
said database engine interacting with said settlement engine;
wherein the program step of said database engine interacting with said market engine further comprising the program steps of:
providing access of said certified client collection to said market engine;
providing access of said commitment collection to said market engine; and
wherein the program step of said database engine interacting with said settlement engine further comprising the program steps of:
providing access of said certified client collection to said settlement engine; and
providing access of said commitment collection to said settlement engine.

23. The system of claim 21,
operating a scheduling engine interacting with at least one member of the collection comprising of said market engine, said settlement engine and said database engine, further comprising the program step of
generating said schedule to said certified client whenever said commitment list contains at least one commitment requiring scheduling of said certified client, for each of said certified clients belonging to said certified client collection; and
wherein the program step operating said database engine is further comprised the program step of
the database engine interacting with said scheduling engine further comprising the program steps of
providing access of said certified client collection to said scheduling engine; and
providing access of said commitment collection to said scheduling engine.

24. The system of claim 23,
wherein the program step operating said scheduling engine is further comprised of the program step of
processing a capacity option request by interacting with at least one of the collection comprising said market engine and said database engine.

25. The system of claim 24,
wherein the program step processing said capacity option request is further comprised of the program steps of
receiving said capacity option request from said first active certified client with operator authorization to create a received capacity option request from said first active certified client;
accessing said validated order collection based upon said received capacity option request to create a capacity option offer list containing a reference to each of said validated orders contained in said validated order collection matching said received capacity option request; and
processing said capacity option offer list.

26. The system of claim 25,
wherein the program step processing said capacity offer list is further comprised of the program step of:
presenting said capacity offer list to said first active certified client.

27. The system of claim 25,
wherein said received capacity option request includes a market interval and includes an ask-limit amount and includes an ask-limit price;
wherein the program step processing said capacity offer list is further comprised of the program step of:
examining said capacity offer list based upon said market interval and based upon said ask-limit amount and based upon said ask-limit price to create an acceptable offer capacity list and to create a potentially eligible offer capacity list;
asking for said acceptable offer capacity list based upon said ask-limit amount and based upon said ask-limit price to said virtual trading floor to create an ask validated order in said market interval for said first active client; and
presenting said potentially eligible capacity offer list to said first active certified client whenever said acceptable offer capacity list does not cover said ask-limit amount.

28. The system of claim 23,
wherein the program step operating said settlement engine is further comprised of the program step of:
operating a settlement engine interacting with said market engine and interacting with said scheduling engine to create said settlement interaction with the one active certified clients.

29. The system of claim 14,
wherein the program step operating said market engine is further comprised of the program step of:
maintaining said certified client collection.

30. The system of claim 14,
wherein said program system is further comprised of the program step of:
operating a settlement engine interacting with said market engine to create a settlement interaction for each of said certified clients whenever said commitment list contains at least one of said commitments requiring settlement by said certified clients.

31. The system of claim 30,
wherein said program system further comprises the program step of:
operating a database engine interacting with said market engine and with said settlement engine further comprising the program steps of:
maintaining said certified client collection;
maintaining said validated order collection;
maintaining said commitment collection;
said database engine interacting with said market engine; and
said database engine interacting with said settlement engine;
wherein the program step said database engine interacting with said market engine is further comprised of the program steps of:
providing said certified client collection to said market engine;
providing said validated order collection to said market engine;
and
providing a commitment collection to said market engine; and
wherein the program step said database engine interacting with said settlement engine is further comprised of the program steps of:
providing said certified client collection to said settlement engine; and
providing said commitment collection to said settlement engine.

32. The system of claim 31,
wherein the program operating said database engine is further comprised program step of:
maintaining said performance collection further comprised of the program step of:
receiving a meter data message for a first of said certified clients to create a meter performance entry for said first certified client in said performance collection.

33. The system of claim 32,
wherein the program step said database engine interacting with said settlement engine is further comprised of the program step of:
providing a meter report referencing said meter performance entry for said first certified client.

34. The system of claim 32,
wherein the program step said database engine interacting with said settlement engine is further comprised of the program step of:
providing said performance collection to said settlement engine.

35. The system of claim 30,
wherein said program system further comprises the program step of:
operating a scheduling engine interacting with said market engine to provide at least one schedule to at least one of said active certified clients.

36. The system of claim 35,
wherein the program step operating said settlement engine is further comprised of the program step of:
operating said settlement engine interacting with said market engine and interacting with said scheduling engine to create said settlement interaction with said one active certified clients.

37. A system interacting with at least a first active certified client and a second active certified client, both belonging to a certified client collection, and supporting transactions involving at least one fungible, ephemeral commodity, comprising:
a computing system interacting with at least the first active certified client and the second certified client and controlled be at least a program system comprised program steps contained in memory accessibly coupled to at least one computer included in the computing system, and
said program system comprising the program steps of:
maintaining a virtual trading floor involving said fungible, ephemeral commodities and interacting with said active certified clients;
supporting bilateral trading involving said active certified clients; and
supporting external market trading involving said active certified clients;
wherein the program step maintaining said virtual trading floor is further comprised of the program steps of:
maintaining a market interval collection of at least one market intervals with said fungible, ephemeral commodity as said product type;
maintaining a validated order collection of at least one validated orders associated with at least one of said market intervals;
contracting to create an agreed contract to be added to a commitment list, where said agreed contract is based upon at least one validated order from said validated order collection;
maintaining said certified client collection;
wherein the program step supporting bilateral trading is further comprised of the program steps of:
receiving from said first active certified client a validated order specifying said second active certified client as said responder to create a received bilateral order with said first active certified client as initiator;
notifying said second active certified client of said received bilateral order with said first active certified client as said initiator to create a bilateral order notification;
receiving a bilateral order response from said second active certified client based upon said bilateral order notification to create a received bilateral order response; and
contracting said received bilateral order between said initiator and said responder whenever said received bilateral order response confirms said received bilateral order; and
wherein the program step supporting external market trading is further comprised of the program steps of:
accepting orders from said active certified clients to create an accepted order in an accepted order pool;
reconciling at market said accepted orders contained in said accepted order pool;
blocking said order acceptance from said certified clients;
retrofitting said accepted orders contained in said accepted order pool based upon an external market quantity and based upon an external market price; and
reconciling said accepted orders in said accepted order pool.

38. The system of claim 37,
wherein the program step of contracting said received bilateral order is further comprised of the program steps of:
creating a counter order based upon said received bilateral order for said responder; and
marking said received bilateral order and said counter order as contracted to create an agreed contract between said first active certified client and said second active certified client.

39. The system of claim 37,
wherein the program step of supporting said virtual trading floor interacting with said active certified clients is further comprised of the program steps of:
reconciling market positions for said market intervals represented in said validated order collection;
adjusting market prices for market intervals represented in said validated order collection;
calculating market exposure for market intervals represented in said validated order collection;
marking said validated orders in said validated order collection onto a calendar; and
recording said validated orders in said validated order collection to a database.

40. The system of claim 39,
wherein the program step of recording said validated orders into the database is further comprised of the program step of:
recording a contracted position for said market interval for each of said certified clients in said certified client collection based upon all validated orders involving said certified client and containing said market interval in said validated order collection into said database.

41. The system of claim 40,
wherein the program step of recording said validated orders into said database is further comprised of at least one the program steps of the collection comprising the program steps of:
recording said market price for a market interval based upon all validated orders containing said market interval in said validated order collection into said database;
recording a market volume for said market interval based upon all validated orders containing said market interval in said validated order collection into said database; and
recording a marginal financial exposure for a market interval for each of said certified clients in said certified client collection based upon all validated orders involving said certified client and containing said market interval in said validated order collection into said database.

42. The system of claim 37,
wherein said program system further comprises the program steps of:
operating a scheduling engine to provide at least one schedule to said at least one of said active certified clients based upon accessing said commitment collection; and
operating a settlement engine accessing said commitment collection to create a settlement with said certified client, for each certified client belonging to said certified client collection.

43. The system of claim 37,
wherein said program system further comprises the program steps of:
operating a scheduling engine interacting to provide at least one schedule to said at least one of said active certified clients; and
operating a settlement engine interacting with said market engine and interacting with said scheduling engine to create said settlement interaction with said one active certified clients.

44. A system interacting with at least two certified clients belonging to a certified client collection and supporting transactions involving at least one fungible, ephemeral commodity, comprising:
at least one computer controlled at least in part by a program system comprised of program steps residing in memory accessibly said computer;
wherein said program system is comprised of the program steps of:
a scheduling engine accessing a commitment collection containing at least one commitment referencing said certified client, for at least one of said certified clients belonging to said certified client collection, and
a settlement engine creating a settlement based upon said commitments contained in said commitment collection involving said fungible, ephemeral commodities requiring settlement by said certified client, for each of said certified clients belonging to said certified client collection; and
said settlement engine providing said settlement to said certified client, for each of said certified clients belonging to said certified client collection.

45. The system of claim 44,
wherein said program system is further comprised of the program step of:
providing metering data for said certified client to said settlement engine to create a received metering data for said certified client, for at least one of said certified clients belonging to said certified client collection;
wherein the step of creating said settlement is further comprised of the step of:
creating said settlement based upon said received metering data for said certified client and based upon said commitments contained in said commitment collection involving said fungible, ephemeral commodities and requiring settlement by said certified client.

46. The system of claim 45,
wherein said program system is further comprised of the program step of:
operating said database engine further comprising the steps of:
maintaining said certified client collection;
maintaining said commitment collection;
said database engine interacting with said scheduling engine;
and
said database engine interacting with said settlement engine;
wherein the program step of said database engine interacting with said scheduling engine further comprising the program steps of:
providing access of said certified client collection to said scheduling engine; and
providing access of said commitment collection to said scheduling engine; and
wherein the program step of said database engine interacting with said settlement engine further comprising the program steps of:
providing access of said certified client collection to said settlement engine; and
providing access of said commitment collection to said settlement engine.

47. The system of claim 46,
wherein the program step of operating said database engine is further comprised of the program step of:
maintaining a metering database further comprised of the program steps of:
receiving said metering data for said certified client to create a meter data entry for said certified client in said metering database; and
processing a meter data request for said certified client based upon said metering data entries for said certified client in said metering database to create a sent metering data for said certified client;
wherein the program step providing metering data for said certified client to said settlement engine is further comprised of the program steps of:
sending said metering data request for said certified client; and
receiving said sent metering data for said certified client to create said received metering data for said certified client.

48. The system of claim 44,
wherein said computing system is further comprised of
a first computer group including at least one first computer with accessibly coupled memory, and
a second computer group including at least one second computer with accessibly coupled memory;
wherein said accessibly coupled memory of said first computer contains program steps operating said scheduling engine;
wherein said accessibly coupled memory of said second computer contains program steps operating said settlement engine:
wherein said accessibly coupled memory of said second computer does not contain the program step operating said scheduling engine; and
wherein said accessibly coupled memory of said first computer does not contain the program steps operating said settlement engine.

49. A computing system communicatively coupled to a market engine, to a scheduling engine and to a settlement engine supporting transactions involving commitments between certified clients belonging to a certified client collection, said commitments contained in a commitment list, said computing system comprising:
at least one computer controlled at least in part by a program system comprised of program steps residing in memory accessibly coupled to said computer;
wherein said program system is comprised of the program steps of:
maintaining said certified client collection;
maintaining said commitment list;
wherein the program step maintaining a certified client collection further comprising the program steps of:
providing access to said certified client collection by said market engine;
providing access to said certified client collection by said scheduling engine;
providing access to said certified client collection by said settlement engine; and
wherein the program step maintaining said commitment list further comprising the program steps of
receiving the sent commitment to create a received commitment;
adding the sent commitment into said commitment list;
receiving a metering data message for a specific certified client to create a received meter message for the specific certified client;
integrating the received meter message for the specific certified client to create a performed commitment by the specific certified client in a meter reading list;
receiving commitment access requests for at least one of said certified clients belonging to said certified client collection from a requesting engine to create a received commitment access request;
wherein the requesting engine belongs to the engine collection comprising said market engine, said scheduling engine and said settlement engine; and
sending a commitment report of said commitments belonging to said commitment list in response to said commitment access request to the requesting engine.

50. The system of claim 49,
wherein said program system is further comprised of the program step of:
maintaining a metering database further comprised of the program steps of:
receiving said metering data for said certified client to create a meter data entry for said certified client in said metering database; and
processing a meter data request for said certified client based upon said metering data entries for said certified client in said metering database to create a sent metering data for said certified client.

51. A method of interacting with at least a first active certified client and a second certified client belonging to a certified client collection supporting transactions involving at least one fungible, ephemeral commodity, comprising, comprising the steps of:
operating a market engine presenting at least one commitment to a commitment list;
operating a scheduling engine providing at least one schedule based upon accessing said commitment list for at least one of said certified clients belonging to said certified client collection; and
operating a settlement engine providing a settlement based upon accessing said commitment list and based upon a performance database for each of said certified clients belonging to said certified client collection;
wherein the step operating said market engine further comprising the steps of:
supporting a virtual trading floor interacting with said active certified clients to create said commitment;
supporting bilateral trading involving said active certified clients to create said commitment;
supporting external market trading involving said active certified clients to create said commitment; and
maintaining said commitment list;
wherein the step operating said scheduling engine is further comprised of, for each of said certified clients belonging to said certified client collection, the steps of:
sending a scheduling commitment access request for said certified client regarding said commitment list;
receiving a scheduling commitment report in response to said scheduling commitment access request based upon said commitment list to create the received scheduling commitment report for said certified client; and
generating said schedule for said certified client based upon the received scheduling commitment report for said certified client whenever the received scheduling commitment access report references commitments requiring scheduling;
wherein the step operating said settlement engine is further comprised of the steps of:
processing a settlement for said certified client, for each of said certified clients belonging to said certified client collection; and
maintaining a performance database;
wherein the step processing said settlement for said certified client is further comprised of the steps of:
sending a settlement commitment access request regarding said commitment list for said certified client;
receiving a settlement commitment report in response to said settlement commitment access request to create said received settlement commitment report for said certified client;
presenting a performance access request regarding said performance database for said certified client;
receiving a performance report in response to said settlement commitment performance access request to create said received performance report for said certified client; and
generating said settlement for said certified client based upon the received performance report for said certified client and based upon said received settlement commitment report for said certified client;
wherein the step maintaining said commitment list is further comprised of the steps of:
receiving the sent commitment to create a received commitment added into said commitment list;
receiving a commitment access request for at least one of said certified clients belonging to said certified client collection from a requesting engine to create a received commitment request; wherein said requesting engine belongs to the collection comprising said market engine, said scheduling engine and said settlement engine; wherein said commitment access request belongs to an access request collection comprising a settlement commitment access request and a scheduling commitment access request; and
sending a commitment report of said commitments belonging to said commitment list in response to said commitment request to the requesting engine;
wherein the step maintaining said performance database is further comprised of the steps of:
receiving a metering data message for a specific certified client to create a received meter data for said specific certified client added into a performance database;
receiving a commitment performance access request for at least one of said certified clients belonging to said certified client collection from said requesting engine to create a received commitment performance request; and
sending a commitment performance report based in response to the received commitment performances request.

52. The method of claim 51,
wherein the step of supporting bilateral trading is further comprised of the steps of
receiving from said first active certified client a validated order specifying said second active certified client as said responder to create a received bilateral order with said first active certified client as initiator;
notifying said second active certified client of said received bilateral order with said first active certified client as said initiator to create a bilateral order notification;
receiving a bilateral order response from said second active certified client based upon said bilateral order notification to create a received bilateral order response; and
contracting said received bilateral order between said initiator and said responder whenever said received bilateral order response confirms said received bilateral order.

53. The method of claim 52,
wherein the step of contracting the received bilateral order is further comprised of the steps of:
creating a counter order based upon said received bilateral order for said responder; and
marking said received bilateral order and said counter order as contracted to create a commitment between said first active certified client and said second active certified client.

54. The method of claim 51,
wherein the step of supporting external market trading is comprised of the steps of:
accepting orders from said active certified clients to create an accepted order in an accepted order pool;
reconciling at market said accepted orders contained in said accepted order pool;
blocking said orders from said certified clients;
retrofitting said accepted orders contained in said accepted order pool based upon an external market quantity and based upon an external market price; and
reconciling said accepted orders in said accepted order pool.

55. The method of claim 51,
wherein the step of operating said market engine is further comprised of the steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar; and
recording said validated orders in said validated order collection to a transaction database.

56. The method of claim 55,
wherein the step of recording the validated orders is further comprised of the steps of:
recording said market price for a market interval based upon all validated orders containing said market interval in said validated order collection;
recording a market volume for said market interval based upon all validated orders containing said market interval in said validated order collection;
recording a contracted position for said market interval for each of said certified clients in said certified client collection based upon all validated orders involving said certified client and containing said market interval in said validated order collection; and
recording a marginal financial exposure for a market interval for each of said certified clients in said certified client collection based upon all validated orders involving said certified client and containing said market interval in said validated order collection.

57. The method of claim 51,
wherein said method further comprises the step of:
providing a login process to create said active certified clients based upon said certified client collection.

58. The method of claim 51,
wherein said method further comprises the step of:
maintaining a web site communicating with at least two clients and further comprising at least one of the collection comprising the steps of:
maintaining a market window interacting with said clients;
providing a metering interface for receiving a metering data message for a specific certified client to create said received meter message for said specific certified client;
providing a scheduler window for said client interacting with said scheduling engine; and
providing said settlement for said certified client from said settlement engine.

59. The method of claim 51,
wherein the step operating said scheduling engine is further comprised of the step of
processing a capacity option request by interacting with at least one of the collection comprising said market engine and said database engine.

60. The method of claim 59,
wherein the step processing said capacity option request is further comprised of the steps of
receiving said capacity option request from said first active certified client with operator authorization to create a received capacity option request from said first active certified client;
accessing said validated order collection based upon said received capacity option request to create a capacity option offer list containing a reference to each of said validated orders contained in said validated order collection matching said received capacity option request; and
processing said capacity option offer list.

61. The method of claim 60,
wherein the step processing said capacity offer list is further comprised of the step of:
presenting said capacity offer list to said first active certified client.

62. The method of claim 60,
wherein said received capacity option request includes a market interval and includes an ask-limit amount and includes an ask-limit price;
wherein the step processing said capacity offer list is further comprised of the step of:
examining said capacity offer list based upon said market interval and based upon said ask-limit amount and based upon said ask-limit price to create an acceptable offer capacity list and to create a potentially eligible offer capacity list;
asking for said acceptable offer capacity list based upon said ask-limit amount and based upon said ask-limit price to said virtual trading floor to create an ask validated order in said market interval for said first active client; and
presenting said potentially eligible capacity offer list to said first active certified client whenever said acceptable offer capacity list does not cover said ask-limit amount.

63. A method of interacting with at least a first active certified client and a second active certified client both belonging to a certified client collection and supporting transactions involving at least one fungible, ephemeral commodity, comprising the step of:
operating a market engine supporting at least two of the collection further comprising the steps of:
operating a virtual trading floor involving said fungible, ephemeral commodities and interacting with said active certified clients;
supporting bilateral trading involving said active certified clients; and
supporting external market trading involving said active certified clients;
wherein the step operating said virtual trading floor comprising the steps of:
maintaining a market interval collection of at least one market intervals with said fungible, ephemeral commodity as the product type;
maintaining a validated order collection of at least one validated orders associated with at least one of said market intervals;
contracting to create an agreed contract to be added to a commitment list, where the agreed contract is based upon at least two validated orders from the validated order collection.

64. The method of claim 63,
wherein the step of supporting bilateral trading involving said active certified clients is further comprised of the steps of
receiving from said first active certified client a validated order specifying said second active certified client as said responder to create a received bilateral order with said first active certified client as initiator;
notifying said second active certified client of said received bilateral order with said first active certified client as said initiator to create a bilateral order notification;
receiving a bilateral order response from said second active certified client based upon said bilateral order notification to create a received bilateral order response; and
contracting said received bilateral order between said initiator and said responder whenever said received bilateral order response confirms said received bilateral order.

65. The method of claim 64,
wherein the step of contracting the received bilateral order is further comprised of the steps of:
creating a counter order based upon said received bilateral order for said responder; and
marking said received bilateral order and said counter order as contracted to create an agreed contract between said first active certified client and said second active certified client.

66. The method of claim 63,
wherein the step of supporting external market trading involving said active certified clients is comprised of the steps of:
accepting an order from said first active certified client to create an accepted order in an accepted order pool;
reconciling at market said accepted orders contained in said accepted order pool;
blocking said order acceptance from said certified clients;
retrofitting said accepted orders contained in said accepted order pool based upon an external market quantity and based upon an external market price; and
reconciling said accepted orders in said accepted order pool.

67. The method of claim 63,
wherein the step of operating said market engine is further comprised of the steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar;
recording said validated orders in said validated order collection to a transaction database.

68. The method of claim 67,
wherein the step of recording the validated orders into the transaction database is further comprised of the step of:
recording a contracted position for said market interval for each of said certified clients in said certified client collection based upon all validated orders involving said certified client and containing said market interval in said validated order collection into said transaction database.

69. The method of claim 68,
wherein the step of recording the validated orders into the transaction database is further comprised of at least one the steps of the collection comprising:
recording said market price for a market interval based upon all validated orders containing said market interval in said validated order collection into said transaction database;
recording a market volume for said market interval based upon all validated orders containing said market interval in said validated order collection into said transaction database; and
recording a marginal financial exposure for a market interval for each of said certified clients in said certified client collection based upon all validated orders involving said certified client and containing said market interval in said validated order collection into said transaction database.

70. The method of claim 63, further comprising the step of:
operating a settlement engine interacting with said market engine to create a settlement with each of said certified clients based upon commitments in said commitment list requiring settlement by said certified client.

71. The method of claim 70, further comprising the step of:
operating a database engine interacting with said market engine and with said settlement engine further comprising the steps of
maintaining said certified client collection;
maintaining said commitment list;
said database engine interacting with said market engine; and
said database engine interacting with said settlement engine;
wherein the step of said database engine interacting with said market engine further comprising the steps of:
providing access of said certified client collection to said market engine;
providing access of said commitment collection to said market engine; and
wherein the step of said database engine interacting with said settlement engine further comprising the steps of:
providing access of said certified client collection to said settlement engine; and
providing access of said commitment collection to said settlement engine.

72. The method of claim 70, further comprising the step of:
operating a scheduling engine interacting with at least one member of the collection comprising of said market engine, said settlement engine and said database engine, further comprising the step of
generating said schedule to said certified client whenever said commitment list contains at least one commitment requiring scheduling of said certified client, for each of said certified clients belonging to said certified client collection; and
wherein the step operating said database engine is further comprised the step of
the database engine interacting with said scheduling engine further comprising the steps of
providing access of said certified client collection to said scheduling engine; and
providing access of said commitment collection to said scheduling engine.

73. The method of claim 72,
wherein the step operating said scheduling engine is further comprised of the step of
processing a capacity option request by interacting with at least one of the collection comprising said market engine and said database engine.

74. The method of claim 73,
wherein the step processing said capacity option request is further comprised of the steps of
receiving said capacity option request from said first active certified client with operator authorization to create a received capacity option request from said first active certified client;
accessing said validated order collection based upon said received capacity option request to create a capacity option offer list containing a reference to each of said validated orders contained in said validated order collection matching said received capacity option request; and
processing said capacity option offer list.

75. The method of claim 74,
wherein the step processing said capacity offer list is further comprised of the step of:
presenting said capacity offer list to said first active certified client.

76. The method of claim 74,
wherein said received capacity option request includes a market interval and includes an ask-limit amount and includes an ask-limit price;
wherein the step processing said capacity offer list is further comprised of the step of:
examining said capacity offer list based upon said market interval and based upon said ask-limit amount and based upon said ask-limit price to create an acceptable offer capacity list and to create a potentially eligible offer capacity list;
asking for said acceptable offer capacity list based upon said ask-limit amount and based upon said ask-limit price to said virtual trading floor to create an ask validated order in said market interval for said first active client; and
presenting said potentially eligible capacity offer list to said first active certified client whenever said acceptable offer capacity list does not cover said ask-limit amount.

77. The method of claim 72,
wherein the step operating said settlement engine is further comprised of the step of:
operating a settlement engine interacting with said market engine and interacting with said scheduling engine to create said settlement interaction with the one active certified clients;

78. The method of claim 63,
wherein the step operating said market engine is further comprised of the step of:
maintaining said certified client collection.

79. The method of claim 63, further comprising the step of:
operating a settlement engine interacting with said market engine to create a settlement interaction for each of said certified clients whenever said commitment list contains at least one of said commitments requiring settlement by said certified clients.

80. The method of claim 79, further comprising the step of:
operating a database engine interacting with said market engine and with said settlement engine further comprising the steps of:
maintaining said certified client collection;
maintaining said validated order collection;
maintaining said commitment collection;
said database engine interacting with said market engine; and
said database engine interacting with said settlement engine;
wherein the step said database engine interacting with said market engine is further comprised of the steps of:
providing said certified client collection to said market engine;
providing said validated order collection to said market engine;
and
providing a commitment collection to said market engine; and
wherein the step said database engine interacting with said settlement engine is further comprised of the steps of:
providing said certified client collection to said settlement engine; and
providing said commitment collection to said settlement engine.

81. The method of claim 80,
wherein the program operating said database engine is further comprised step of:
maintaining said performance collection further comprised of the step of:
receiving a meter data message for a first of said certified clients to create a meter performance entry for said first certified client in said performance collection.

82. The method of claim 81,
wherein the step said database engine interacting with said settlement engine is further comprised of the step of:
providing a meter report referencing said meter performance entry for said first certified client.

83. The method of claim 81,
wherein the step said database engine interacting with said settlement engine is further comprised of the step of:
providing said performance collection to said settlement engine.

84. The method of claim 79, further comprising the step of:
operating a scheduling engine interacting with said market engine to provide at least one schedule to at least one of said active certified clients.

85. The method of claim 84,
wherein the step operating said settlement engine is further comprised of the step of:
operating said settlement engine interacting with said market engine and interacting with said scheduling engine to create said settlement interaction with said one active certified clients.

86. A method interacting with at least two certified clients belonging to a certified client collection and supporting transactions involving at least one fungible, ephemeral commodity, comprising the steps of:
a scheduling engine accessing a commitment collection containing at least one commitment referencing said certified client, for at least one of said certified clients belonging to said certified client collection; and
a settlement engine creating a settlement based upon said commitments contained in said commitment collection involving said fungible, ephemeral commodities requiring settlement by said certified client, for each of said certified clients belonging to said certified client collection; and
said settlement engine providing said settlement to said certified client, for each of said certified clients belonging to said certified client collection.

87. The method of claim 86, further comprising the step of:
providing metering data for said certified client to said settlement engine to create a received metering data for said certified client, for at least one of said certified clients belonging to said certified client collection;
wherein the step of creating said settlement is further comprised of the step of:
creating said settlement based upon said received metering data for said certified client and based upon said commitments contained in said commitment collection involving said fungible, ephemeral commodities and requiring settlement by said certified client.

88. The method of claim 87, further comprising the step of:
operating said database engine further comprising the steps of:
maintaining said certified client collection;
maintaining said commitment collection;
said database engine interacting with said scheduling engine;
and
said database engine interacting with said settlement engine;
wherein the step of said database engine interacting with said scheduling engine further comprising the steps of:
providing access of said certified client collection to said scheduling engine; and
providing access of said commitment collection to said scheduling engine; and
wherein the step of said database engine interacting with said settlement engine further comprising the steps of:
providing access of said certified client collection to said settlement engine; and
providing access of said commitment collection to said settlement engine.

89. The method of claim 88, further comprising the step of:
maintaining a metering database further comprised of the steps of:
receiving said metering data for said certified client to create a meter data entry for said certified client in said metering database; and
processing a meter data request for said certified client based upon said metering data entries for said certified client in said metering database to create a sent metering data for said certified client;
wherein the step providing metering data for said certified client to said settlement engine is further comprised of the steps of:
sending said metering data request for said certified client; and
receiving said sent metering data for said certified client to create said received metering data for said certified client.

90. A method of communicating with a market engine, with a scheduling engine and with a settlement engine supporting transactions involving commitments between certified clients belonging to a certified client collection, said commitments contained in a commitment list, said method comprising the steps of:
maintaining said certified client collection;
maintaining said commitment list;
wherein the step maintaining a certified client collection further comprising the steps of:
providing access to said certified client collection by said market engine;
providing access to said certified client collection by said scheduling engine;
providing access to said certified client collection by said settlement engine; and
wherein the step maintaining said commitment list further comprising the steps of
receiving the sent commitment to create a received commitment;
adding the sent commitment into said commitment list;
receiving a metering data message for a specific certified client to create a received meter message for the specific certified client;
integrating the received meter message for the specific certified client to create a performed commitment by the specific certified client in a meter reading list;
receiving commitment access requests for at least one of said certified clients belonging to said certified client collection from a requesting engine to create a received commitment access request; wherein the requesting engine belongs to the engine collection comprising said market engine, said scheduling engine and said settlement engine; and
sending a commitment report of said commitments belonging to said commitment list in response to said commitment access request to the requesting engine.

91. The method of claim 90, further comprising the step of:
maintaining a metering database further comprised of the steps of:
receiving said metering data for said certified client to create a meter data entry for said certified client in said metering database; and
processing a meter data request for said certified client based upon said metering data entries for said certified client in said metering database to create a sent metering data for said certified client.
